(19) United States
(12) Patent Application Publication
(10) Pub. No.: US 2026/0063871 A1
(43) Pub. Date: Mar. 5, 2026

(54) OPTICAL SYSTEM AND CAMERA MODULE

(71) Applicant: LG INNOTEK CO., LTD., Seoul (KR)

(72) Inventor: Chang Gyun SON, Seoul (KR)

(21) Appl. No.: 19/106,513

(22) PCT Filed: Aug. 25, 2023
(86) PCT No.: PCT/KR2023/012669

§ 371 Date: Feb. 25, 2025

(30) Foreign Application Priority Data
Aug. 25, 2022 (KR) 10-2022-0107102
Aug. 25, 2022 (KR) 10-2022-0107107
Aug. 25, 2022 (KR) 10-2022-0107108

(51) Int. Cl. G02B 13/00; G02B 7/02; G02B 9/64

(52) U.S. Cl. CPC G02B 13/0045; G02B 7/025; G02B 9/64; G02B 13/006

(57) ABSTRACT

The optical system disclosed in the embodiment of the invention includes first to seventh lenses aligned along an optical axis from an object side toward a sensor side, wherein a refractive power of the first lens is negative, a composite refractive power of the second to seventh lenses is positive, a refractive power of the seventh lens is negative, the first lens is a spherical lens having a maximum center thickness, the center thickness of the first lens may be greater than an optical axis distance from a center of an object-side surface of the fifth lens to a center of a sensor-side surface of the sixth lens.

### TECHNICAL FIELD

An embodiment of the invention relates to an optical system for improved optical performance and a camera module including the same.

### BACKGROUND ART

ADAS (Advanced Driving Assistance System) is an advanced driver assistance system for assisting the driver to drive and is composed of sensing the situation in front, determining the situation based on the sensed result, and controlling the behavior of the vehicle based on the situation determination. For example, the ADAS sensor device detects a vehicle ahead and recognizes a lane. Then, when the target lane or target speed and the target in front are determined, the vehicle's ESC (Electrical Stability Control), EMS (Engine Management System), MDPS (Motor Driven Power Steering), etc. are controlled. Typically, ADAS may be implemented as an automatic parking system, a low-speed city driving assistance system, a blind spot warning system, and the like. The sensor devices for sensing the forward situation in ADAS are a GPS sensor, a laser scanner, a front radar, and a lidar, and the most representative ones are cameras for filming the front, rear, and sides of a vehicle.

These cameras may be placed outside or inside the vehicle to detect the surroundings of the vehicle. In addition, the cameras may be placed inside the vehicle to detect the situations of the driver and passengers. For example, the camera can photograph the driver at a location adjacent to the driver and detect the driver's health status, whether he or she is drowsy, whether he or she is drinking, etc. In addition, the camera can photograph the passenger at a location adjacent to the passenger and detect the passenger's sleep status, health status, etc., and provide the driver with information about the passenger.

In particular, the most important element for obtaining an image from a camera is the imaging lens that forms the image. Recently, interest in high-definition and high-resolution, etc., has been increasing, and research on an optical system including multiple lenses is being conducted to implement this. However, there is a problem that the characteristics of the optical system change when the camera is exposed to a harsh environment, such as high temperature, low temperature, moisture, or high humidity, outside or inside the vehicle. In this case, the camera has a problem that it is difficult to uniformly derive excellent optical characteristics and aberration characteristics. Therefore, new optical systems and cameras that can solve the above-described problems are required.

### DISCLOSURE

### Technical Problem

An embodiment of the invention provides an optical system and a camera module with improved optical characteristics. The embodiment provides an optical system and a camera module having excellent optical performance in low-temperature to high-temperature environments. The embodiment provides an optical system and a camera module capable of preventing or minimizing changes in optical characteristics in various temperature ranges.

### Technical Solution

An optical system according to an embodiment of the invention includes first to seventh lenses aligned along an optical axis from an object side toward a sensor side, wherein a refractive power of the first lens is negative, a composite refractive power of the second to seventh lenses is positive, a refractive power of the seventh lens is negative, the first lens is a spherical lens having a maximum center thickness, and the center thickness of the first lens may be greater than an optical axis distance from a center of an object-side surface of the fifth lens to a center of a sensor-side surface of the sixth lens.

According to an embodiment of the invention, an object-side surface of the fourth lens may have a concave shape on the optical axis. A center thickness of the second lens may be a minimum among center thicknesses of the first to seventh lenses.

According to an embodiment of the invention, a center distance between an i-th lens and an i+1 lens from the object side is CGi, and a center thickness of the i-th lens is CTi, and a value of an Equation: CTi/CGi may be maximum when i is 1. The value of Equation: CTi/CGi may be minimum when i is 3.

According to an embodiment of the invention, an effective diameter of the first lens is CA1, an effective diameter of the second lens is CA2, and an effective diameter of the third lens is CA3, and the following Equation may satisfy: CA1<CA2<CA3. According to an embodiment of the invention, a length from a center of an image sensor to a diagonal end is ImgH, an effective diameter of the fifth lens is CA5, an effective diameter of the sixth lens is CA6, an effective diameter of the seventh lens is CA7, and the following Equation may satisfy: CA4>CA5>CA6>(2*ImgH)>CA7.

According to an embodiment of the invention, a sensor-side surface of the fifth lens and an object-side surface of the sixth lens may be adhered to each other. An aperture stop may be included that is arranged on a periphery between the first lens and the second lens.

According to an embodiment of the invention, an object-side surface and a sensor-side surface of the third lens may be aspherical on the optical axis, and an object-side surface and a sensor-side surface of the seventh lens may be aspherical on the optical axis. The first to seventh lenses may be made of glass, and a number of lenses whose an object-side surface and a sensor-side surface are spherical on the optical axis may be at least twice a number of lenses whose an object-side surface and a sensor-side surface are aspherical.

According to an embodiment of the invention, the center thickness of the first lens is CT1, and an optical axis distance from a center of the object-side surface of the first lens to a surface of the image sensor is TTL, and the following Equation may satisfy: 0.18≤CT1/TTL≤0.3. According to an embodiment of the invention, the center thickness of the first lens may be thicker than a center thickness of a cemented lens.

A camera module according to an embodiment of the invention comprises: an image sensor; first to seventh lenses aligned along an optical axis from an object side toward a sensor side; an aperture stop disposed between spherical lenses among the first to seventh lenses; and an optical filter between the seventh lens and the image sensor, wherein the first lens has a meniscus shape convex toward the sensor on the optical axis, the first and seventh lenses have negative refractive power, and a composite refractive power of the second to seventh lenses is positive, and any one of the first to fourth lenses is an aspherical lens, the aspherical lens may be arranged between lenses having a shape in which both sides are convex on the optical axis.

According to an embodiment of the invention, a cemented lens is included in which two lenses having opposite refractive powers among the fifth to seventh lenses are cemented, and the cemented lens may include an object-side lens that is convex on the optical axis and a sensor-side lens that is concave on the optical axis.

### Advantageous Effects

An optical system and camera module according to the embodiment may have improved optical characteristics. Specifically, in the optical system according to the embodiment, a plurality of lenses may have set thicknesses, refractive powers, and distances between adjacent lenses. Accordingly, the optical system and camera module according to the embodiment may have improved MTF characteristics, aberration control characteristics, resolution characteristics, etc. in a set field of view range, and may have good optical performance in the periphery of the field of view.

In addition, the optical system and camera module according to the embodiment may have good optical performance in a temperature range of low temperature (about −20° C. to −40° C.) to high temperature (85° C. to 105° C.). Specifically, a plurality of lenses included in the optical system may have set materials, refractive powers, and refractive indices. Accordingly, even when the focal length of each lens changes due to a change in refractive index according to a change in temperature, the lenses can mutually compensate for each other. That is, the optical system can effectively perform distribution of refractive power in a temperature range of low temperature to high temperature, and prevent or minimize changes in optical characteristics in a temperature range of low temperature to high temperature. Therefore, the optical system and camera module according to the embodiment can maintain improved optical characteristics in various temperature ranges.

In addition, the optical system and camera module according to the embodiment may satisfy the set field of view by mixing an aspherical lens and a spherical lens and implement excellent optical characteristics. As a result, the optical system can provide a slimmer vehicle camera module. Therefore, the optical system and camera module may be provided for various applications and devices, and may have excellent optical characteristics even in harsh temperature environments, such as when exposed to the outside of a vehicle or inside a vehicle at high temperatures in summer. The invention can improve the reliability of an optical system and camera module for ADAS placed in a vehicle.

### DESCRIPTION OF DRAWINGS

FIG. 1 is a side cross-sectional view of an optical system according to an embodiment and a camera module having the same.

FIG. 2 is a side cross-sectional view for explaining the relationship between the n-th and n−1th lenses according to FIG. 1.

FIG. 3 is a table showing lens characteristics of the optical system of FIG. 1.

FIG. 4 is a table showing aspherical coefficients of lenses in the optical system of FIG. 1.

FIG. 5 is a table showing the thickness of each lens and the distances between adjacent lenses in the optical system of FIG. 1.

FIG. 6 is a table showing CRA (Chief Ray Angle) data at room temperature, low temperature, and high temperature according to the position of the image sensor in the optical system of FIG. 1.

FIG. 7 is a graph showing data on the diffraction MTF (Modulation Transfer Function) of the optical system of FIG. 1 at room temperature.

FIG. 8 is a graph showing data on the diffraction MTF of the optical system of FIG. 1 at low temperature.

FIG. 9 is a graph showing data on the diffraction MTF of the optical system of FIG. 1 at high temperature.

FIG. 10 is a graph showing data on the aberration characteristics of the optical system of FIG. 1 at room temperature.

FIG. 11 is a graph showing data on the aberration characteristics of the optical system of FIG. 1 at low temperature.

FIG. 12 is a graph showing data on the aberration characteristics of the optical system of FIG. 1 at high temperature.

FIG. 13 is a graph showing relative illuminance according to the height of the image sensor according to the first embodiment.

FIG. 14 is a side cross-sectional view of the optical system and the camera module having the same according to the second embodiment.

FIG. 15 is a side cross-sectional view for explaining the relationship between the n-th and n−1th lenses according to FIG. 14.

FIG. 16 is a table showing lens characteristics of the optical system of FIG. 14.

FIG. 17 is a table showing aspherical coefficients of lenses in the optical system of FIG. 14.

FIG. 18 is a table showing the thickness of each lens and the spacing between adjacent lenses in the optical system of FIG. 14.

FIG. 19 is a table showing CRA data at room temperature, low temperature, and high temperature according to the position of the image sensor in the optical system of FIG. 14.

FIG. 20 is a graph showing data on the diffraction MTF of the optical system of FIG. 14 at room temperature.

FIG. 21 is a graph showing data on the diffraction MTF of the optical system of FIG. 14 at low temperature.

FIG. 22 is a graph showing data on the diffraction MTF of the optical system of FIG. 14 at high temperature.

FIG. 23 is a graph showing data on the aberration characteristics of the optical system of FIG. 14 at room temperature.

FIG. 24 is a graph showing data on the aberration characteristics of the optical system of FIG. 14 at low temperature.

FIG. 25 is a graph showing data on the aberration characteristics of the optical system of FIG. 14 at high temperature.

FIG. 26 is a side cross-sectional view of an optical system according to the third embodiment and a camera module having the same.

FIG. 27 is a table showing lens characteristics of the optical system of FIG. 26.

FIG. 28 is a table showing aspherical coefficients of lenses in the optical system of FIG. 26.

FIG. 29 is a table showing the thickness of each lens and the spacing between adjacent lenses in the optical system of FIG. 26.

FIG. 30 is a table showing CRA data at room temperature, low temperature, and high temperature according to the position of the image sensor in the optical system of FIG. 26.

FIG. 31 is a graph showing data on diffraction MTF at room temperature of the optical system of FIG. 26.

FIG. 32 is a graph showing data on aberration characteristics at room temperature of the optical system of FIG. 26.

FIG. 33 is a table showing data on relative illuminance according to the height of the image sensor according to the second and third embodiments.

FIG. 34 is a side cross-sectional view of an optical system according to the fourth embodiment and a camera module having the same.

FIG. 35 is a side cross-sectional view for explaining the relationship between the n-th and n−1th lenses according to FIG. 34.

FIG. 36 is a table showing lens characteristics of the optical system of FIG. 34.

FIG. 37 is a table showing the aspherical coefficients of the lenses in the optical system of FIG. 34.

FIG. 38 is a table showing the thickness of each lens and the spacing between adjacent lenses in the optical system of FIG. 34.

FIG. 39 is a table showing CRA data at room temperature, low temperature, and high temperature according to the position of the image sensor in the optical system of FIG. 34.

FIG. 40 is a graph showing data on the diffraction MTF of the optical system of FIG. 34 at room temperature.

FIG. 41 is a graph showing data on the diffraction MTF of the optical system of FIG. 34 at low temperature.

FIG. 42 is a graph showing data on the diffraction MTF of the optical system of FIG. 34 at high temperature.

FIG. 43 is a graph showing data on the aberration characteristics of the optical system of FIG. 34 at room temperature.

FIG. 44 is a graph showing data on the aberration characteristics of the optical system of FIG. 34 at low temperature.

FIG. 45 is a graph showing data on the aberration characteristics of the optical system of FIG. 34 at high temperature.

FIG. 46 is a side cross-sectional view of an optical system according to the fifth embodiment and a camera module having the same.

FIG. 47 is a table showing lens characteristics of the optical system of FIG. 46.

FIG. 48 is a table showing aspherical coefficients of lenses in the optical system of FIG. 46.

FIG. 49 is a table showing thicknesses of each lens and spacing between adjacent lenses in the optical system of FIG. 46.

FIG. 50 is a table showing CRA data at room temperature, low temperature, and high temperature according to the position of the image sensor in the optical system of FIG. 46.

FIG. 51 is a graph showing data on diffraction MTF at room temperature of the optical system of FIG. 46.

FIG. 52 is a graph showing data on aberration characteristics at room temperature of the optical system of FIG. 46.

FIG. 53 is a table showing data on relative illuminance according to the height of the image sensor according to the fourth and fifth embodiments.

FIG. 54 is an example of a vehicle having an optical system according to an embodiment of the invention.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

The terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element. Several embodiments described below may be combined with each other, unless it is specifically stated that they cannot be combined with each other. In addition, the description of other embodiments may be applied to parts omitted from the description of any one of several embodiments unless otherwise specified.

In the description of the invention, “object-side surface” may refer to a surface of the lens facing the object side with respect to the optical axis OA, and “sensor-side surface” may refer to a surface of the lens facing the imaging surface (image sensor) with respect to the optical axis. A convex surface of the lens may mean a convex shape on the optical axis or paraxial region, and a concave surface of the lens may mean a concave shape on the optical axis or paraxial region. A curvature radius, center thickness, and distance between lenses described in the table for lens data may mean values on the optical axis, and the unit is mm. The vertical direction may mean a direction perpendicular to the optical axis, and an end of the lens or the lens surface may mean the end or edge of the effective region of the lens through which the incident light passes. The size of the effective diameter on the lens surface may have a measurement error of up to ±0.4 mm depending on the measurement method. The paraxial region refers to a very narrow region near the optical axis, and is a region where the distance a light ray falls from the optical axis OA is almost 0. Hereinafter, the optical axis may include the center of each lens or a very narrow region near the optical axis.

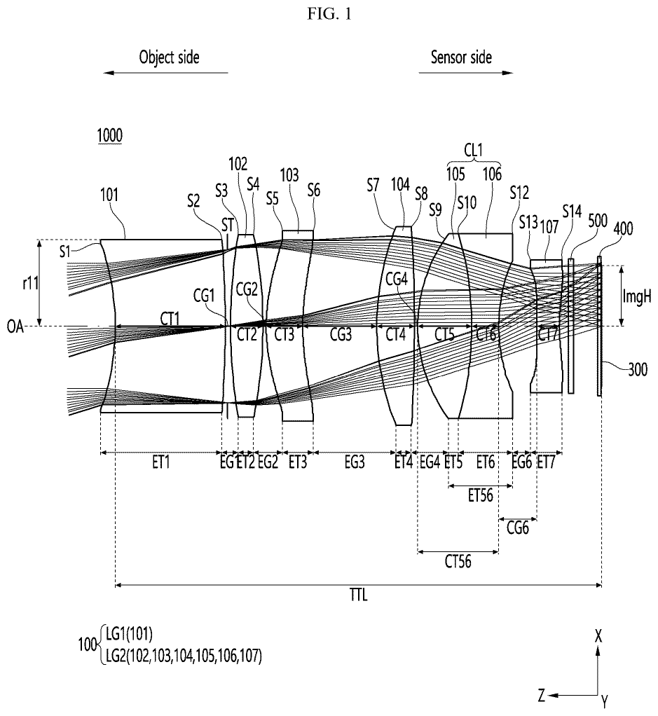

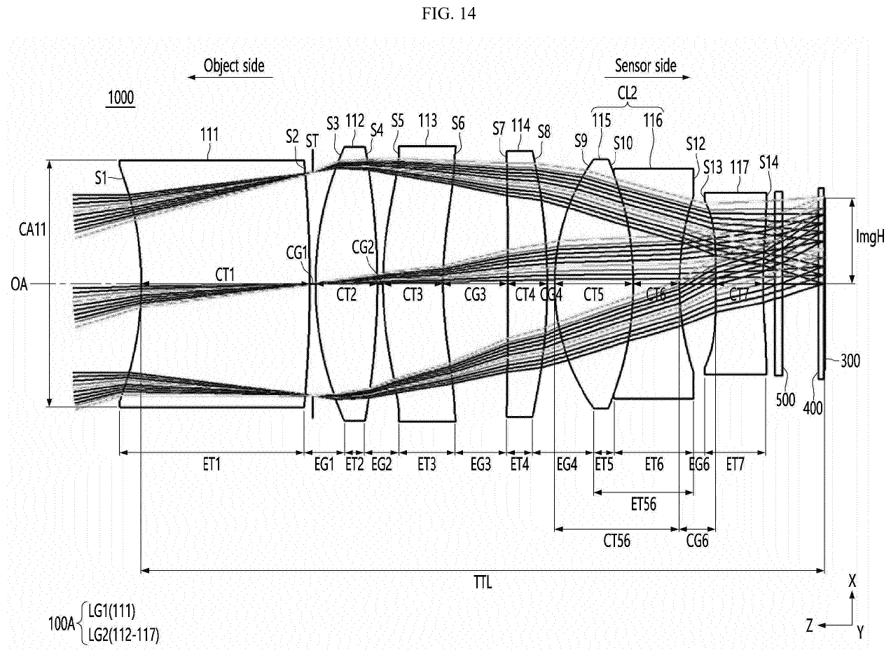

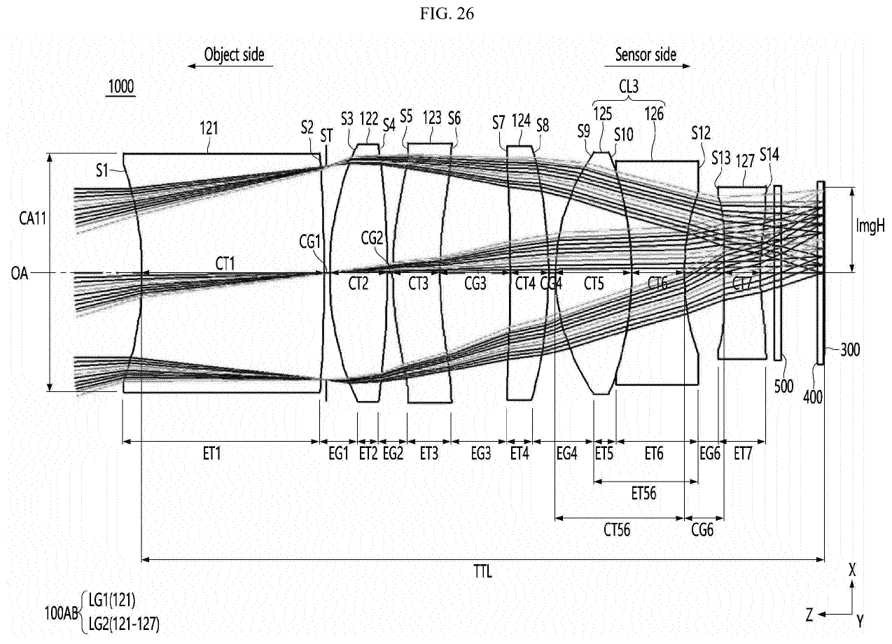

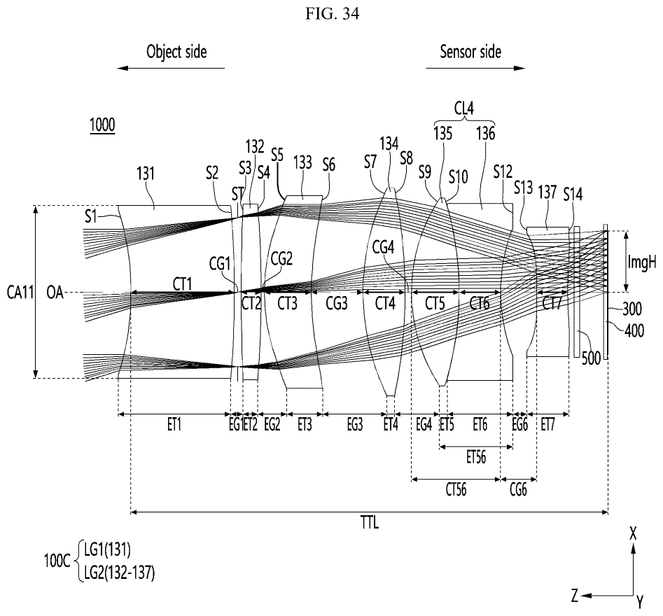

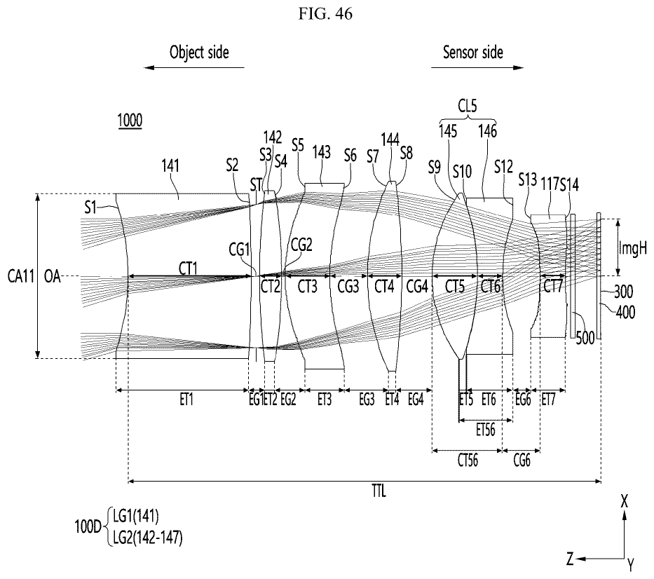

As shown in FIG. 1, FIG. 14, FIG. 26, FIG. 34, and FIG. 46, the optical system 1000 according to the embodiment of the invention may include a plurality of lens groups LG1 and LG2. In detail, each of the plurality of lens groups LG1 and LG2 includes at least one lens. For example, the optical system 1000 may include a first lens group LG1 and a second lens group LG2 sequentially arranged along the optical axis OA from the object side toward the image sensor 300. The number of lenses of each of the first lens group LG1 and the second lens group LG2 may be different from each other. The number of lenses of the second lens group LG2 may be greater than the number of lenses of the first lens group LG1, and for example, may be more than four times or more than five times the number of lenses of the first lens group LG1. The lenses of the first lens group LG1 and the second lens group LG2 may be defined as lens sections 100, 100A, 100B, 100C, and 100D.

The first lens group LG1 may include at least one lens. The first lens group LG1 may have two or fewer lenses. The first lens group LG1 may preferably be one lens. The second lens group LG2 may include two or more lenses. The second lens group LG2 may have five or more lenses, and preferably six lenses. The optical system 1000 may include n lenses, the n-th lens may be the last lens, and the n−1th lens may be the lens closest to the last lens. The n is an integer greater than or equal to 5, for example, 5 to 8.

The first lens group LG1 may include at least one glass lens. The first lens group LG1 may provide a lens closest to the object side as a glass lens. Such a glass material has a small amount of expansion and contraction change due to external temperature change, and its surface is not easily scratched, thereby preventing surface damage. The lens material of the second lens group LG2 may include glass lenses. The second lens group LG2 may include five or more glass lenses, for example, five to seven glass lenses. The lenses of the first and second lens groups LG1 and LG2 may all be made of glass, and the glass lenses have a smaller amount of expansion and contraction due to temperature change than plastic lenses, and can prevent deterioration of optical characteristics through heat compensation. As another example, one or two lenses of the second lens group LG2 closest to the image sensor 300 may be provided as plastic or as an aspherical lens.

The lens of the first lens group LG1 may be a spherical lens. The lenses of the second lens group LG2 may include at least one aspherical lens and two or more spherical lenses. The aspherical lens is a lens whose object-side surface and sensor-side surface are aspherical, and the spherical lens is a lens whose object-side surface and sensor-side surface are spherical. The number of spherical lenses in the second lens group LG2 may be at least twice the number of aspherical lenses. The aspherical lenses may prevent spherical aberration within the optical system 1000, and since aberration does not occur even when the effective diameter is increased, miniaturization and weight reduction of the camera module may be possible. The aspherical lens may be made of a glass mold material. The lenses of the second lens group LG2 may include at least one non-molded lens and at least one molded lens. For example, the number of non-molded lenses made of glass in the second lens group LG2 may be at least twice as many as the number of molded lenses made of glass. The materials of the non-molded lenses and the molded lenses may both be glass, and the non-molded lenses are lenses that are finely processed without injection molding, while the molded lenses are injection molded lenses.

The optical system 1000 is arranged with lenses made of glass, and since the rate of change in shrinkage and expansion of the lenses made of glass is smaller than that of the plastic material due to temperature change, heat compensation is possible within the lens barrel, and deterioration of optical characteristics due to temperature change may be suppressed. In addition, since the lenses made of glass include at least two or more aspherical lenses, the occurrence of various aberrations may be suppressed.

Among the lenses of the optical system 1000, the lens having the maximum Abbe number may be positioned in the second lens group LG2, and the lens having the maximum refractive index may be positioned in the first lens group LG1 or the second lens group LG2. In the first to fifth embodiments, the maximum Abbe number may be 55 or more, and the maximum refractive index may be 1.70 or more. The lens having the maximum Abbe number may reduce chromatic dispersion, and the lens having the maximum refractive index may increase chromatic dispersion of incident light. Preferably, the maximum Abbe number may be 65 or more in the fourth and fifth embodiments.

As shown in FIG. 1, the lens having the maximum effective diameter in the lens portion 100 may be a lens positioned on the sensor side of the aspherical lens closest to the object side. Here, the object-side aspherical lens may be positioned on the object side and the other may be positioned closest to the sensor side when there are two or more aspherical lenses. As shown in FIGS. 14 and 26, the lens having the maximum effective diameter within the lens portions 100A and 100B may be the aspherical lens closest to the object side. Here, when there are two or more aspherical lenses, one may be positioned on the object side and the other may be positioned on the sensor side. As shown in FIGS. 34 and 46, the lens having the maximum effective diameter within the lens portions 100C and 100D may be positioned on the object side or the sensor side of the aspherical lens, for example, may be a lens positioned closer to the sensor side than the aspherical lens. Here, when there are two aspherical lenses, one may be the first aspherical lens positioned on the object side and the other may be the second aspherical lens positioned on the sensor side.

In the optical system 1000, a lens having a maximum effective diameter may be a glass lens, for example, a spherical lens made of glass. The effective diameter of each lens may be the diameter of an effective region where effective light is incident on each lens, and is an average of the effective diameter on the object-side surface and the effective diameter on the sensor-side surface. According to an embodiment of the invention, by further mixing an aspherical lens into the optical system 1000, the weight of the camera module may be reduced, the manufacturing cost may be provided more cheaply, and the deterioration of optical characteristics due to temperature change may be suppressed. Each of the lenses may include an effective region and an ineffective region. The effective region may be a region through which light incident on each of the lenses passes. That is, the effective region may be defined as an effective region or an effective diameter where the incident light is refracted to implement optical characteristics. The ineffective region may be arranged around the effective region. The ineffective region may be a region where effective light is not incident on the plurality of lenses. That is, the non-effective region may be a region unrelated to the optical characteristics. In addition, the end of the non-effective region may be a region fixed to a lens barrel (not shown) that accommodates the lens.

In the optical system 1000, the TTL (Total top length) may be more than 4 times the ImgH, for example, more than 4 times and less than 15 times. Preferably, the following condition may satisfy: 4<TTL/ImgH<10. The TTL (Total track length) is a distance from the center of the object-side surface of the first lens to the surface of the image sensor 300 on the optical axis OA. The ImgH is a distance from the optical axis OA to the diagonal end of the image sensor 300 or ½ of the maximum diagonal length of the image sensor 300. In the optical system 1000, the EFL is provided to be 10 mm or more and the diagonal field of view (FOV) is provided to be less than 45 degrees, so that it may be provided as a standard optical system in a vehicle camera module. For example, the optical system and camera module according to the embodiment may be applied to a camera module for an ADAS (Advanced driving assistance system) installed inside or outside a vehicle.

The optical system 1000 may satisfy the following Equation: 2<TTL/(2*ImgH), for example, 2<TTL/(2*ImgH)<7.5 or 2<TTL/(2*ImgH)<5. The optical system 1000 can provide a vehicle lens optical system by setting the value of TTL/(2*ImgH) to be greater than 2. The total number of lenses of the first and second lens groups LG1 and LG2 is 8 or less. Accordingly, the optical system 1000 can provide an image without exaggeration or distortion for the image being formed.

The length of the image sensor 300 is the maximum length of the diagonal in the direction orthogonal to the optical axis OA. The number of lenses having an effective diameter greater than the length of the image sensor 300 in the optical system 1000 is more than 70%, and the number of lenses having an effective diameter smaller than the length of the image sensor 300 is 30% or less, for example, in the range of 10% to 30%. At least one of the aspherical lenses on the optical system 1000 may have an effective diameter smaller than the length of the image sensor 300, and at least one may have an effective diameter larger than the length of the image sensor 300. The effective diameter of the lens closest to the object side in the lens portion 100, 100A, 100B, 100C, and 100D may be larger than the effective diameter of the lens closest to the image sensor 300. Accordingly, the brightness of the optical system may be controlled. By controlling the effective diameter size of each of the lenses, the optical system 1000 can control the incident light to compensate for the deterioration of the optical characteristics due to resolution and temperature change, improve the chromatic aberration control characteristics, and improve the vignetting characteristics of the optical system 1000.

As shown in FIG. 1, FIG. 14, FIG. 26, FIG. 34, and FIG. 46, the optical system 1000 or the lens portions 100, 100A, 100B, 100C, and 100D may include at least one cemented lens CL1-CL5. The above-described cemented lens CL1-CL5 may be a lens in which two lenses having different focal lengths are bonded. The object-side surface and the sensor-side surface of the cemented lens CL1-CL5 may have an effective diameter greater than the length of the image sensor 300. The effective diameter of the lens(es) positioned on the sensor side relative to the cemented lens CL1-CL5 may be smaller than the length of the image sensor 300. In addition, the effective diameter of the lenses positioned on the object side relative to the cemented lens CL1-CL5 may be greater than the length of the image sensor 300. The sensor-side surface of the cemented lens CL1-CL5 may be positioned in a range of 100% to 110% of the length of the image sensor 300. The object-side surface and the sensor-side surface of the cemented lens CL1 may be spherical.

The optical system 1000 according to the embodiments may include an aperture stop ST. The aperture stop ST can control the amount of light incident on the optical system 1000. The aperture stop ST may be arranged between any two lenses in the lens portions 100, and 100A-100D. In the lenses arranged between the object and the aperture stop ST, the effective diameter of the lens surface tends to become smaller as it goes from the object side to the aperture stop ST. In the lenses arranged between the aperture stop ST and the image sensor 300, the effective diameters of the lens surfaces tend to become larger or smaller as it goes from the aperture stop ST to the sensor side. The meaning of ‘the effective diameters of the lenses tend to become larger or smaller as it goes from the aperture stop ST to the sensor side’ may include lenses arranged between the aperture stop ST and the image sensor 300 in which the effective diameters of the lens surfaces become larger or smaller as it goes from the aperture stop ST to the sensor side. In the lenses arranged between the aperture stop ST and the image sensor as in an embodiment of the present invention, there is also a case where the effective diameter of the lens surfaces increases and then decreases as it moves from the aperture stop ST toward the sensor.

Here, the effective diameters of the first lens 101, 111, 121, 131, and 141 to the fourth lens 104, 114, 124, 134, and 144 are defined as CA1, CA2, CA3, CA4, and the effective diameters of the object-side surface and the sensor-side surface of the first lens to the fourth lens may be defined as CA11, CA12, CA21, CA22, CA31, CA32, CA42. The first lens 101, 111, 121, 131, and 141 may be arranged on the object side of the aperture stop ST, and the second lens 102, 112, 122, 132, and 142, the third lens 103, 113, 123, 133, 143, and the fourth lens 104, 114, 124, 134, and 144 may be arranged on the sensor side of the aperture stop ST.

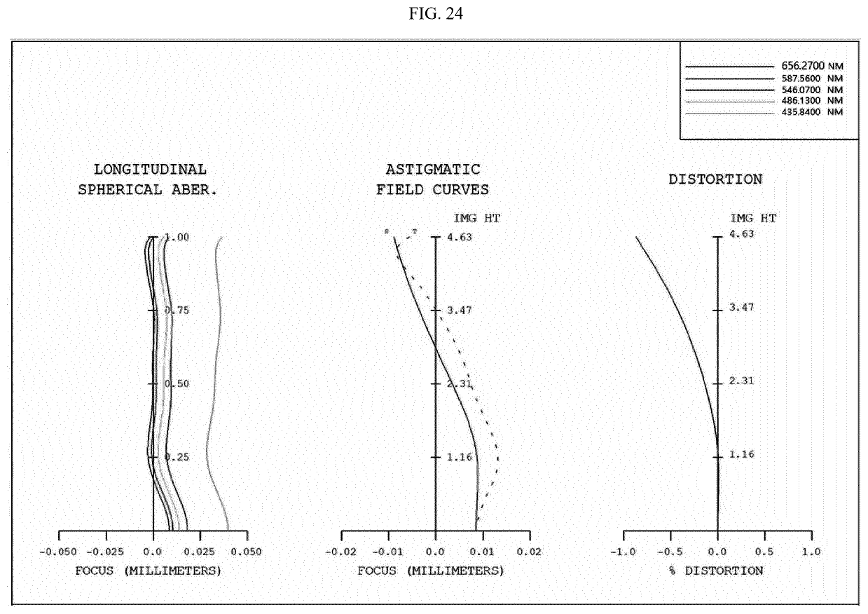

As shown in FIG. 1, when the aperture stop ST is arranged on the sensor-side surface of the first lens 101, the following condition may satisfy: CA12 (or effective diameter of the aperture stop)<CA11<CA21<CA22. The following condition satisfies: CA22<CA31<CA41. As shown in FIG. 24 and FIG. 26, when the aperture stop ST is arranged on the sensor-side surface of the first lens 111 and 121, the following conditions may be satisfied.

$$Condition 1 : CA 1 < CA 2 < CA 3 ,$$

$$Condition 2 : CA 4 < CA 3 ,$$

$$Condition 3 : CA 1 < CA 4 < CA 2$$

$$Condition 4 : CA 11 \leq CA 12 < CA 21 < CA 22 < CA 31$$

$$Condition 5 : CA 42 < CA 41 < CA 32 < CA 31$$

As shown in FIG. 34 and FIG. 46, when the aperture stop ST is arranged on the sensor-side surface of the first lens 131 and 141, the following conditions may be satisfied.

$$Condition 1 : CA 1 \leq CA 2 < CA 3 ,$$

$$Condition 2 : CA 3 < CA 4 ,$$

$$Condition 3 : ( 2 * ImgH ) < CA 1 < CA 4$$

$$Condition 4 : CA 12 \leq CA 21 \leq CA 11 \leq CA 22 \leq CA 31$$

$$Condition 5 : CA 31 \leq CA 32 < CA 42 \leq CA 41$$

As another example, the aperture stop ST may be arranged around the object-side surface of the lens closest to the object side among the lenses of the second lens group LG2.

The aperture stop ST may be arranged at a set position. For example, the aperture stop ST may be arranged around the object-side surface of the lens closest to the object side among the lenses of the second lens group LG2. Alternatively, the aperture stop ST may be arranged around the object-side surface of the object-side lens of the first lens group LG1. In contrast, at least one lens selected from the plurality of lenses may function as an aperture stop. In detail, the object-side surface or the sensor-side surface of one lens selected from the lenses of the optical system 1000 may function as an aperture stop for controlling the amount of light.

The optical axis distance between the first lens group LG1 and the second lens group LG2 in the optical axis OA may be the optical axis distance between the sensor-side surface of the lens closest to the sensor side among the lenses in the first lens group LG1 and the object-side surface of the lens closest to the object side among the lenses in the second lens group LG2. The optical axis distance between the first lens group LG1 and the second lens group LG2 may be smaller than the center distance between adjacent object-side aspherical lenses and sensor-side spherical lenses in the lens portions 100, and 100A-100D. In addition, the optical axis distance between the first lens group LG1 and the second lens group LG2 may be smaller than the center distance between the adjacent object-side spherical lens and the sensor-side aspherical lens. The optical axis distance between the first lens group LG1 and the second lens group LG2 may be the center distance between the spherical lenses.

In FIG. 1, the optical axis distance between the first lens group LG1 and the second lens group LG2 may be less than 1 time the optical axis distance of the first lens group LG1, for example, greater than 0 and less than 0.5 times the optical axis distance of the first lens group LG1. The optical axis distance between the first lens group LG1 and the second lens group LG2 may be less than 0.5 times the optical axis distance of the second lens group LG2, for example, greater than 0 and less than 0.2 times. In FIG. 14, FIG. 26, FIG. 34, and FIG. 46, the optical axis distance between the first lens group LG1 and the second lens group LG2 may be less than 1 time the optical axis distance of the first lens group LG1, for example, greater than 0 and less than 0.1 times the optical axis distance of the first lens group LG1. The optical axis distance between the first lens group LG1 and the second lens group LG2 may be less than 0.5 times the optical axis distance of the second lens group LG2, for example, greater than 0 and less than 0.05 times the optical axis distance. The optical axis distance of the first lens group LG1 is an optical axis distance from the object-side surface to the sensor-side surface. The optical axis distance of the second lens group LG2 is an optical axis distance between the object-side surface of the lens closest to the object side of the second lens group LG2 and the sensor-side surface of the lens closest to the image sensor 300.

Here, the first lens group LG1 may be a lens located closer to the object side than the aperture stop ST, and the second lens group LG2 may be a lens located closer to the sensor side than the aperture stop ST. The first lens group LG1 and the second lens group LG2 may be divided into an object-side lens group and a sensor-side lens group based on the aperture stop ST. The sensor-side surface of the first lens group LG1 may have a convex shape on the optical axis, and the object-side surface of the second lens group LG2 may have a convex shape on the optical axis, and may be opposite to each other.

The first lens group LG1 may have negative (−) refractive power, and the second lens group LG2 may have positive (+) refractive power. The lens closest to the object in the first lens group LG1 may have negative (−) refractive power, and the lens closest to the image sensor among the lenses in the second lens group LG2 may have negative (−) refractive power. That is, the focal length of the lenses in the first lens group LG1 has a negative value, and the composite focal length of the lenses in the second lens group LG2 has a positive value. When the focal length of the first lens group LG1 is F_LG1, and the focal length of the second lens group LG2 is F_LG2, F_LG1<F_LG2 may be satisfied, and preferably, |F_LG1|>F_LG2 may be satisfied. That is, F_LG1<0 may be satisfied.

Here, when the composite focal length of the first lens 101, 111, 121, 131, and 141 to the third lens 103,113,123,133, and 143 on the optical system 1000 is set to F13 and the composite focal length of the fourth lens 104,114,124,134, and 144 to the seventh lens 107,117,127,137, and 147 is set to F47, F13<F47 may be satisfied and F13, F47>0 may be satisfied. In addition, FLG2<F13, |F_LG1|<F47 may be satisfied. Here, F_LG1 is the focal length of the first lens 101,111,121,131, and 141 and may be defined as F1, and F_LG2 is the composite focal length of the second lens 102,112,122,132, and 142 to the seventh lens 107,117,127,137, and 147 and may be defined as F27. The first lens group LG1 diffuses light incident through the object side, and the second lens group LG2 may be in close contact with the sensor-side surface of the first lens group LG1 and refract light emitted through the first lens group LG1 to the image sensor 300. The optical axis distance between the first lens group LG1 and the second lens group LG2 may be less than 1 mm, for example, 0.8 mm or less.

When the focal length is expressed as an absolute value, the focal length of the first lens group LG1 may be 1.5 times or more, for example, 1.5 to 7 times, of the focal length of the second lens group LG2. The effective focal length (EFL) of the optical system 1000 may be smaller than the absolute value of the focal length of the first lens group LG1. The EFL of the optical system 1000 may be smaller than the absolute value of the focal length of the first lens group LG1 and larger than the absolute value of the focal length of the second lens group LG2.

The lens portions 100, and 100A-100D may be a mixture of spherical lenses and aspherical lenses. The number of lenses of the aspherical lenses may be less than 50% of the total number of lenses, and may be in the range of 10 to 45%. When representing the absolute value of the focal length, the average of the composite focal lengths of the spherical lenses may be smaller than the average of the composite focal lengths of the aspherical lenses. The average of the refractive indices of the aspherical lenses may be smaller than the average of the refractive indices of the spherical lenses. In addition, the difference between the average effective diameter of the spherical lenses and the average effective diameter of the aspherical lenses may be 1 mm or more, for example, in the range of 1 mm to 3 mm. Accordingly, when two or more aspherical lenses are arranged in the camera module, the weight of the camera module may be reduced and the optical characteristics may be improved. The average Abbe number of the spherical material lenses in the lens portions 100, and 100A-100D may be larger than the average Abbe number of the aspherical lenses. Since the lens adjacent to the image sensor 300 is arranged to have a low Abbe number and a high refractive index, color dispersion may be improved by the lenses adjacent to the image sensor 300. For example, the product of the Abbe number and the refractive index of the n-th lens, which is the last lens, may be less than the product of the Abbe number and the refractive index of each of the n−2th, n−3rd, n−4th, or n−5th lenses. Also, the product of the Abbe number and the refractive index of the n−1th lens may be less than the product of the Abbe number and the refractive index of each of the n−2nd, n−3rd, n−4th, or n−5th lenses.

In the optical system 1000, the number of lenses having negative (−) refractive power may be less than the number of lenses having positive (+) refractive power. The number of lenses having negative (−) refractive power may be less than 50% of the total number of lenses, for example, may be in the range of 20% to 45%.

The sum of the refractive indices of the lenses of the lens portions 100, and 100A-100D of the embodiments may be 8 or more, for example, in the range of 8 to 15, and the average of the refractive indices may be in the range of 1.60 to 1.72. The sum of the Abbe numbers of each of the lenses may be 220 or more, for example, in the range of 220 to 380, and the average of the Abbe numbers may be 55 or less, for example, in the range of 31 to 55. The sum of the center thicknesses of the entire lens may be 15 mm or more, for example, in the range of 15 mm to 32 mm, 21 mm to 30 mm, or 15 mm to 28 mm. The average of the center thicknesses of the entire lens may be 4 mm or 4.2 mm or less, for example, in the range of 2.7 mm to 4 mm, or 3 mm to 4.2 mm. The sum of the center distances between the lenses in the optical axis OA may be 4.5 mm or more, or 5 mm or more, for example, in a range of 5 mm to 20 mm, 4.5 mm to 20 mm, or 5 mm to 10 mm, and may be less than the sum of the center thicknesses of the lenses. In addition, the average value of the effective diameter of each lens surface of the lens portions 100, and 100A-100D may be provided as 8 mm or more, for example, in a range of 8 mm to 15 mm. The difference between the maximum and minimum effective diameters may have a difference of 7.5 mm or less, or 5 mm or less. Therefore, an optical system in which the difference in the effective diameter of each lens surface is not large may be provided, and the assembling performance of lenses assembled in the lens barrel may be improved.

In the lens portions 100, and 100A-100D, the number of aspherical lenses is Ma, the number of lenses having an effective diameter smaller than the diagonal length of the image sensor 300 is Mb, and the number of lenses having negative refractive power is Mc, then the following condition may satisfy: Mb≤Ma<Mc, and preferably the following condition may satisfy: Mb<Ma. In the lens portion 100, and 100A-100D, the number of lens surfaces having aspherical surfaces is Ma1, the number of lens surfaces having an effective diameter smaller than the diagonal length of the image sensor 300 is Mb1, and the number of lenses having negative refractive power is Mc, then the following condition may satisfy: Mb1≤Mc<Ma1, and preferably the following condition may satisfy: Mb1<Mc. The lens surfaces are the object-side surface and the sensor-side surface of each lens.

In the lens portion 100, and 100A-100D, the number of aspherical lens surfaces is Ma1, the number of aspherical lens surfaces having an effective diameter smaller than the diagonal length of the image sensor 300 is Ma2, and the number of lenses having negative refractive power is Mc, then the following condition may satisfy: Ma2<Mc<Ma1. In the lens portion 100, the number of spherical lenses is Ga, the number of lenses having an effective diameter larger than the diagonal length of the image sensor 300 is Gb, and the number of lenses having positive refractive power is Gc, then the following condition may satisfy: Gc<Ga≤Gb, and preferably the following condition may satisfy: Ga<Gb.

The F number of the optical system or camera module according to the embodiments of the invention may be 2.4 or less, for example, in the range of 1.4 to 2.4 or in the range of 1.5 to 1.8. In the optical system according to embodiments of the invention, the maximum field of view (diagonal) may be 50 degrees or less, for example, in a range of 20 to 55 degrees or 25 to 40 degrees. The vehicle optical system may have a horizontal field of view (FOV_H) in the Y-axis direction that is greater than 20 degrees and less than 40 degrees, for example, in a range of 25 to 35 degrees. In addition, a vertical field of view is provided at a smaller angle than the horizontal field of view, and may be 20 degrees or less, for example, in a range of 10 to 20 degrees. At this time, a sensor length in the horizontal direction Y may be 8.064 mm±0.5 mm, and a sensor height in the vertical direction X may be 4.54 mm±0.5 mm. The horizontal field of view (FOV_H) is a field of view based on the horizontal length of the sensor. Accordingly, it is possible to suppress the change in the focus position due to temperature change, and provide a vehicle camera in which various aberrations are well corrected.

The optical system 1000 or the camera module may include an image sensor 300. The image sensor 300 may detect light and convert it into an electrical signal. The image sensor 300 may detect light that has sequentially passed through the lens portion 100. The image sensor 300 may include a device capable of detecting incident light, such as a CCD (Charge coupled device) or a CMOS (Complementary metal oxide semiconductor). In this regard, the length of the image sensor 300 is a maximum length in a diagonal direction orthogonal to the optical axis OA, and may be smaller than the effective diameter of the lens closest to the object side in the first lens group LG1 and larger than the effective diameter of the lens closest to the sensor side in the second lens group LG2. Here, the number of lenses having an effective diameter larger than the length of the image sensor 300 may be 5 to 6, and the number of lenses having an effective diameter smaller than the length of the image sensor 300 may be 1 to 2.

The optical system 1000 or camera module may include an optical filter 500. The optical filter 500 may be disposed between the second lens group LG2 and the image sensor 300. The optical filter 500 may be disposed between the lens closest to the sensor side among the lenses of the lens portion 100 and the image sensor 300. For example, the optical system 100 may be disposed between the last lens and the image sensor 300.

A cover glass 400 is disposed between the optical filter 500 and the image sensor 300, and may protect the upper portion of the image sensor 300 and prevent a decrease in the reliability of the image sensor 300. The cover glass 400 may be removed. The optical filter 500 may include an infrared filter or an infrared cut-off (IR cut-off) filter. The optical filter 500 can pass light of a set wavelength band and filter light of a different wavelength band. If the optical filter 500 includes an infrared filter, it can block radiant heat emitted from external light from being transmitted to the image sensor 300. In addition, the optical filter 500 can transmit visible light and reflect infrared light.

The optical system 1000 according to the embodiment may further include a reflective member (not shown) for changing the path of light. The reflective member may be implemented as a prism that reflects the incident light of the first lens group LG1 toward the lenses. Hereinafter, the optical system according to the embodiment will be described in detail.

The optical system of the embodiments may be applied to a vehicle camera, and an aspherical lens and a spherical lens may be used together, and the material of the first lens 101, 111, 121, 131, and 141 may be provided as a glass material. This has the advantage that the glass material is more scratch-resistant and less sensitive to external temperature than the plastic material. In order to more effectively prevent scratches by foreign substances or when placed inside a vehicle, a glass lens is used as the first lens 101, 111, 121, 131, and 141, and the object-side surface of the first lens 101, 111, 121, 131, and 141 may have a concave shape so as not to come into contact with external structures. If the object-side surface of the first lens 101, 111, 121, 131, and 141 is designed to have a convex shape, scratches may occur due to contact with external structures. In order to monitor the driver while driving, film the front/rear of the vehicle, detect lanes, and detect unexpected objects around the vehicle, the horizontal field of view may be more than 20 degrees and less than 40 degrees, and may be, for example, in the range of 25 degrees to 35 degrees. This horizontal field of view may be a preset angle for an advanced driver assistance system (ADAD).

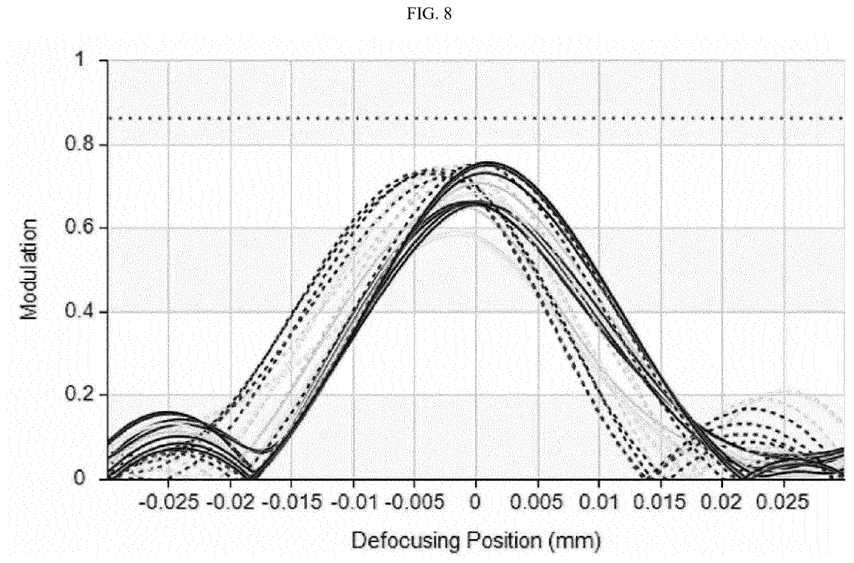

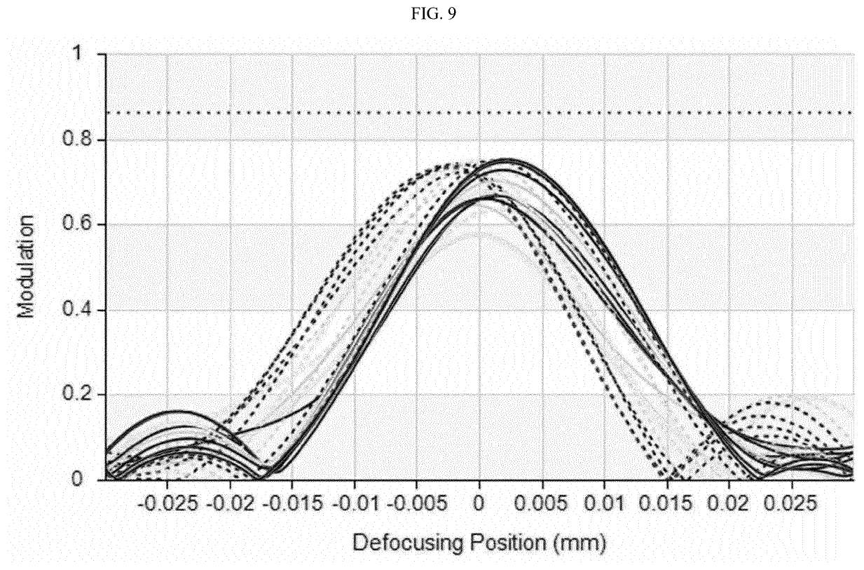

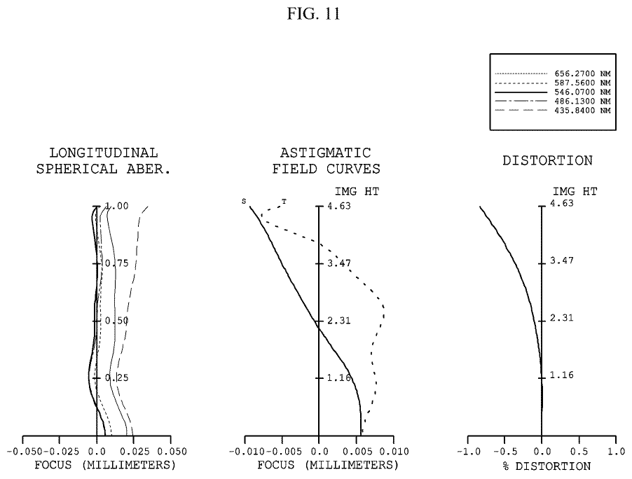

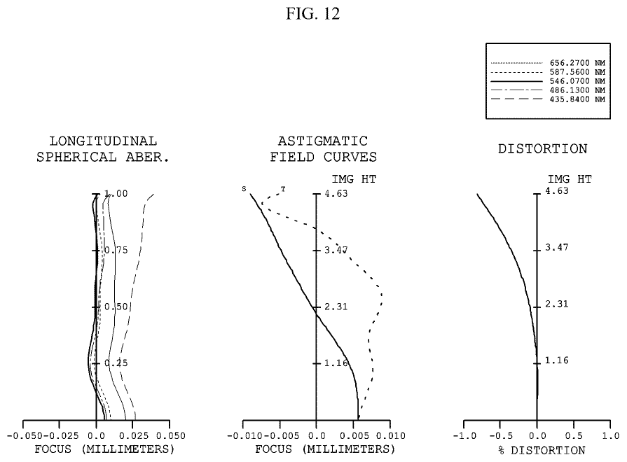

An optical system according to a first embodiment of the invention will be described with reference to FIGS. 1 to 12.

Referring to FIGS. 1 to 3, the lens portion 100 of an optical system 1000 according to the first embodiment may include a first lens 101 to a seventh lens 107. The first to seventh lenses 101-107 may be sequentially aligned along an optical axis OA. Light corresponding to information about an object may pass through the first lens 101 to the seventh lens 107 and the optical filter 500 and be incident on an image sensor 300. The first lens 101 is the lens closest to the object in the first lens group LG1. The seventh lens 107 is the lens closest to the image sensor 107 in the second lens group LG2 or lens portion 100. The first lens 101 may be the first lens group LG1, and the second to seventh lenses 102-107 may be the second lens group LG2.

The first lens 101 may have positive (+) or negative (−) refractive power on the optical axis OA. The first lens 101 may have negative (−) refractive power. The first lens 101 may include a plastic material or a glass material, and may be, for example, a non-molded lens made of glass material or a glass material. The first lens 101 made of glass material may reduce changes in the center position and the radius of curvature due to temperature changes in the surrounding environment, and may protect the incident side surface of the optical system 1000.

The object-side first surface S1 of the first lens 101 may be concave on the optical axis, and the sensor-side second surface S2 may be convex. The first lens 101 may have a meniscus shape that is convex toward the sensor side on the optical axis. Differently, the first surface S1 may have a convex shape and the second surface S2 may have a concave shape on the optical axis OA. The first lens 101 may be provided with a glass material having the thickest thickness, so that the rigidity may be prevented from being deteriorated due to external impact, and when the temperature changes to low or high temperature due to the glass material, the optical performance may be maintained constant. In addition, since a spherical surface is applied to the glass material, even if the thickness of the lens is designed to be thick, the change in the refractive index of light is not large. Here, the thickness of the lens may be an average of the center thickness and the edge thickness. The thickness of the first lens 101 may be the thickest in the lens portion 100. The thickness of the first lens 101 may be thicker than the thickness of the cemented lens CL1. The center thickness of the first lens 101 may be thicker than the center thickness of the cemented lens CL1. The edge thickness of the first lens 101 may be thicker than the edge thickness of the cemented lens CL1.

Since the first surface S1 is concave and the second surface S2 is convex on the optical axis, the incident light may be refracted in a direction away from the optical axis, and the center distance CG1 between the first and second lenses 101 and 102 may be reduced and the effective diameter of the second lens 102 may be reduced. The first surface S1 of the first lens 101 may be provided without a critical point from the optical axis OA to the end of the effective region, i.e., the edge. The second surface S2 of the first lens 101 may be provided without a critical point.

The aperture stop ST may be arranged around the sensor-side surface of the first lens 101. Alternatively, the aperture stop ST may be arranged around the object-side or sensor-side surface of the second lens 102, or around the object-side surface of the third lens 103.

The second lens 102 may be disposed between the first lens 101 and the third lens 103. The second lens 102 may have positive (+) or negative (−) refractive power on the optical axis OA. The second lens 102 may have positive (+) refractive power. The second lens 102 may include a plastic or glass material. For example, the second lens 102 may be provided as a glass material. The object-side third surface S3 of the second lens 102 may be convex on the optical axis OA, and the sensor-side fourth surface S4 may be convex. The second lens 102 may have a shape in which both sides are convex on the optical axis. Alternatively, the third surface S3 may be convex, and the fourth surface S4 may be concave. In contrast, the second lens 102 may have a shape in which both sides are concave. The second lens 102 may be provided as a spherical lens made of glass. The third surface S3 and the fourth surface S4 may be spherical. At least one or both of the third surface S3 and the fourth surface S4 may be provided without a critical point from the optical axis OA to the end of the effective region.

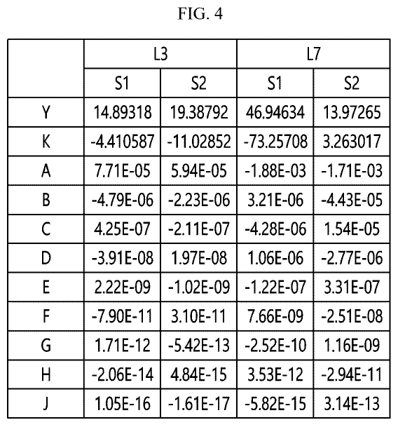

The third lens 103 may have positive (+) or negative (−) refractive power on the optical axis OA. The third lens 103 may have positive (+) refractive power. The third lens 103 may include a plastic or glass material. For example, the third lens 103 may be provided as a glass material or a glass mold material. The object-side fifth surface S5 of the third lens 103 based on the optical axis may be convex, and the sensor-side sixth surface S6 may be concave. The third lens 103 may have a meniscus shape convex toward the object side on the optical axis. Alternatively, the third lens 103 may have a meniscus shape convex toward the sensor side on the optical axis. Alternatively, the third lens 103 may have a shape in which both sides are concave on the optical axis. The third lens 103 may be provided as an aspherical lens made of glass. The fifth surface S5 and the sixth surface S6 may be aspherical, and the aspherical coefficients may be provided as L3S1 and L3S2 of FIG. 4. At least one or both of the fifth surface S5 and the sixth surface S6 may be provided without a critical point from the optical axis OA to the end of the effective region.

The optical system 1000 may include at least one, for example, 1 to 3, aspherical glass lenses. The effective radius of the fifth surface S5 or the sixth surface S6 of the third lens 103 may be larger than the effective radii of the object-side surface or the sensor-side surface of the first lens 101 or the seventh lens 107. The effective diameter of the third lens 103 may have the second largest effective diameter in the lens portion 100. The effective diameter of the third lens 103 may have the largest effective diameter among the aspherical lenses. Since the second lens 102 arranged on the sensor side of the aperture stop ST has positive refractive power (F2>0), the second lens 102 may refract incident light in the direction of the optical axis, and may suppress an increase in the effective diameters of the sensor-side or rear-side lenses of the second lens 102. Accordingly, the yield by weight of the optical system may be prevented from decreasing by the second lens 102 and the production efficiency may be improved. Here, the composite focal length of the second to seventh lenses 102-107 arranged on the sensor side of the aperture stop ST may have a positive value, and the TTL may be reduced within the field of view range. The distance between the second lens 102 and the third lens 103 can gradually increase from the center to the edge. This distance can gradually increase from the optical axis to the edge due to the convex shape of the sensor-side surface of the second lens 102 and the convex shape of the object-side surface of the third lens 103.

The fourth lens 104 may have positive (+) or negative (−) refractive power on the optical axis OA. The fourth lens 104 may have positive (+) refractive power. The fourth lens 104 may include a plastic or glass material. For example, the fourth lens 104 may be provided as a glass material. The object-side seventh surface S7 of the fourth lens 104 with respect to the optical axis may be convex, and the sensor-side eighth surface S8 may be convex. The fourth lens 104 may have a shape in which both sides are convex on the optical axis. Alternatively, the seventh surface S7 may have a concave shape on the optical axis OA, and the eighth surface S8 may have a concave or convex shape. Alternatively, the fourth lens 104 may have a meniscus shape that is convex toward the sensor side. The fourth lens 104 may be provided as a spherical lens made of glass. The seventh surface S7 and the eighth surface S8 may be spherical. The seventh surface S7 and the eighth surface S8 may be provided without a critical point from the optical axis OA to the end of the effective region.

The fifth lens 105 may have positive (+) or negative (−) refractive power on the optical axis OA. The fifth lens 105 may have positive (+) refractive power. The fifth lens 105 may include a plastic or glass material. For example, the fifth lens 105 may be provided with a glass material. With respect to the optical axis OA, the object-side ninth surface S9 of the fifth lens 105 may be convex, and the sensor-side tenth surface S10 may be convex. The fifth lens 105 may have a shape in which both sides are convex on the optical axis OA. In contrast, the ninth surface S9 may have a concave shape and the tenth surface S10 may have a convex shape on the optical axis OA. In contrast, the ninth surface S9 may have a concave shape and the tenth surface S10 may have a concave shape. The fifth lens 105 may be a spherical lens. The ninth surface S9 and the tenth surface S10 of the fifth lens 105 may be spherical. At least one or both of the ninth surface S9 and the tenth surface S10 may be provided without a critical point from the optical axis OA to the end of the effective region.

The sixth lens 106 may have positive (+) or negative (−) refractive power on the optical axis OA. The sixth lens 106 may have negative (−) refractive power. The sixth lens 106 may include a plastic or glass material. For example, the sixth lens 106 may be provided as a glass material. With respect to the optical axis OA, the object-side eleventh surface of the sixth lens 106 may be concave, and the sensor-side twelfth surface S12 may be concave. The sixth lens 106 may have a shape in which both sides are concave on the optical axis OA. Alternatively, the sixth lens 106 may have a convex meniscus shape toward the sensor side, or a convex shape on both sides. The sixth lens 106 may be spherical. For example, the eleventh surface and the twelfth surface S12 may be spherical. The eleventh surface of the sixth lens 106 may be provided without a critical point from the optical axis OA to the end of the effective region. The twelfth surface S12 may be provided without a critical point from the optical axis OA to the end of the effective region.

The fifth lens 105 and the sixth lens 106 may be joined and defined as a cemented lens CL1. The bonded surface between the fifth lens 105 and the sixth lens 106 may be defined as a tenth surface S10. The tenth surface S10 may be the same surface as the eleventh surface of the sixth lens 106. When the distance between the fifth and sixth lenses 105 and 106 is G5, the G5 may be less than 0.01 mm. The distance G5 between the fifth and sixth lenses 105 and 106 may be less than 0.01 mm from the optical axis OA to the end of the effective region. The fifth and sixth lenses 105 and 106 may have opposite refractive powers. The composite refractive power of the fifth and sixth lenses 105 and 106 may have positive (+) refractive power. The product of the refractive power of the object-side fifth lens 105 of the cemented lens CL1 and the refractive power or focal length of the sensor-side sixth lens 106 may be less than 0. Accordingly, the aberration characteristics of the optical system may be improved. If the signs of the refractive powers of the two lenses of the cemented lens CL1 are the same, there is a limit to the improvement of aberration.

The composite refractive power of the cemented lens CL1 may have positive refractive power, and the fourth lens 104 arranged on the object side based on the cemented lens CL1 may have positive refractive power, and the seventh lens 107 arranged on the sensor side may have negative refractive power. Accordingly, the fourth lens 104, the cemented lens CL1, and the seventh lens 107 may refract some of the incident light in the direction of the optical axis.

The effective diameter of the cemented lens CL1 may be greater than the diagonal length of the image sensor 300. The effective diameter of the fifth lens 105 is the average of the effective diameters of the ninth surface S9 and the tenth surface S10, and each of the effective diameters of the ninth surface S9 and the tenth surface S10 may be larger than the diagonal length of the image sensor 300. The effective diameter of the sixth lens 106 may be smaller than the effective diameter of the fifth lens 105 and larger than the diagonal length of the image sensor 300. The effective diameter of the seventh surface S7 of the fourth lens 104 may be larger than the diagonal length of the image sensor 300, and the effective diameter of the twelfth surface S12 of the sixth lens 106 may be larger than the diagonal length of the image sensor 300.

When the sixth lens 106 is a spherical lens and the seventh lens 107 is an aspherical lens, the difference in effective diameter between the object-side eleventh surface and the sensor-side twelfth surface S12 of the sixth lens 106 may be the largest within the lens portion 100. For example, when the effective diameter of the ninth surface and the effective diameter of the sensor-side twelfth surface S12 of the sixth lens 106 are CA61 and CA62, the following condition satisfies: CA61>CA62, and the difference between CA61 and CA62 may be the largest among the effective diameter differences between the object-side surfaces and the sensor-side surfaces of each lens. Accordingly, by maximizing the difference in effective diameter between the object-side surface and the sensor-side surface of the sixth lens 106, light may be guided to the effective region of the aspherical lens having a relatively small effective diameter. Accordingly, a slimmer optical system may be provided. The effective diameter of the sixth lens 106 may satisfy the following condition: 1.10<CA61/CA62<1.50.

The cemented lens CL1 is bonded with glass lenses having different refractive indices, has a spherical refractive surface, and at least one lens positioned on the sensor side than the cemented lens CL1 is an aspherical lens, so that spherical aberration may be compensated. In addition, the lens positioned on the sensor side than the cemented lens CL1 is an aspherical lens and is positioned with a small effective diameter, so that light may be guided to the entire region of the image sensor 300 through the aspherical lens. The position of the cemented lens CL1 is positioned between the aspherical third lens 103 and the aspherical seventh lens 107, or between the spherical fourth lens 104 and the aspherical seventh lens 107, so that chromatic aberration correction may be more efficient. By arranging a bonding lens CL1 within the optical system, TTL may be reduced.

The seventh lens 107 may have positive (+) or negative (−) refractive power on the optical axis OA. The seventh lens 107 may have negative (−) refractive power. The seventh lens 107 can include a plastic or glass material. For example, the seventh lens 107 may be a glass material or a glass mold material. The thirteenth surface S13 on the object side of the seventh lens 107 in the optical axis may be convex, and the fourteenth surface S14 on the sensor side may be concave. The seventh lens 107 may have a meniscus shape that is convex toward the object side in the optical axis. In contrast, the thirteenth surface S13 on the optical axis OA may have a concave shape, and the fourteenth surface S14 may have a convex shape. In contrast, the seventh lens 107 may have concave shapes on both sides. The seventh lens 107 may be made of glass and may have aspherical surfaces on both sides. The thirteenth surface S13 and the fourteenth surface S14 have aspherical surfaces, and aspherical coefficients may be provided as in L7S1 and L7S2 of FIG. 4. The seventh lens 107 may be an aspherical lens closest to the image sensor 300. By arranging the aspherical lens closest to the image sensor 300, it is possible to prevent deterioration of optical performance, improve aberration characteristics, and control the influence on resolution. In addition, by arranging the aspherical lens as the lens closest to the image sensor 300, it may be insensitive to the assembly tolerance compared to the spherical lens. In other words, being insensitive to the assembly tolerance means that even if it is assembled with a slight difference compared to the design during assembly, it may not significantly affect the optical performance.

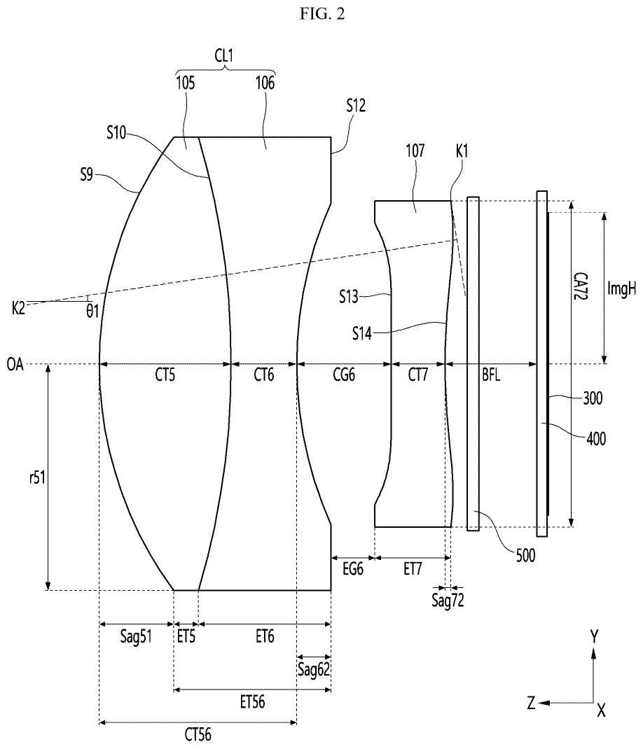

Referring to FIG. 2, at least one or both of the thirteenth surface S13 and the fourteenth surface S14 of the seventh lens 107 may have a critical point. The thirteenth surface S13 of the seventh lens 107 may have at least one critical point from the optical axis OA to the end of the effective region. The critical point of the thirteenth surface S13 may be located at 50% or less of the effective radius from the optical axis OA, or in the range of 30% to 50%, or in the range of 35% to 40%. The critical point of the thirteenth surface S13 may be located at a position less than or equal to 2.1 mm from the optical axis OA, for example, in a range of 1.4 mm to 2.1 mm or in a range of 1.6 mm to 2 mm. As another example, the thirteenth surface S13 may be provided without a critical point. The fourteenth surface S14 of the seventh lens 107 may have at least one critical point from the optical axis OA to an end of the effective region. The critical point of the fourteenth surface S14 may be located at a distance of 65% or more of the effective radius from the optical axis OA, or in a range of 65% to 85% or in a range of 70% to 80%. The critical point of the fourteenth surface S14 may be located at a position greater than or equal to 3.5 mm from the optical axis OA, for example, in a range of 3.5 mm to 4.3 mm or in a range of 3.6 mm to 4.2 mm. Since the critical point of the fourteenth surface S14 of the seventh lens 107 is positioned further outside than the critical point of the thirteenth surface S13, the incident light may be refracted to the periphery of the image sensor 300.

The BFL (Back focal length) is the optical axis distance from the image sensor 300 to the last lens. The tangent line K1 passing through any point of the fourteenth surface S14 of the seventh lens 107 and the normal line K2 perpendicular to the tangent line K1 may have a predetermined angle θ1 with the optical axis OA. The maximum tangent angle θ1 on the fourteenth surface S14 in the first direction X may be 15 degrees or less, for example, 1 to 15 degrees or 2 to 10 degrees, based on an axis parallel to the optical axis. The maximum tangent angle on the thirteenth surface S13 in the first direction X may be 5 degrees or more, for example, in the range of 5 degrees to 40 degrees or in the range of 14 degrees to 34 degrees, with respect to an axis parallel to the optical axis.

CT7 is the center thickness or optical axis thickness of the seventh lens 107, and ET7 is the edge thickness of the seventh lens 107. CT6 is the center thickness or optical axis thickness of the sixth lens 106, and ET6 is the edge thickness of the sixth lens 106. The edge thickness is the distance in the optical axis direction between the object side and the sensor side at the end of the effective region of each lens. CG6 is the optical axis distance (i.e., center distance) from the center of the sixth lens 106 to the center of the seventh lens 107. That is, CG6 is the distance from the center of the twelfth surface S12 to the center of the thirteenth surface S13. EG6 is the distance (i.e., edge distance) in the optical axis direction from the edge of the sixth lens 106 to the edge of the seventh lens 107.

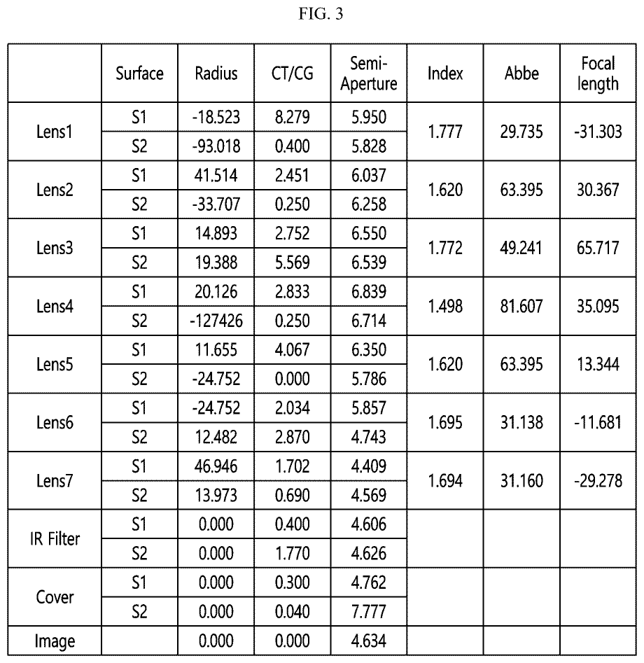

FIG. 3 is an example of lens data of the optical system of FIG. 1. As shown in FIG. 3, the radius of curvature of the first to seventh lenses 101-107 on the optical axis OA, the center thickness CT of the lenses, the center distance CG between adjacent lenses, the refractive index on the d-line, the Abbe number, and the size of the clear aperture CA may be set.

When the radius of curvature of each lens on the optical axis is expressed as an absolute value, the radius of curvature of the eighth surface S8 of the fourth lens 104 on the optical axis OA may be the largest among the lenses, and the radius of curvature of the ninth surface S9 of the fifth lens 105 or the twelfth surface S12 of the sixth lens 106 may be the smallest among the lenses. The difference between the maximum radius of curvature and the minimum radius of curvature may be 5 times or more, for example, 5 to 20 times. The radius of curvature of the third lens 103, which is an aspherical lens, may be smaller than the radii of curvature of the first, second, and fourth lenses 101, 102, and 104 made of glass. Here, the radius of curvature is an average of the absolute values of the radii of curvature of the object-side surface and the sensor-side surface of each lens.

The radius of curvature of the first lens 101 arranged on the object-side of the aperture stop ST in the optical axis may be larger than the radius of curvature of the second lens 102 arranged on the sensor-side of the aperture stop ST. The radius of curvature of the seventh lens 107 may be larger than the radius of curvature of the sixth lens 106. The radius of curvature of the seventh lens 107 may be larger than the radii of curvature of the fifth and sixth lenses 105 and 106.

If the third lens 103 is designed as an aspherical surface, it may satisfy thermal compensation and improve optical performance, but it may not be as easy to assemble as a spherical lens, and the optical characteristics of lenses arranged on the sensor side may be affected due to the aspherical third lens 103 due to the assemblability of the aspherical third lens. If the third lens is a spherical lens, even if the optical characteristics of the third lens are affected, the curvature radius of the third lens on the optical axis may not be significantly changed due to the spherical characteristics. The invention designs the curvature radius of the third lens 103 having an aspherical surface to exceed 10 mm and the effective diameter to be large, so that assembly may be facilitated, and also, when the curvature radius on the optical axis is large, the shape of the lens is formed gently, so that even if it is assembled with a slight tilt from the optical axis, the effect on the lenses on the sensor side may be minimal.

Also, the reason why the first spherical lens 101 has the largest radius of curvature after the fourth lens 104 is that the lens disposed on the object side of the aperture stop ST is the lens most sensitive to optical characteristics, so the radius of curvature is provided larger or the thickness is increased. Here, a sensitive lens means a lens that has a large impact on the optical system even if the assembly is slightly wrong. Therefore, the lens disposed on the object side of the aperture is the most sensitive to assembly, so the radius of curvature of the lenses adjacent to the aperture stop is designed to be the largest, and then the radius of curvature of the first lens that is sensitive to assembly is increased.

Since the third lens 103 is provided as an aspherical surface, the radius of curvature on the optical axis is not increased, and the difference in the radius of curvature between the object side and the sensor side is not made large, and heat compensation is possible by the glass material, and the assembly may be improved by the effective diameter, and the influence on the optical characteristics may be reduced.

The radius of curvature of the seventh lens 107 may be greater than the radius of curvature of the sixth lens 106 made of glass. Accordingly, the seventh lens 107 may guide light incident through the first to sixth lenses 101-106 to the entire region of the image sensor 300. When the radius of curvature of the seventh lens 117 is greater than the radius of curvature of the sixth lens 116, the assembly properties of the last aspherical lens may be improved and changes in optical characteristics may be minimized.

The curvature radii of the first and second surfaces S1 and S2 of the first lens 101 are defined as L1R1 and L1R2, the curvature radii of the thirteenth and fourteenth surfaces S13 and S14 of the seventh lens 107 are defined as L7R1 and L7R2, and the curvature radii of each lens surface of the second to sixth lenses 102-106 may be defined as L2R1, L2R2, L3R1, L3R2, L4R1, L4R2 (L5R1), L5R2, L6R1, and L6R2. The curvature radii of each lens surface may satisfy the following conditions.

$$Condition 1 : 0 < \vert L 1 R 1 / L 1 R 2 \vert < 1 ,$$

$$Condition 2 : 0.5 < \vert L 2 R 1 / L 2 R 2 \vert < 2$$

$$Condition 3 : 0.2 < L 3 R 1 / L 3 R 2 < 1.2 ,$$

$$Condition 4 : 0 < \vert L 4 R 1 / L 4 R 2 \vert < 0.5$$

$$Condition 5 : 0 < \vert L 5 R 1 / L 5 R 2 \vert < 0.7 ,$$

$$Condition 6 : 1 < \vert L 6 R 1 / L 6 R 2 \vert < 2.5$$

$$Condition 7 : 1.5 < L 7 R 1 / L 7 R 2 < 4.5 ,$$

$$Condition 8 : 1 mm \leq \vert L 3 R 2 - L 3 R 1 \vert \leq 10 mm$$

$$Condition 9 : 10 mm < L 7 R 1 - L 7 R 2 < 50 mm$$

When the difference between the object-side curvature radius and the sensor-side curvature radius of the third lens 103 is provided within the above range, the assembling performance of the third lens 103 having an aspherical surface may be improved and the optical influence caused by the third lens 103 may be reduced.

When the center thicknesses of the first to seventh lenses 101-107 are defined as CT1-CT7 and the edge thicknesses of the first to seventh lenses 101-107 are defined as ET1-ET7, the sum of the center thicknesses of the first to seventh lenses 101-107 may be defined as ΣCT and the sum of the edge thicknesses of the first to seventh lenses 101-107 may be defined as ΣET. Regarding the thicknesses of the lenses, the center thickness CT1 of the first lens 101 may be greater than the center thicknesses CT2-CT7 of the second to seventh lenses 102-107 and may have the maximum thickness within the lens portion 100. The center thickness CT7 of the seventh lens 107 may be smaller than the center thicknesses CT1-CT6 of the first to sixth lenses 101-106, and may have a minimum thickness within the lens portion 100. The aspherical lens may include the third lens 103 and the seventh lens 107. The center thickness CT1 of the first lens 101 may be greater than 100% of the center thickness CT56 of the cemented lens CL1, for example, in a range of 101% to 150%. The thickness of each lens may satisfy at least one of the following conditions.

$$Condition 1 : 0.6 < CT 1 / ET 1 < 1.3 ,$$

$$Condition 2 : 1 < CT 2 / ET 2 < 2.5$$

$$Condition 3 : 1 < CT 3 / ET 3 < 2 ,$$

$$Condition 4 : 1.2 < CT 4 / ET 4 < 2.5$$

$$Condition 5 : 1.5 < CT 5 / ET 5 < 3.5 ,$$

$$Condition 6 : 0 < CT 6 / ET 6 < 1$$

$$Condition 7 : 0.5 < CT 7 / ET 7 < 1.2 ,$$

$$Condition 8 : 0.8 < \sum CT / \sum ΕΤ < 1.2$$

$$Condition 9 : 0.24 < CT 1 / \sum CT < 0.44$$

In this way, the difference between the center thickness and the edge thickness of each lens may be set to be more than 0.6 mm and less than 4 mm. This can effectively guide light without increasing the difference between the center thickness and the edge thickness of each lens by arranging the aspherical lens in the third and seventh lenses 103 and 107. In addition, by setting the difference between the center thickness and the edge thickness of the third lens 103 to the range of condition 3, the difference in the radius of curvature between the object side and the sensor side may be designed without being large, and the assembling of the aspherical third lens 103 may be improved and the influence on the optical characteristics may be reduced.

In addition, the difference between the maximum center thickness and the minimum center thickness of the lenses may be 3 mm or more, for example, in the range of 3 mm to 8 mm or 3 mm to 7 mm. That is, even if the center thickness of the last aspherical lens is provided thinly, the optical performance may not be degraded, and the thickness of the camera module may be provided slimly. In addition, since the difference between the center thickness and the edge thickness of each lens is not made large, even if at least one lens is tilted, the influence on the optical characteristics may be reduced. It can also reduce the influence on the thermal characteristics between the center portion and edge portion of the lenses. The maximum center thickness may be greater than the sum of the center thicknesses of the adjacent two lenses. For example, the conditions may satisfy: (CT2+CT3)<CT1, (CT3+CT4)<CT1, (CT4+CT5)<CT1, (CT5+CT6)<CT1, and (CT6+CT7)<CT1.

The center distance between the first to seventh lenses 101-107 may be defined as CG1-CG6, and the sum of the center distances between the first to seventh lenses 101-107 may be defined as ΣCG.

The center distance CG3 between the third lens 103 and the fourth lens 104 is the center distance between the aspherical lens and the spherical lens, is the maximum within the lens portion 100, and is greater than the center distance between the spherical lenses. That is, the distance CG3 between the adjacent object-side aspherical lens and the sensor-side spherical lens may be the maximum within the lens portion 100, and may be equal to or less than the center thickness of the cemented lens CL1, for example, 84% or more, for example, in the range of 84% to 95% of the center thickness of the cemented lens CL1. The center distance CG6 between the sixth lens 106 and the seventh lens 107 may be smaller than the center distance CG3 and the second largest within the lens portion 100. That is, the distance CG6 between the adjacent object-side spherical lens and the sensor-side aspherical lens may satisfy the following condition: CT7<CG6<CG3<CT1. The distance between the center thickness of each lens and the center distance between the adjacent lenses may satisfy the following conditions (Here, the gap within the cemented lens is excluded).

$$Condition 1 : 10 < CT 1 / CG 1 < 30 ,$$

$$Condition 2 : 1 < CG 6 / CT 7 < 3$$

$$Condition 3 : 1 < CG 3 / CT 3 < 3 ,$$

$$Condition 4 : ( CG 6 / CT 7 ) < ( CG 3 / CT 3 )$$

$$Condition 5 : 0.2 < CG 3 / \sum CG < 0.7 ,$$

$$Condition 6 : 1 < CT 1 / CG 3 < 2$$

By providing the maximum center thickness between the lenses to be 1.1 times or more of the maximum center distance, for example, in the range of 1.1 to 2 times, a camera module applying an aspherical lens within the optical system may be provided without increasing the center distance compared to the center thickness of each lens. In Condition 3, since the aspherical third lens 103 is provided in a meniscus shape convex toward the object side, the distance between the third and fourth lenses 104 and 105 may be provided greatly. Here, if the i-th center distance between the adjacent two lenses is defined as CGi, and the center thickness of the i-th lens positioned closer to the object side than CGi is defined as CTi, the following condition may be satisfied (here, the distance between the cemented lens and the cemented lens is excluded). The ratio of CTi/CGi is maximum when i is 1, and minimum when i is 3. The reason why the value of CTi/CGi is minimum when i is 3 may be implemented by the third lens 103 made of aspherical glass material.

If the optical axis distance from the center of the object-side surface of the first lens 101 to the surface of the image sensor 300 is TTL, the following condition may be satisfied.

$$Condition 2 : 0.1 < CT 2 / TTL < 0.5 ,$$

$$Condition 3 : 0 < CT 3 / TTL < 0.1$$

$$Condition 4 : 0 < CT 4 / TTL < 0.1 ,$$

$$Condition 5 : 0 < CT 5 / TTL < 0.15$$

$$Condition 6 : 0 < CT 6 / TTL < 0.1 ,$$

$$Condition 7 : 0 < CT 7 / TTL < 0.1$$

Preferably, Condition 1 may satisfy 0.18≤CT1/TTL≤0.3. Since the first lens 101 is made of a glass material of a spherical lens, an optical system may be designed that may satisfy thermal compensation according to temperature change by the thickness of the first lens 101 satisfying condition 1. That is, condition 1 may be a feature that appears when the first lens 101 is designed as a spherical glass. The value of CT1/TTL of condition 1 may be greater than the values of conditions 2 to 7 below.

$$Condition 1 : 0 < CT 1 / TTL < 0.5$$

As for the effective diameter, the lens having the maximum effective diameter may be the fourth lens 104 closest to the object. The fourth lens 104 having the maximum effective diameter may be a spherical lens. The lens having the minimum effective diameter may be the lens closest to the image sensor 300, for example, the seventh lens 107. The fourth lens 104 having the maximum effective diameter may be placed between the third lens 103 which is an aspherical surface and the cemented lens CL1.

The effective diameters of the first lens 101 to the seventh lens 107 may be defined as CA1, CA2, CA3, CA4, CA5, CA6, and CA7, the effective diameters of the first and second surfaces S1 and S2 of the first lens 101 may be defined as CA11 and CA12, the effective diameters of the thirteenth and fourteenth surfaces S13 and S14 of the seventh lens 107 may be defined as CA71 and CA72, and the effective diameters of the object-side surface and the sensor-side surface of the second to sixth lenses may be defined as CA21, CA22, CA31, CA32, CA41, CA42, CA51, CA52, CA61, and CA62. The effective diameters may satisfy the following conditions.

$$Condition 1 : CA 11 < CA 21 < CA 22$$

$$Condition 2 : CA 71 < CA 72$$

$$Condition 3 : CA 22 < CA 31 < CA 41$$

$$Condition 4 : ( CA 11 - CA 12 ) < ( CA 61 - CA 62 )$$

$$Condition 5 : CA 71 < CA 61 < CA 51 < CA 41$$

$$Condition 5 : CA 1 < CA 2 < CA 3 < CA 4$$

$$Condition 6 : CA 4 > CA 5 > CA 6 > ( 2 * ImgH ) > CA 7$$

As in Condition 1, even if the effective diameter of the first lens 101 is provided to be smaller than that of the second lens 102, the heat compensation may be more effective and the assembling property may be improved due to the spherical glass material and thick thickness.

In terms of the refractive index, at least one of the first and third lenses 101 and 103 has the largest refractive index among the lenses, and preferably, the refractive index of the first lens 101 may be the largest and may be 1.72 or more. The difference in the refractive indices of the first and third lenses 101 and 103 is 0.10 or less. The refractive index of the fourth lens 104 is the smallest among the lenses. The difference between the maximum refractive index and the minimum refractive index may be 0.20 or more. By adjusting the refractive indices of the spherical lens and the aspherical lens, the incident efficiency may be increased, and the incident light may be guided to the image sensor 300. In terms of the Abbe number, the Abbe number of the fourth lens 104 is the largest among the lenses, and may be 65 or more. The Abbe number of the first lens 101 is the smallest among the lenses. The difference between the maximum refractive index and the minimum Abbe number may be 30 or more. By making the Abbe number of the object-side lens based on the aperture stop ST small, the Abbe number of the sensor-side lens based on the aperture stop ST large, and providing the Abbe number of the aspherical seventh lens 107 closest to the image sensor 300 small, the color dispersion of light traveling between the lenses made of glass may be controlled, and the color dispersion between the spherical lens and the aspherical lens may be increased and guided to the image sensor 300.

If the average effective diameter of the spherical lens is GL_CA_Aver and the average effective diameter of the aspherical lens is GM_CA_Aver, the following condition may satisfy: GM_CA_Aver<GL_CA_Aver. If the average of the center thickness of the spherical lens is GL_CT_Aver and the average of the center thickness of the aspherical lens is GM_CT_Aver, the following condition may satisfy: GM_CT_Aver<GL_CT_Aver. If the average refractive index of the spherical lens is GL_nd_Aver and the average refractive index of the aspherical lens is GM_nd_Aver, the following condition may satisfy: GL_nd_Aver<GM_nd_Aver. If the average Abbe number of the spherical lens is GL_Ad_Aver and the average Abbe number of the aspherical lens is GM_Ad_Aver, the following condition may satisfy: GM_Ad_Aver<GL_Ad_Aver.

The focal lengths F1, F6, and F7 of the first, sixth, and seventh lenses 101, 106, and 107 have negative refractive power, and the focal lengths F2, F3, F4, and F5 of the second, third, fourth, and fifth lenses 102, 103, 104, and 105 may have positive refractive power. In addition, the fifth and sixth lenses 105 and 106, which are adjacently arranged lenses, may satisfy the following condition.
Condition 1: Refractive index of lens with positive refractive power<Refractive index of lens with negative refractive power
Condition 2: Dispersion of lens with positive refractive power>Dispersion of lens with negative refractive power

Here, the fifth lens 105 has positive refractive power and the sixth lens 106 has negative refractive power, and as in the conditions 1 and 2, the refractive index of the fifth lens 105 is smaller than the refractive index of the sixth lens 106, and the dispersion value of the fifth lens 105 is larger than the dispersion value of the sixth lens 106. Accordingly, the chromatic aberration occurring in the spherical lens may be corrected with an aspherical lens. In addition, by satisfying the refractive index difference between the fifth and sixth lenses 105 and 106 arranged sequentially being 0.01 or more and 0.15 or less and the Abbe number difference being 20 or more and 60 or less, the chromatic aberration occurring in the spherical lens may be compensated for with a cemented lens. Here, the refractive index difference is rounded off to the third decimal place, and the Abbe number difference is rounded off to the first decimal place to compare the values.

The optical system 1000 generates chromatic aberration, and the chromatic aberration is corrected by using a cemented lens CL1 or two lenses arranged in series. The lens repeatedly contracts and expands as the temperature changes from low to high. Since the lens characteristics of lenses of the same material change the same amount according to the temperature change, it is effective to correct the chromatic aberration between lenses of the same material even when the temperature changes. In addition, the chromatic aberration occurring in the spherical lens may be corrected by using the third lens 103 and the seventh lens 107, and the chromatic aberration between the spherical lens and the aspherical lens may be mutually corrected by using the sixth lens 106 and the seventh lens 107. In addition, by arranging glass lenses having relatively high Abbe numbers of the fifth lens 105 of the cemented lens CL1 arranged on the object side of the aspherical seventh lens 107, color dispersion may be reduced by the glass lenses and color dispersion may be increased by the aspherical lenses.

When the focal length is expressed as an absolute value, the focal length of the third lens 103 is the largest among the lenses and may be 45 or more. The focal length of the sixth lens 106 is the smallest among the lenses. The difference between the maximum focal length and the minimum focal length may be 35 mm or more. By making the focal length of the aspherical third lens 103 on the object side the largest and providing the focal length of the sixth lens 106 adjacent to the last aspherical lens the smallest, the optical system may have improved MTF characteristics, aberration control characteristics, resolution characteristics, etc. in the set field of view range, and may have good optical performance in the periphery portion of the field of view.

The sensor-side surface of the seventh lens 107 has a critical point. The critical point is a point where the trend of the Sag value changes. That is, the point where the Sag value increases and then decreases, or the point where the Sag value decreases and then increases. It may be seen that the sensor-side surface of the seventh lens 107 has a critical point between a point of 3.5 mm and a point of 4.4 mm in a direction perpendicular to the optical axis based on the optical axis. For example, the sensor-side surface of the seventh lens 107 increases the Sag value in a direction perpendicular to the optical axis up to the critical point, and then decreases toward the edge after the critical point. If the critical point exists on the sensor-side surface of the seventh lens 107, that is, the sensor side of the last lens, that is, the lens surface closest to the sensor, TTL may be reduced, making it easy to miniaturize and lighten the optical system.

In FIG. 2, Sag51 represents the Sag value of the object-side surface of the fifth lens 105, Sag62 represents the Sag value of the sensor-side surface of the sixth lens 106, Sag72 represents the Sag value of the sensor-side surface of the seventh lens, and the Sag value of the object-side surface of the seventh lens may be represented as Sag71. The Sag value has a positive value when the lens surface is located closer to the sensor than the center of each lens surface, and has a negative value when it is located closer to the object than the center of each lens surface.

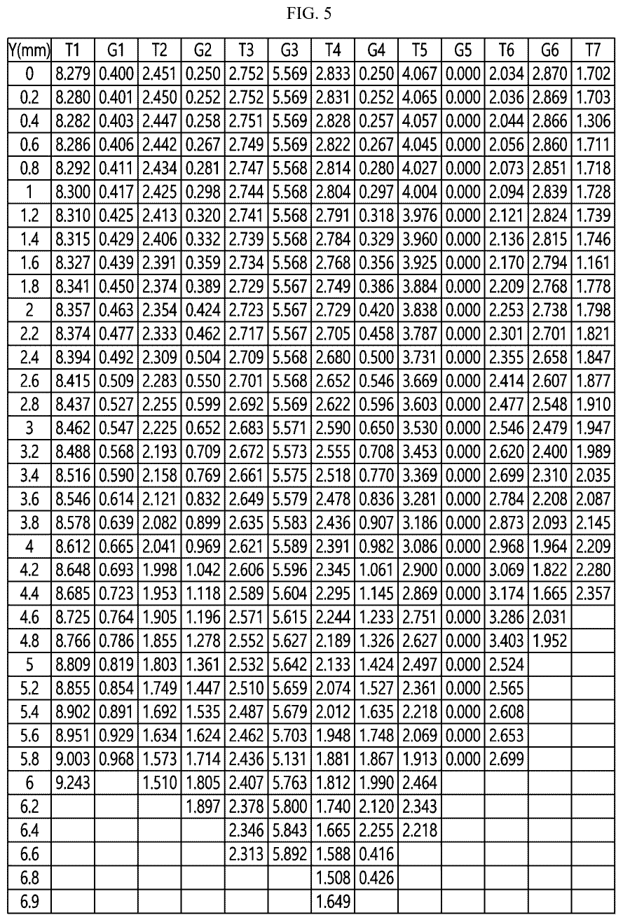

As shown in FIG. 4, the lens surfaces of the third and seventh lenses 103 and 107 among the lenses of the lens portion 100 may include an aspherical surface having a 30th aspherical coefficient. For example, the third and seventh lenses 103 and 107 may include a lens surface having a 30th aspherical coefficient. As described above, since an aspherical surface having a 30th aspherical coefficient (a non-zero value) can significantly change an aspherical shape of a peripheral portion, the optical performance of a peripheral portion of a field of view (FOV) may be well compensated. As shown in FIG. 5, the thickness T1-T7 of the first to seventh lenses 101-107 and the distances G1-G6 between adjacent two lenses may be set. The thickness T1-T7 of each lens in the Y-axis direction may be expressed at intervals of 0.1 mm or 0.2 mm or more, and the distance G1-G6 between lenses may be expressed at intervals of 0.1 mm or 0.2 mm or more. The center thickness CT56 of the cemented lens CL1 may be greater than the edge thickness ET56. The center thickness CT56 of the cemented lens CL1 is a distance from the center of the object-side ninth surface S9 of the fifth lens 105 to the center of the twelfth surface S12 of the sixth lens 106, and the edge thickness ET56 is a distance from the end of the effective region of the ninth surface S9 to the twelfth surface S12 in the optical axis direction. The maximum thickness of the cemented lens CL1 is the center, the minimum thickness is the edge, and the maximum thickness may be at least 1 time the minimum thickness, for example, in the range of 1 to 1.5 times. The cemented lens CL1 may satisfy the following condition: 0 mm<CT56−ET56<2 mm.

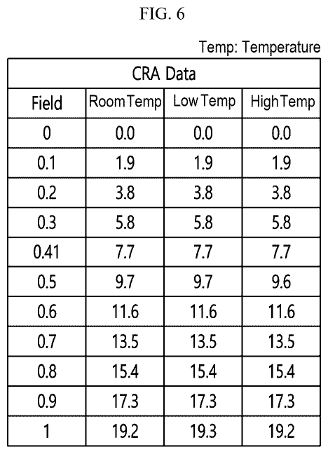

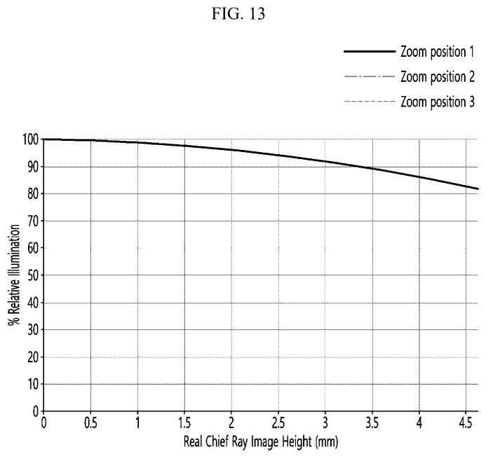

As shown in FIG. 6, the chief ray angle (CRA) of the optical system and camera module of FIG. 1 may be at least 10 degrees, for example, in the range of 10 to 35 degrees or in the range of 10 to 25 degrees. As shown in FIG. 13, a graph showing the relative illumination according to the image height in an optical system according to an embodiment shows that the relative illumination is 70% or more, for example, 75% or more from the center of the image sensor to the diagonal end. That is, it may be seen that the difference in the relative illumination (Zoom position 1, 2, 3) according to the temperature is almost the same up to 4.4 mm from the optical axis.

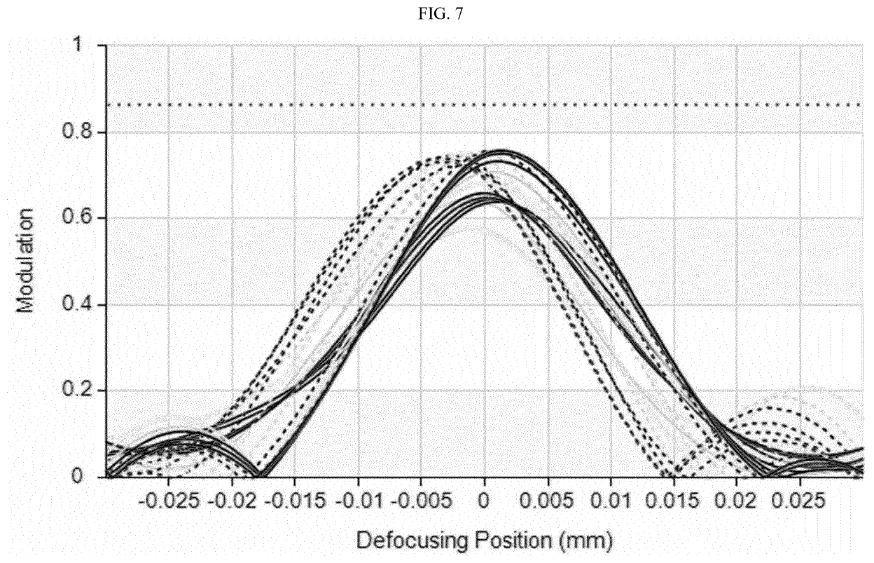

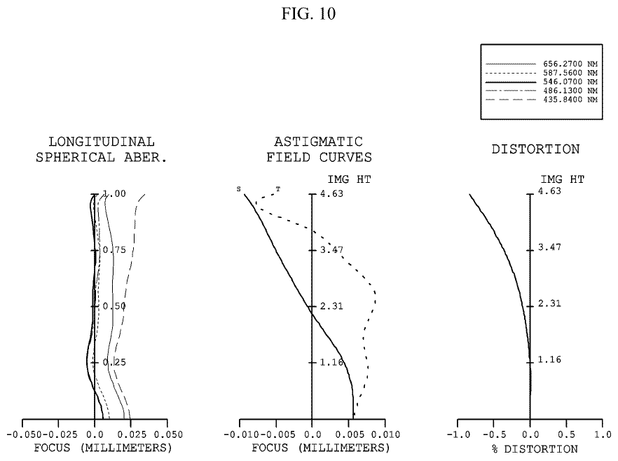

FIGS. 7 to 9 are graphs showing diffraction MTF at room temperature, low temperature, and high temperature in the optical system of FIG. 1, and are graphs showing modulation according to spatial frequency. As shown in FIGS. 7 to 9, in an embodiment of the invention, the deviation of MTF with respect to room temperature and low temperature or high temperature may be less than 10%, that is, 7% or less. FIGS. 10 to 12 are graphs showing aberration characteristics at room temperature, low temperature, and high temperature in the optical system of FIG. 1. In the aberration graphs of FIGS. 10 to 12, spherical aberration (Longitudinal spherical aberration), astigmatic field curves, and distortion are graphs measured from left to right. In FIGS. 10 to 12, the X-axis may represent a focal length (mm) and a degree of distortion (%), and the Y-axis may represent the height of the image. In addition, the graph for spherical aberration is a graph for light in wavelength bands of about 435 nm, about 486 nm, about 546 nm, about 587 nm, and about 656 nm, and the graph for astigmatism and distortion is a graph for light in wavelength bands of about 546 nm. In the aberration diagram of FIGS. 10 to 12, it may be interpreted that the aberration correction function is better as each curve at room temperature, low temperature, and high temperature approaches the Y-axis, and the optical system 1000 according to the embodiment may see that the measured values are adjacent to the Y-axis in almost all regions. That is, the optical system 1000 according to the embodiment has improved resolution and may have good optical performance not only in the center portion of the FOV but also in the periphery portion. Here, the low temperature is −20 degrees or less, for example, −20 to −40 degrees, the room temperature is 22 degrees±5 degrees or 18 to 27 degrees, and the high temperature may be 85 degrees or more, for example, 85 to 105 degrees. Accordingly, it may be seen that the reduction in the luminance ratio (modulation) from the low temperature to the high temperature in FIGS. 10 to 12 is less than 10%, for example, 5% or less, or is almost unchanged.

Table 1 compares the changes in optical characteristics such as EFL, BFL, F number, TTL, and FOV at room temperature, low temperature, and high temperature in the optical system according to the embodiment, and it may be seen that the change rate of the optical characteristics at low temperature is 5% or less, for example, 3% or less, based on room temperature, and it may be seen that the change rate of the optical characteristics at low temperature is 5% or less, for example, 3% or less, based on room temperature.

TABLE 1

| | | | | Low | High |
|---|---|---|---|---|---|
| | Room | Low | High | temperature/Room | temperature/Room |
| | temperature | temperature | temperature | temperature | temperature |
| EFL(F) | 15.1 | 15.1 | 15.2 | 99.89% | 100.14% |
| BFL | 3.2 | 3.2 | 3.2 | 99.88% | 100.14% |
| F# | 1.6 | 1.59 | 1.6 | 99.89% | 100.15% |
| TTL | 36.7 | 36.6 | 36.7 | 99.92% | 100.10% |
| FOV | 34.3 | 34.3 | 34.2 | 100.11% | 99.86% |

As shown in Table 1, the change in optical characteristics according to temperature change from low temperature to high temperature, for example, the change rate of EFL, TTL, BFL, F number, and diagonal FOV is 10% or less, that is, 5% or less, for example, 0 to 5%. This means that even if at least one or two or more aspherical lenses are used, temperature compensation for the aspherical lenses may be designed to prevent a decrease in reliability of optical characteristics. In this way, since the third lens 103 and the seventh lens 107 are provided with aspherical glass materials, it may be seen that thermal compensation is possible according to temperature change from low temperature to high temperature in the entire optical system, and it may be seen that the optical characteristics are not affected due to the assembly by these lenses. The optical system of the first embodiment disclosed above can effectively control aberration characteristics such as chromatic aberration and distortion aberration, and may have good optical performance not only in the center portion of the FOV but also in the periphery portion.

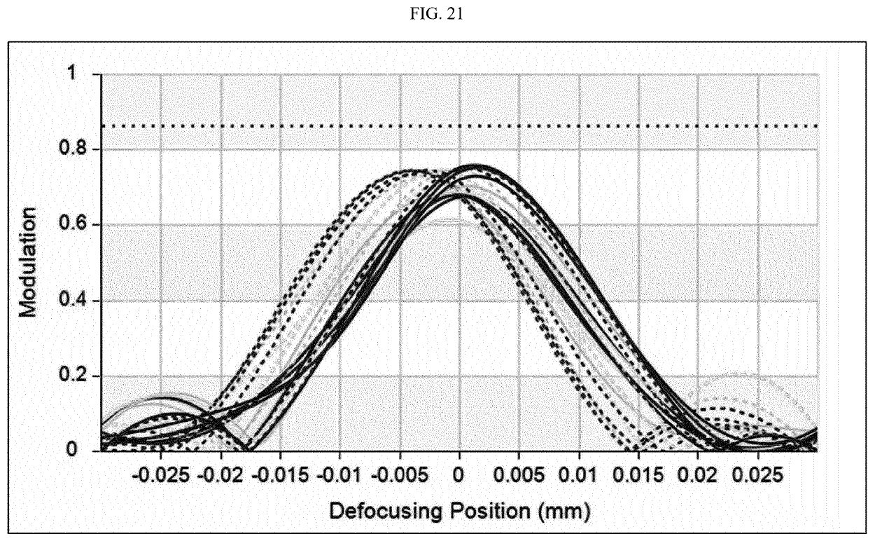

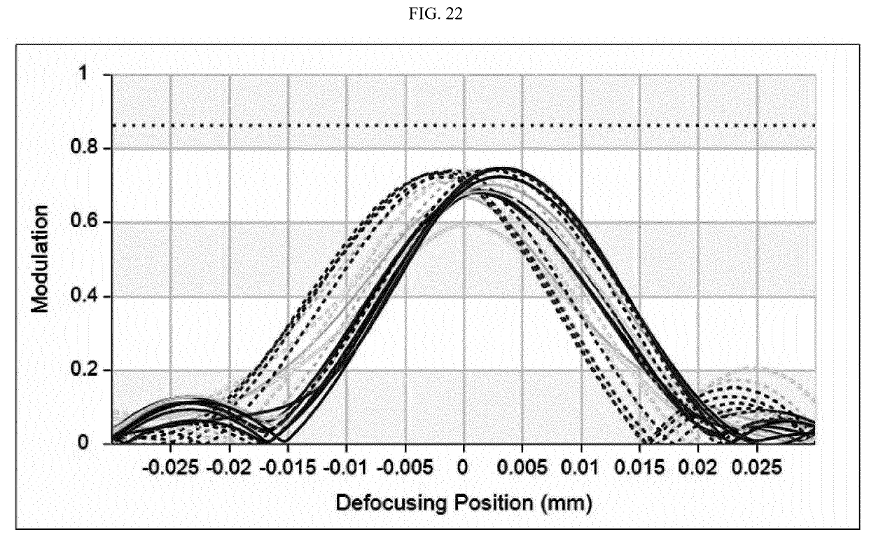

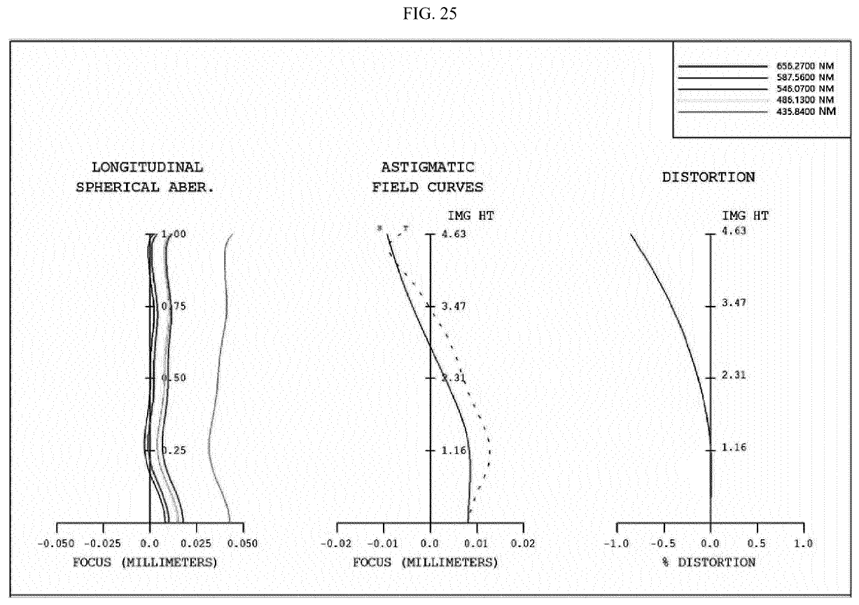

The optical system 1000 according to the second embodiment will be described with reference to FIGS. 14 to 25. In describing the second embodiment, the same or overlapping contents as those of the first embodiment will refer to the description of the first embodiment, and may be included, substituted, or applied to the second embodiment. Referring to FIGS. 14 to 16, the lens portion 100A of the optical system 1000 according to the second embodiment may include a first lens 111 to a seventh lens 117. The first lens 111 is the lens closest to the object side in the first lens group LG1. The seventh lens 117 is the lens closest to the image sensor 117 in the second lens group LG2 or the lens portion 100A. The first lens 111 may be a first lens group LG1, and the second to seventh lenses 112, 113, 114, 115, 116, and 117 may be a second lens group LG2.

The first lens 111 may have negative (−) refractive power. The first lens 111 may be made of glass or a glass non-mold material. The object-side first surface S1 of the first lens 111 with respect to the optical axis may be concave, and the sensor-side second surface S2 may be convex. The thickness of the first lens 111 may be the thickest within the lens portion 100A. The thickness of the first lens 111 may be thicker than the thickness of the cemented lens CL2. The thickness of the first lens 111 may be a center thickness or an average of the center thickness and the edge thickness. The center thickness of the first lens 111 may be thicker than the center thickness of the cemented lens CL2. The edge thickness of the first lens 111 may be thicker than the edge thickness of the cemented lens CL2. The first surface S1 of the first lens 111 may be provided without a critical point from the optical axis OA to the end of the effective region, i.e., the edge. The second surface S2 of the first lens 111 may be provided without a critical point.

The aperture stop ST may be arranged around the sensor-side surface of the first lens 111. Alternatively, the aperture stop ST may be arranged around the object-side or sensor-side surface of the second lens 112, or around the object-side surface of the third lens 113.

The second lens 112 may have positive (+) refractive power on the optical axis OA. The second lens 112 may be provided with a glass material. The object-side third surface S3 of the second lens 112 with respect to the optical axis OA may be convex, and the sensor-side fourth surface S4 may be convex. At least one or both of the third surface S3 and the fourth surface S4 may be provided without a critical point from the optical axis OA to the end of the effective region.

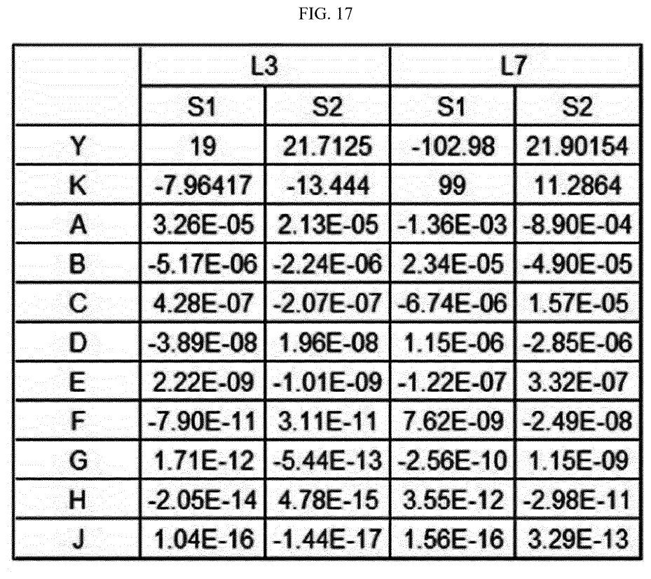

The third lens 113 may have positive (+) refractive power. The third lens 113 may be provided with a glass material or a glass mold material. The object-side fifth surface S5 of the third lens 113 with respect to the optical axis may be convex, and the sensor-side sixth surface S6 may be concave. The third lens 113 may be provided as an aspherical lens made of glass. The fifth surface S5 and the sixth surface S6 may be aspherical, and the aspherical coefficients may be provided as L3S1 and L3S2 of FIG. 17. At least one or both of the fifth surface S5 and the sixth surface S6 may be provided without a critical point from the optical axis OA to the end of the effective region.

In the optical system 1000, there may be at least one, for example, 1 to 3, aspherical glass lenses. The effective radius of the fifth surface S5 or the sixth surface S6 of the third lens 113 may be larger than the effective radii of the object-side surface or the sensor-side surface of the first lens 111 or the seventh lens 117. The effective diameter of the third lens 113 may have the largest effective diameter within the lens portion 100A. The effective diameter of the third lens 113 may have the largest effective diameter among the spherical lens and the aspherical lens.

Since the second lens 112 has positive refractive power (F2>0), the second lens 112 may refract incident light in the direction of the optical axis, and may suppress the effective diameters of the sensor-side or rear-side lenses of the second lens 112 from increasing. The distance between the second lens 112 and the third lens 113 may gradually increase from the center to the edge. This distance may gradually increase from the optical axis to the edge due to the convex shape of the sensor-side surface of the second lens 112 and the convex shape of the object-side surface of the third lens 113.

The fourth lens 114 may have positive (+) refractive power on the optical axis OA. The fourth lens 114 may be provided with a glass material. The object-side seventh surface S7 of the fourth lens 114 with respect to the optical axis may be concave, and the sensor-side eighth surface S8 may be convex. The fourth lens 114 may be provided with a spherical lens made of glass. The seventh surface S7 and the eighth surface S8 may be spherical. The seventh surface S7 and the eighth surface S8 may be provided without a critical point from the optical axis OA to the end of the effective region.

The fifth lens 115 may have positive (+) refractive power on the optical axis OA. The fifth lens 115 may be provided with a glass material. Based on the optical axis OA, the ninth surface S9 of the fifth lens 115 on the object side may be convex, and the sensor-side tenth surface S10 may be convex. The fifth lens 115 may be a spherical lens. The ninth surface S9 and the tenth surface S10 of the fifth lens 115 may be spherical. At least one or both of the ninth surface S9 and the tenth surface S10 may be provided without a critical point from the optical axis OA to the end of the effective region.

The sixth lens 116 may have negative (−) refractive power on the optical axis OA. The sixth lens 116 may be provided with a glass material. Based on the optical axis OA, the object-side eleventh surface of the sixth lens 116 may be concave, and the sensor-side twelfth surface S12 may be concave. The sixth lens 116 may be spherical. For example, the eleventh surface and the twelfth surface S12 may be spherical. The eleventh surface of the sixth lens 116 may be provided without a critical point from the optical axis OA to the end of the effective region. The twelfth surface S12 may be provided without a critical point from the optical axis OA to the end of the effective region.

The fifth lens 115 and the sixth lens 116 may be bonded or joined, and may be defined as a cemented lens CL2. The bonded surface between the fifth lens 115 and the sixth lens 116 may be defined as the tenth surface S10. The tenth surface S10 may be the same surface as the eleventh surface of the sixth lens 116. When the distance between the fifth and sixth lenses 115 and 116 is G5, G5 may be less than 0.01 mm. The distance G5 between the fifth and sixth lenses 115 and 116 may be less than 0.01 mm from the optical axis OA to the end of the effective region. The fifth and sixth lenses 115 and 116 may have opposite refractive powers. The composite refractive power of the fifth and sixth lenses 115 and 116 may have positive (+) refractive power.

The product of the refractive power of the object-side fifth lens 115 of the cemented lens CL2 and the refractive power or focal length of the sensor-side sixth lens 116 may be less than 0. Accordingly, the aberration characteristics of the optical system may be improved. If the signs of the refractive powers of the two lenses of the cemented lens CL2 are the same, there is a limit to the improvement of aberration. The composite refractive power of the cemented lens CL2 may have a positive refractive power, and the fourth lens 114 arranged on the object side with respect to the cemented lens CL2 may have a positive refractive power, and the seventh lens 117 arranged on the sensor side may have a negative refractive power. Accordingly, the fourth lens 114, the cemented lens CL2, and the seventh lens 117 may refract some of the incident light in the direction of the optical axis. The effective diameter of the cemented lens CL2 may be larger than the diagonal length of the image sensor 300. The effective diameter of the fifth lens 115 is an average of the effective diameters of the ninth surface S9 and the tenth surface S10, and the effective diameters of each of the ninth surface S9 and the tenth surface S10 may be larger than the diagonal length of the image sensor 300. The effective diameter of the sixth lens 116 may be smaller than the effective diameter of the fifth lens 115 and larger than the diagonal length of the image sensor 300.

The effective diameter of the seventh surface S7 of the fourth lens 114 may be larger than the diagonal length of the image sensor 300, and the effective diameter of the twelfth surface S12 of the sixth lens 116 may be smaller than the diagonal length of the image sensor 300. The difference in the effective diameter between the object-side eleventh surface and the sensor-side twelfth surface S12 of the sixth lens 116 may be the largest among the lenses. For example, if the effective diameter of the ninth surface of the sixth lens 116 and the effective diameter of the twelfth surface S12 on the sensor side are CA61 and CA62, the following condition satisfies: CA61>CA62, and the difference between CA61 and CA62 may be the maximum among the effective diameter differences between the object-side surface and the sensor-side surface of each lens. Accordingly, by maximizing the effective diameter difference between the object-side surface and the sensor-side surface of the sixth lens 116, light may be guided to the effective region of the aspherical lens having a relatively small effective diameter. Accordingly, a slimmer optical system may be provided. The effective diameter of the sixth lens 116 may satisfy the following condition: 1.10<CA61/CA62<1.50.

The cemented lens CL2 is made of glass lenses having different refractive indices, has a spherical refractive surface, and at least one lens positioned closer to the sensor than the cemented lens CL2 is an aspherical lens, so that spherical aberration may be compensated for. In addition, the lens positioned closer to the sensor than the cemented lens CL2 is an aspherical lens and has a small effective diameter, so that light may be guided to the entire region of the image sensor 300 through the aspherical lens. The position of the cemented lens CL2 is between the aspherical third lens 113 and the aspherical seventh lens 117, or between the spherical fourth lens 114 and the aspherical seventh lens 117, so that chromatic aberration correction may be more efficient. By positioning the cemented lens CL2 within the optical system, TTL may be reduced.

The seventh lens 117 may have a negative (−) refractive power on the optical axis OA. The seventh lens 117 may be made of a glass material or a glass mold material. The object-side thirteenth surface S13 of the seventh lens 117 on the optical axis may be concave, and the sensor-side fourteenth surface S14 may be concave. The thirteenth surface S13 and the fourteenth surface S14 may have aspherical surfaces, and aspherical coefficients may be provided as in L7S1 and L7S2 of FIG. 17. At least one or both of the thirteenth surface S13 and the fourteenth surface S14 of the seventh lens 117 may be provided without a critical point. The seventh lens 117 may be an aspherical lens closest to the image sensor 300. Since the aspherical lens is arranged closest to the image sensor 300, the deterioration of optical performance may be prevented, and the influence on the improvement of aberration characteristics and resolution may be controlled.

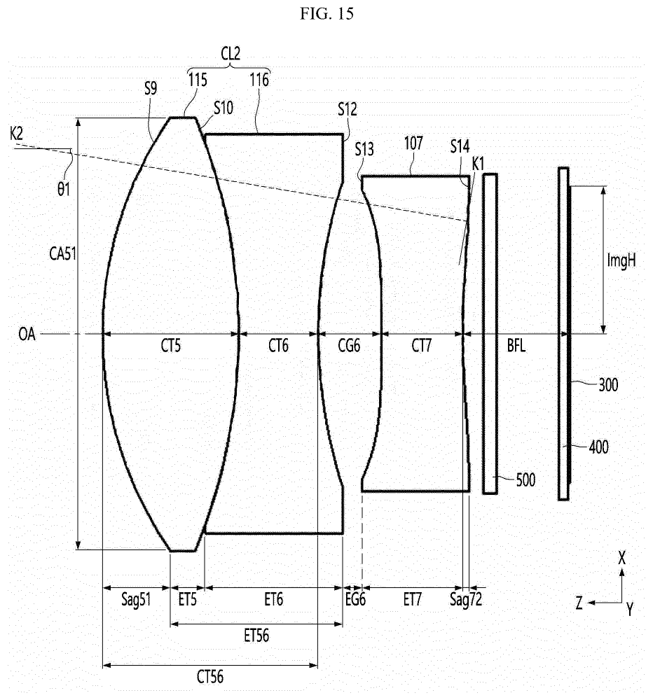

Referring to FIG. 15, the distance from the center of the sensor-side fourteenth surface S14 of the seventh lens 117 to the edge of the fourteenth surface S14 and the straight line perpendicular to the center of the sensor-side surface of the seventh lens 117 can gradually increase. Differently, the thirteenth surface S13 of the seventh lens 117 may have at least one critical point from the optical axis OA to the end of the effective region. Differently, the fourteenth surface S14 of the seventh lens 117 may have at least one critical point from the optical axis OA to the end of the effective region. The maximum tangent angle θ1 on the fourteenth surface S14 in the first direction X may be 15 degrees or less, for example, in the range of 1 to 15 degrees or in the range of 2 to 10 degrees, based on an axis parallel to the optical axis. The maximum tangent angle on the thirteenth surface S13 in the first direction X may be 5 degrees or more, for example, in the range of 5 to 40 degrees or in the range of 10 to 30 degrees, based on an axis parallel to the optical axis. The seventh lens 117 may have a small inclination angle between the thirteenth surface S13 and the fourteenth surface S14 and an effective diameter of 90% or more, for example, in the range of 90% to 99% of the diagonal length of the image sensor 300. Therefore, light refracted from the seventh lens 117 may be refracted to the entire region of the image sensor 300.

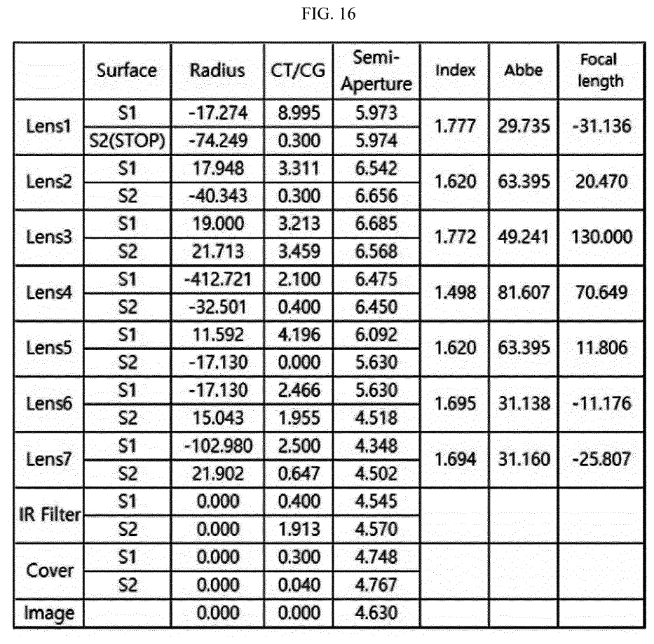

FIG. 16 is an example of lens data of the optical system of FIG. 14. Referring to FIG. 16, when the radius of curvature of each lens is expressed as an absolute value on the optical axis, the radius of curvature of the seventh surface S7 of the fourth lens 114 on the optical axis OA may be the largest among the lenses, and the radius of curvature of the ninth surface S9 of the fifth lens 115 or the twelfth surface S12 of the sixth lens 116 may be the smallest among the lenses. Preferably, the radius of curvature of the ninth surface S9 of the fifth lens 115 may be the smallest. The difference between the maximum radius of curvature and the minimum radius of curvature may be 10 times or more, for example, 10 to 40 times. The radius of curvature of the third lens 113, which is an aspherical lens, may be smaller than the radii of curvature of the first, second, and fourth lenses 111, 112, and 114 made of glass. Here, the radius of curvature is the average of the absolute values of the radius of curvature of the object-side surface and the sensor-side surface of each lens. When expressed as an absolute value, the radius of curvature of the first lens 111 arranged on the object-side of the aperture stop ST in the optical axis may be larger than the radius of curvature of the second lens 112 arranged on the sensor-side of the aperture stop ST.

When expressed as an absolute value, the radius of curvature of the seventh lens 117 in the optical axis may be larger than the radius of curvature of the sixth lens 116. The radius of curvature of the seventh lens 117 may be larger than the radius of curvature of the fifth and sixth lenses 115 and 116. When expressed as an absolute value, the difference in the curvature radius between the object-side surface and the sensor-side surface of the seventh lens 117 may be greater than the difference in the curvature radius between the object-side surface and the sensor-side surface of the sixth lens 116, and may be greater than the difference in the curvature radius between the object-side surface and the sensor-side surface of the fifth lens 115.

If the third lens 113 is designed as an aspherical surface, it may satisfy thermal compensation and improve optical performance, but may not be as easy to assemble as a spherical lens, and the optical characteristics of lenses arranged on the sensor side may be affected more than the third lens 113 due to the assemblability of the aspherical third lens 113. If the third lens is a spherical lens, even if the optical characteristics of the third lens are affected, the curvature radius of the third lens on the optical axis may not be significantly changed due to the spherical characteristics. The third lens 113 having an aspherical surface has a curvature radius of less than 35 mm and is designed to have a large effective diameter, so that assembly may be easy. In addition, since the third lens 113 has a large curvature radius on the optical axis and thus has a gentle lens shape, even if it is assembled with a slight tilt from the optical axis, the influence on the sensor-side lenses may be minimal.

Among the first to fourth lenses 111-114, the first lens 111 having a spherical surface is arranged on the object side of the aperture stop ST and is the lens most sensitive to optical characteristics, so the curvature radius of the first lens 111 is made larger than the curvature radii of the second and third lenses, and the thickness of the first lens 112 is provided as thickest. Here, a sensitive lens means a lens that has a large influence on the optical system even if the assembly is slightly misaligned. Therefore, since the lens disposed on the object side of the aperture is the most sensitive to assembly, the curvature radius of the lenses adjacent to the aperture is designed to be the largest, and then the curvature radius of the first lens, which is sensitive to assembly, is increased.

Since the third lens 113 is provided as an aspherical surface, the curvature radius on the optical axis may be increased without increasing the curvature radius, the difference in the curvature radius between the object-side surface and the sensor-side surface cannot be greatly increased, heat compensation is possible by the glass material, the assembling performance may be improved by the effective diameter, and the influence on the optical characteristics may be reduced. The curvature radius of the seventh lens 117 may be larger than the curvature radius of the sixth lens 116 made of glass. Accordingly, the seventh lens 117 can guide the light incident through the first to sixth lenses 111-116 to the entire region of the image sensor 300. When the radius of curvature of the seventh lens 117 is made larger than the radius of curvature of the sixth lens 126, the assembling properties of the last aspherical lens may be improved and changes in optical characteristics may be minimized.

The radii of curvature of each lens surface of the first to sixth lenses 111-117 may satisfy the following conditions.

$$Condition 1 : 0 < \vert L 1 R 1 / L 1 R 2 \vert < 1 ,$$

$$Condition 2 : 0 < \vert L 2 R 1 / L 2 R 2 \vert < 1$$

$$Condition 3 : 0.5 < L 3 R 1 / L 3 R 2 < 1.2 ,$$

$$Condition 4 : 5 < \vert L 4 R 1 / L 4 R 2 \vert < 20$$

$$Condition 5 : 0.2 < \vert L 5 R 1 / L 5 R 2 \vert < 1.2 ,$$

$$Condition 6 : 0.7 < \vert L 6 R 1 / L 6 R 2 \vert < 1.5$$

$$Condition 7 : 2 < \vert L 7 R 1 / L 7 R 2 \vert < 7 ,$$

$$Condition 8 : 1 mm \leq \vert L 3 R 2 - L 3 R 1 \vert \leq 10 mm$$

$$Condition 9 : 30 mm < \vert L 7 R 1 \vert - L 7 R 2$$

If the difference between the object-side curvature radius and the sensor-side curvature radius of the third lens 113 is provided within the above range, the assembling performance of the third lens 113 having an aspherical surface may be improved and the optical influence caused by the third lens 113 may be reduced.

Describing the thickness of the lenses, the center thickness CT1 of the first lens 111 may be greater than the center thicknesses CT2-CT7 of the second to seventh lenses 112-117, and may have the maximum thickness within the lens portion 100A. The center thickness CT4 of the fourth lens 114 may be smaller than the center thicknesses CT1-CT5 of the first to fifth lenses 111-115, and preferably, may have the minimum thickness within the lens portion 100A. The aspherical lens may include a third lens 113 and a seventh lens 117. The center thickness CT1 of the first lens 111 may be greater than 100% of the center thickness CT56 of the cemented lens CL2, for example, in a range of 101% to 150%. The thickness of each lens may satisfy at least one of the following conditions.

$$Condition 1 : 0.6 < CT 1 / ET 1 < 1.3 ,$$

$$Condition 2 : 1 < CT 2 / ET 2 < 2.7$$

$$Condition 3 : 0.8 < CT 3 / ET 3 < 2 ,$$

$$Condition 4 : 0.8 < CT 4 / ET 4 < 2.5$$

$$Condition 5 : 1.5 < CT 5 / ET 5 < 3.5 ,$$

$$Condition 6 : 0 < CT 6 / ET 6 < 1$$

$$Condition 7 : 0.3 < CT 7 / ET 7 < 1.2 ,$$

$$Condition 8 : 0.8 < \sum CT / \sum ΕΤ < 1.2$$

$$Condition 9 : 0.24 < CT 1 / \sum CT < 0.44 ,$$

In this way, the difference between the center thickness and the edge thickness of each lens may be set to be more than 0.6 mm and less than 4 mm. This can prevent the difference between the center thickness and the edge thickness of each lens from increasing by arranging the aspherical lens in the third and seventh lenses 113 and 117. In addition, the difference between the center thickness and the edge thickness of the third lens 113 may be set to the range of condition 3.

In addition, the difference between the maximum center thickness and the minimum center thickness in the lenses will be referred to the description of the first embodiment. The maximum center thickness may be greater than the sum of the center thicknesses of two adjacent lenses.

The center distance CG3 between the third lens 113 and the fourth lens 114 is a center distance between the aspherical lens and the spherical lens, is the maximum within the lens portion 100A, and is greater than the center distance between the spherical lenses. That is, the distance CG3 between the adjacent object-side aspherical lens and the sensor-side spherical lens may be the maximum within the lens portion 100A, and may be less than the center thickness of the cemented lens CL2, for example, 61% or less of the center thickness of the cemented lens CL2, for example, in the range of 41% to 61%. The center distance CG6 between the sixth lens 116 and the seventh lens 117 may be smaller than the center distance CG3 and the second largest within the lens portion 100A. That is, the distance CG6 between the adjacent object-side spherical lens and the sensor-side aspherical lens may satisfy the following condition: CG6<CT7<CG3<CT1.

The center thickness of each lens and the center distances between the adjacent lenses may satisfy the following conditions (Here, the distance within the cemented lens is excluded).

$$Condition 1 : 15 < CT 1 / CG 1 < 40 ,$$

$$Condition 2 : 0.4 < CG 6 / CT 7 < 1.5$$

$$Condition 3 : 0.5 < CG 3 / CT 3 < 2 ,$$

$$Condition 4 : ( CG 6 / CT 7 ) < ( CG 3 / CT 3 )$$

$$Condition 5 : 0.2 < CG 3 / \sum CG < 0.7 ,$$

$$Condition 6 : 2 < CT 1 / CG 3 < 3.2$$

By providing the maximum center thickness of the lenses to be 2.1 times or more, for example, in the range of 2.1 to 3 times, the center distance between the lenses may be provided without increasing the center distance compared to the center thickness of each lens, thereby providing a camera module that applies an aspherical lens within the optical system. In Condition 3, since the aspherical third lens 113 is provided in a meniscus shape convex toward the object side, the distance between the third and fourth lenses 114 and 115 may be provided greatly. Here, if the i-th center distance between the adjacent two lenses is defined as CGi, and the center thickness of the i-th lens positioned closer to the object side than CGi is defined as CTi, the following conditions may be satisfied (here, the distance between the cemented lens and the cemented lens is excluded). The ratio of CTi/CGi is maximum when i is 1, and minimum when i is 3. The reason why the value of CTi/CGi is minimum when i is 3 may be implemented by the third lens 113 made of aspherical glass material.

If the optical axis distance from the center of the object-side surface of the first lens 111 to the surface of the image sensor 300 is TTL, the following conditions may be satisfied.

$$Condition 1 : 0.15 < CT 1 / TTL < 0.5$$

Preferably, Condition 1 may satisfy: 0.2≤CT1/TTL≤0.3. Since the first lens 111 is a glass material of the spherical lens, an optical system may be designed that may satisfy thermal compensation according to temperature change by the thickness of the first lens 111 satisfying condition 1. That is, condition 1 may be a feature that appears when the first lens 111 is designed as spherical glass.

$$Condition 2 : 0 < CT 2 / TTL < 0.2 ,$$

$$Condition 3 : 0 < CT 3 / TTL < 0.2$$

$$Condition 4 : 0 < CT 4 / TTL < 0.2 ,$$

$$Condition 5 : 0 < CT 5 / TTL < 0.3$$

$$Condition 6 : 0 < CT 6 / TTL < 0.2 ,$$

$$Condition 7 : 0 < CT 7 / TTL < 0.2$$

The ratio of CT1/TTL of condition 1 may be greater than the values of conditions 2 to 7.

In terms of the effective diameter, the lens having the maximum effective diameter may be the third lens 113. The fifth surface S5 of the third lens 113 may be the lens surface having the maximum effective diameter. The lens having the minimum effective diameter may be the lens closest to the image sensor 300, for example, the seventh lens 117. The third lens 113 having the maximum effective diameter may be arranged between the second lens 112 and the fourth lens 114. The lens surface having the minimum effective diameter may be the thirteenth surface S13 of the seventh lens 117.

The effective diameter of each lens may satisfy the following conditions.

$$Condition 1 : CA 11 < CA 21 < CA 22 ,$$

$$Condition 2 : CA 71 < CA 72$$

$$Condition 3 : CA 32 < CA 22 < CA 31 ,$$

$$Condition 4 : ( CA 11 - CA 12 ) < ( CA 61 - CA 62 )$$

$$Condition 5 : CA 71 < CA 61 < CA 51 < CA 41 ,$$

$$Condition 6 : ( 2 * ImgH ) < CA 1 < CA 2 < CA 3 > CA 4 ,$$

$$Condition 7 : CA 4 > CA 5 > CA 6 > ( 2 * ImgH ) > CA 7$$

As in Condition 1, even if the effective diameter of the first lens 111 is provided to be smaller than that of the second lens 112, the heat compensation may be more effective and the assembling may be improved due to the spherical glass material and thick thickness.

In terms of the refractive index, at least one of the first and third lenses 111 and 113 has the largest refractive index among the lenses, and preferably, the refractive index of the first lens 111 may be the largest and may be 1.72 or more. The difference in the refractive indices of the first and third lenses 111 and 113 is 0.10 or less. The refractive index of the fourth lens 114 is the smallest among the lenses. The difference between the maximum refractive index and the minimum refractive index may be 0.20 or more. By adjusting the refractive indices of the spherical lens and the aspherical lens, the incident efficiency may be increased, and the incident light may be guided to the image sensor 300.

In terms of the Abbe number, the Abbe number of the fourth lens 114 is the largest among the lenses and may be 65 or more. The Abbe number of the first lens 111 is the smallest among the lenses. The difference between the maximum refractive index and the minimum Abbe number may be 30 or more. By making the Abbe number of the object-side lens based on the aperture stop ST small, the Abbe number of the sensor-side lens based on the aperture stop ST large, and providing the Abbe number of the aspherical seventh lens 117 closest to the image sensor 300 small, the color dispersion of light traveling between the lenses made of glass may be controlled, and the color dispersion between the spherical lens and the aspherical lens may be increased and guided to the image sensor 300.

If the average effective diameter of the spherical lens is GL_CA_Aver and the average effective diameter of the aspherical lens is GM_CA_Aver, the following condition may satisfy: GM_CA_Aver<GL_CA_Aver.

If the average of the center thickness of the spherical lens is GL_CT_Aver and the average of the center thickness of the aspherical lens is GM_CT_Aver, the following condition may satisfy: GM_CT_Aver<GL_CT_Aver. The average refractive index of the spherical lens is GL_nd_Aver, and the average refractive index of the aspherical lens is GM_nd_Aver, so that the following condition may satisfy: GL_nd_Aver<GM_nd_Aver. The average Abbe number of the spherical lens is GL_Ad_Aver, and the average Abbe number of the aspherical lens is GM_Ad_Aver, so that the following condition may satisfy: GM_Ad_Aver<GL_Ad_Aver.

The focal lengths F1, F6, and F7 of the first, sixth, and seventh lenses 111, 116, and 117 have negative refractive power, and the focal lengths F2, F3, F4, and F5 of the second, third, fourth, and fifth lenses 112, 113, 114, and 115 may have positive refractive power. In addition, the fifth and sixth lenses 115 and 116, which are adjacently arranged lenses, may satisfy the following conditions.
Condition 1: Refractive index of lens with positive refractive power<Refractive index of lens with negative refractive power
Condition 2: Dispersion of lens with positive refractive power>Dispersion of lens with negative refractive power

Here, the fifth lens 115 has positive refractive power and the sixth lens 116 has negative refractive power, and like conditions 1 and 2, the refractive index of the fifth lens 115 is smaller than the refractive index of the sixth lens 116, and the dispersion value of the fifth lens 115 is larger than the dispersion value of the sixth lens 116. Accordingly, the chromatic aberration occurring in the spherical lens may be corrected with an aspherical lens. In addition, by satisfying the refractive index difference of the fifth and sixth lenses 115 and 116 arranged sequentially to be 0.01 or more and 0.15 or less and the Abbe number difference to be 20 or more and 60 or less, the chromatic aberration occurring in the spherical lens may be compensated for with the cemented lens. Here, the refractive index difference is rounded off to the third decimal place, and the Abbe number difference is rounded off to the first decimal place to compare the values.

The optical system 1000 generates chromatic aberration, and the chromatic aberration is corrected by using a cemented lens CL2 or two lenses arranged in series. The lens repeatedly contracts and expands as the temperature changes from low to high. Since the lens characteristics of lenses of the same material change the same amount according to the temperature change, it is effective to correct the chromatic aberration between lenses of the same material even when the temperature changes. The chromatic aberration occurring in the spherical lens may be corrected by using the third lens 113 and the seventh lens 117, and the chromatic aberration between the spherical lens and the aspherical lens may be mutually corrected by using the sixth lens 116 and the seventh lens 117. By arranging glass lenses having relatively high Abbe numbers of the fifth lens 115 of the cemented lens CL2 arranged on the object side of the aspherical seventh lens 117, color dispersion may be reduced by the glass lenses and color dispersion may be increased by the aspherical lenses.

When the focal length is expressed as an absolute value, the focal length of the third lens 113 is the largest among the lenses and may be 60 or more. The focal length of the sixth lens 116 is the smallest among the lenses. The difference between the maximum focal length and the minimum focal length may be 35 or more. By making the focal length of the aspherical third lens 113 on the object side the largest and providing the focal length of the sixth lens 116 adjacent to the last aspherical lens the smallest, the optical system may have improved MTF characteristics, aberration control characteristics, resolution characteristics, etc. in the set field of view range, and may have good optical performance in the periphery of the field of view.

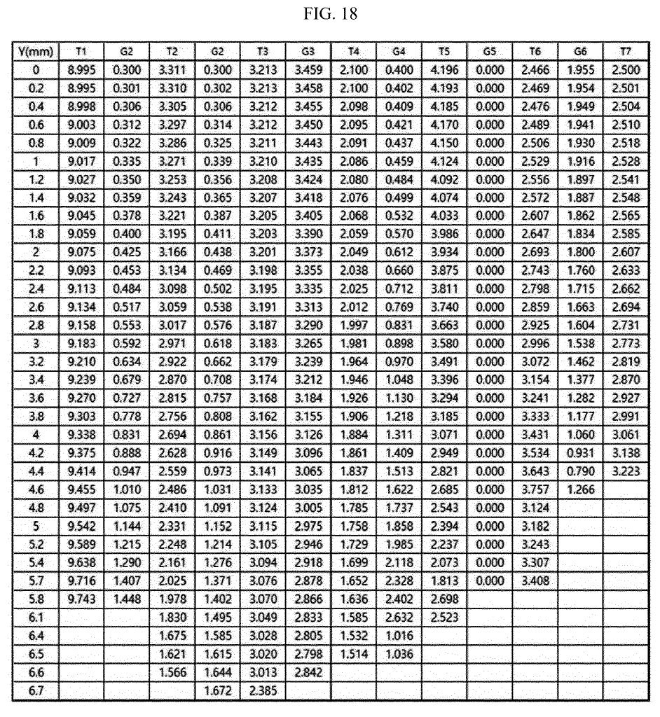

As shown in FIG. 15, in the absolute values of the Sag values, the maximum value of Sag51 may be greater than the maximum values of Sag52, Sag62, Sag71, and Sag72. As shown in FIG. 17, the lens surfaces of the third and seventh lenses 113 and 117 among the lenses of the lens portion 100A may include aspherical surfaces having a 30th aspherical coefficient. For example, the third and seventh lenses 113 and 117 may include lens surfaces having a 30th aspherical coefficient. As shown in FIG. 18, the thicknesses T1-T7 of each lens in the Y-axis direction may be expressed at intervals of 0.1 mm or 0.2 mm or greater, and the distances G1-G6 between each lens may be expressed at intervals of 0.1 mm or 0.2 mm or greater. The center thickness CT56 of the cemented lens CL2 may be greater than the edge thickness ET56. The center thickness CT56 of the cemented lens CL2 is the distance from the center of the object-side ninth surface S9 of the fifth lens 115 to the center of the twelfth surface S12 of the sixth lens 116, and the edge thickness ET56 is the distance from the end of the effective region of the ninth surface S9 to the twelfth surface S12 in the optical axis direction. The maximum thickness of the cemented lens CL2 is the center, the minimum thickness is the edge, and the maximum thickness may be at least 1 time the minimum thickness, for example, 1 time to 1.5 times the range. The cemented lens CL2 may satisfy the following condition: 0 mm<CT56−ET56<2 mm.

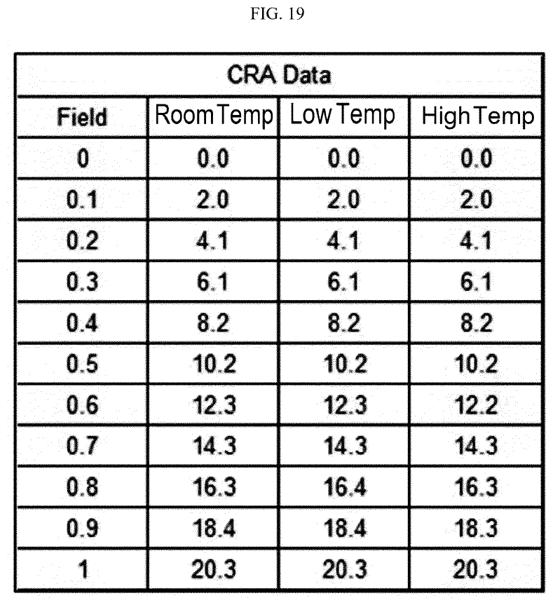

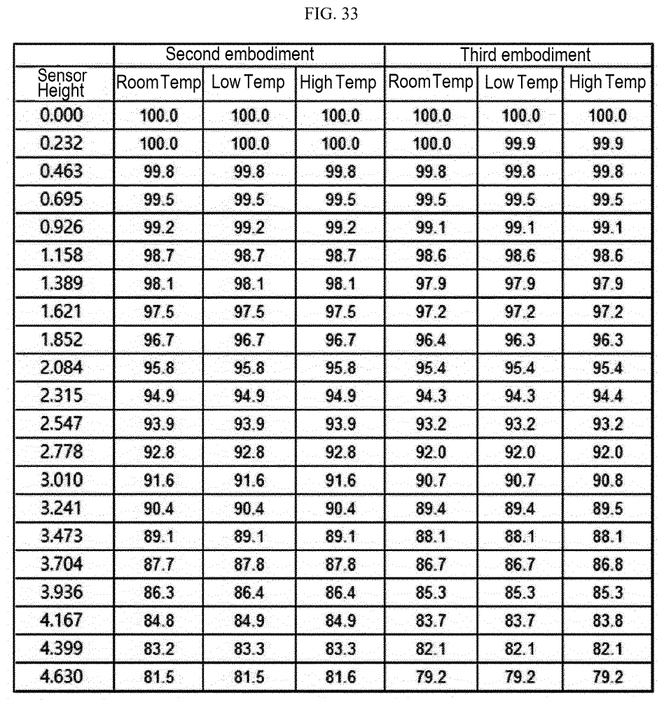

As shown in FIG. 19, the CRA of the optical system and camera module of FIG. 14 may be 10 degrees or more, for example, in a range of 10 to 35 degrees or in a range of 10 to 25 degrees. As shown in FIG. 33, in a table showing the relative illumination from the center of the image sensor to the image height, that is, from 0 to 4.630 mm in the optical system according to the second embodiment, it may be seen that the relative illumination is 70% or more, for example, 75% or more from the center of the image sensor to the diagonal end. That is, it may be seen that the difference in the relative illumination according to the low temperature, room temperature, and high temperature is almost the same up to 4.399 mm from the optical axis.

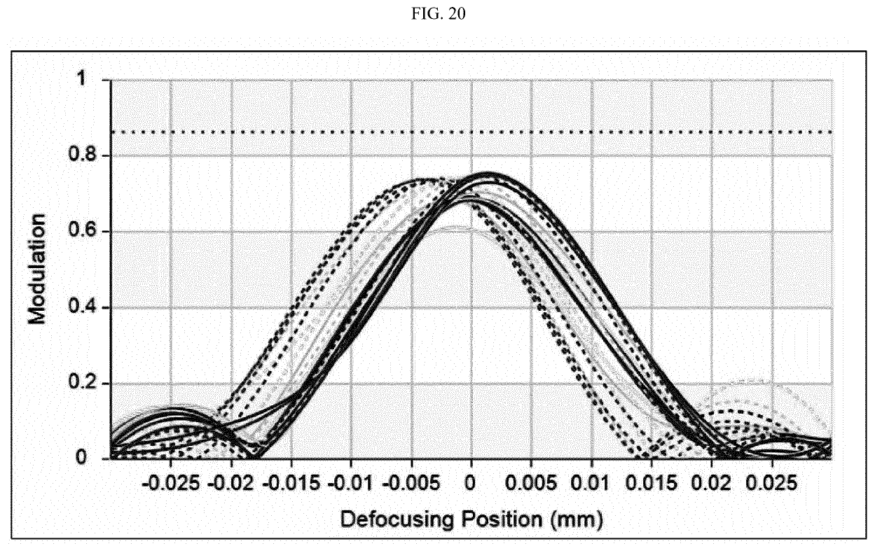

FIGS. 20 to 22 are graphs showing diffraction MTF at room temperature, low temperature, and high temperature in the optical system of FIG. 14, and are graphs showing modulation according to spatial frequency. As shown in FIGS. 20 to 22, the deviation of MTF at low temperature or high temperature based on room temperature may be less than 10%, that is, 7% or less.

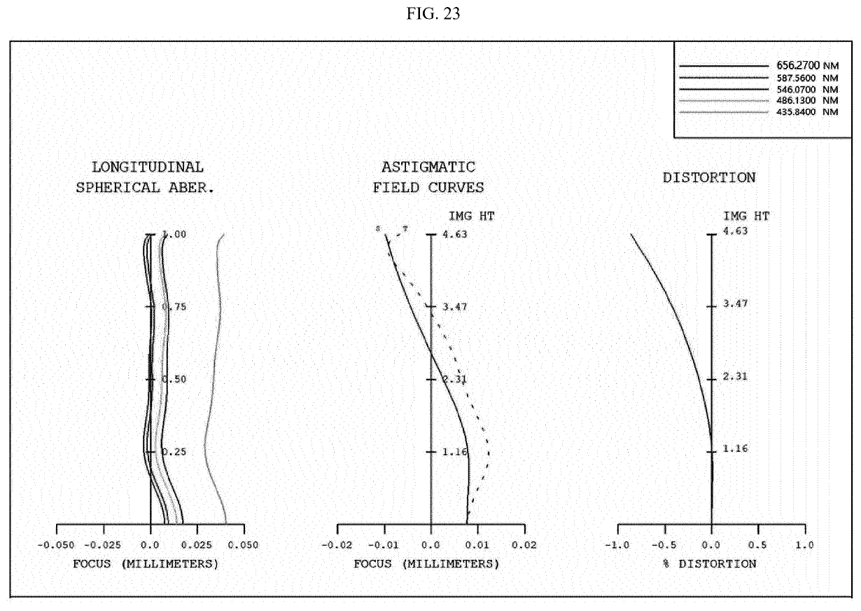

FIGS. 23 to 25 are graphs showing aberration characteristics at room temperature, low temperature, and high temperature in the optical system of FIG. 14. In the aberration graphs of FIGS. 23 to 25, spherical aberration (Longitudinal spherical aberration), astigmatic field curves, and distortion are measured from left to right. In FIGS. 23 to 25, the X-axis may represent a focal length (mm) and a degree of distortion (%), and the Y-axis may represent the height of the image. In addition, the graph for spherical aberration is a graph for light in wavelength bands of about 435 nm, about 486 nm, about 546 nm, about 587 nm, and about 656 nm, and the graph for astigmatism and distortion is a graph for light in wavelength bands of about 546 nm. In the aberration diagrams of FIGS. 23 to 25, it may be interpreted that the aberration correction function is better as each curve at room temperature, low temperature, and high temperature approaches the Y-axis, and the optical system 1000 according to the embodiment may see that the measured values are adjacent to the Y-axis in almost all regions. That is, the optical system 1000 according to the embodiment has improved resolution and may have good optical performance not only in the center portion of the FOV but also in the periphery portion. Here, the low temperature is −20 degrees or less, for example, −20 to −40 degrees, the room temperature is 22 degrees±5 degrees or 18 to 27 degrees, and the high temperature may be 85 degrees or more, for example, 85 to 105 degrees. Accordingly, it may be seen that the reduction in the luminance ratio (modulation) from the low temperature to the high temperature in FIGS. 23 to 25 is less than 10%, for example, 5% or less, or is almost unchanged.

Table 2 compares the changes in optical characteristics such as EFL, BFL, F number, TTL, and FOV at room temperature, low temperature, and high temperature in the optical system according to the embodiment, and it may be seen that the change rate of the optical characteristics at low temperature is 5% or less, for example, 3% or less, based on room temperature, and it may be seen that the change rate of the optical characteristics at low temperature is 5% or less, for example, 3% or less, based on room temperature.

TABLE 2

| | | | | Low | High |
|---|---|---|---|---|---|
| | Room | Low | High | temperature/Room | temperature/Room |
| | temperature | temperature | temperature | temperature | temperature |
| EFL(F) | 15.2 | 15.1 | 15.2 | 99.91% | 100.12% |
| BFL | 3.3 | 3.3 | 3.3 | 99.88% | 100.15% |
| F# | 1.6 | 1.6 | 1.6 | 99.91% | 100.13% |
| TTL | 36.5 | 36.5 | 36.5 | 99.92% | 100.09% |
| FOV | 34.3 | 34.3 | 34.2 | 100.10% | 99.88% |

Therefore, as shown in Table 2, it may be seen that the change in optical characteristics according to the temperature change from low temperature to high temperature, for example, the change rate of the EFL, TTL, BFL, F number, and diagonal FOV, is 10% or less, that is, 5% or less, for example, in the range of 0 to 5%.

The optical system according to the third embodiment of the invention will be described with reference to FIGS. 26 to 32. In describing the third embodiment, a configuration different from the first and second embodiments will be described, and the same configuration may include the description of the first and second embodiments.

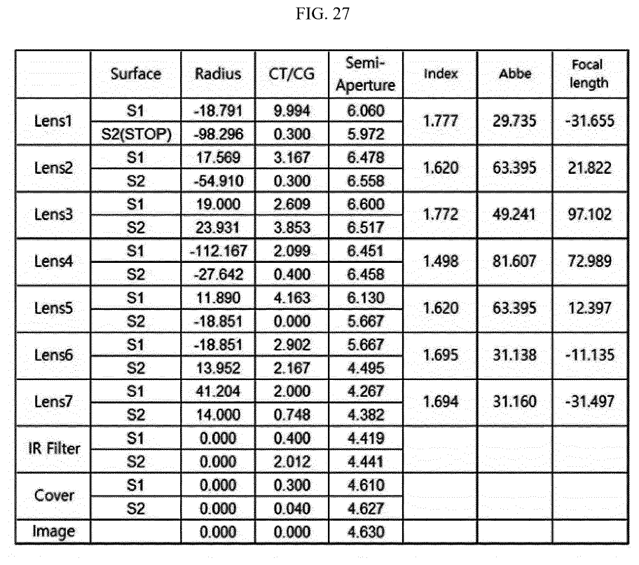

Referring to FIGS. 26 and 27, the lens portion 100B of the optical system 1000 according to the third embodiment may include the first lens 121 to the seventh lens 127. The first lens 121 may be a first lens group LG1, and the second to seventh lenses 122, 123, 124, 125, 126, and 127 may be a second lens group LG2.

The first lens 121 may have a negative (−) refractive power on the optical axis OA. The first lens 121 may be made of glass or a glass non-mold material. The object-side first surface S1 of the first lens 121 on the optical axis may be concave, and the sensor-side second surface S2 may be convex. The thickness of the first lens 121 may be thicker than the thickness of the cemented lens CL3. The center thickness of the first lens 121 may be thicker than the center thickness of the cemented lens CL3. The edge thickness of the first lens 121 may be thicker than the edge thickness of the cemented lens CL3. Since the first surface S1 is concave and the second surface S2 is convex on the optical axis, the incident light may be refracted in a direction away from the optical axis, and the center distance between the first and second lenses 121 and 122 may be reduced and the effective diameter of the second lens 122 may be reduced.

The aperture stop ST may be arranged around the sensor-side surface of the first lens 121. Alternatively, the aperture stop ST may be arranged around the object-side or sensor-side surface of the second lens 122, or around the object-side surface of the third lens 123.

The second lens 122 may have positive (+) refractive power on the optical axis OA. The second lens 122 may be provided with a glass material. The object-side third surface S3 of the second lens 122 based on the optical axis OA may be convex, and the sensor-side fourth surface S4 may be convex. The third surface S3 and the fourth surface S4 may be spherical. The third lens 123 may have positive (+) refractive power on the optical axis OA.

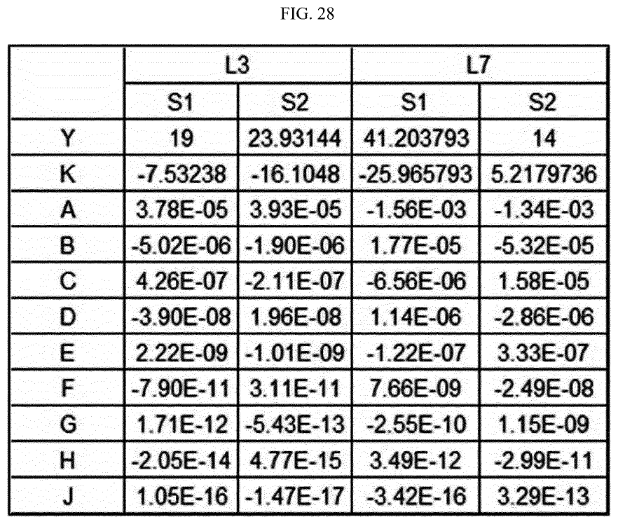

The third lens 123 may be provided with a glass material or a glass mold material. The object-side fifth surface S5 of the third lens 123 based on the optical axis may be convex, and the sensor-side sixth surface S6 may be concave. The third lens 123 may be provided with an aspherical lens made of glass. The fifth surface S5 and the sixth surface S6 may be aspherical, and the aspherical coefficients may be provided as L3S1 and L3S2 of FIG. 28. The effective diameter of the third lens 123 may have the largest effective diameter within the lens portion 100B. The effective diameter of the third lens 123 may have the largest effective diameter among the spherical lens and the aspherical lens.

The fourth lens 124 may have positive (+) refractive power on the optical axis OA. The fourth lens 124 may be provided with a glass material. The object-side seventh surface S7 of the fourth lens 124 with respect to the optical axis may be concave, and the sensor-side eighth surface S8 may be convex. The fourth lens 124 may be provided with a spherical lens made of glass.

The fifth lens 125 may have positive (+) refractive power on the optical axis OA. The fifth lens 125 may be provided with a glass material. Based on the optical axis OA, the object-side ninth surface S9 of the fifth lens 125 may be convex, and the sensor-side tenth surface S10 may be convex. The fifth lens 125 may be a spherical lens. The ninth surface S9 and the tenth surface S10 of the fifth lens 125 may be spherical.

The sixth lens 126 may have negative (−) refractive power on the optical axis OA. The sixth lens 126 may be provided as a glass material. Based on the optical axis OA, the object-side eleventh surface of the sixth lens 126 may be concave, and the sensor-side twelfth surface S12 may be concave. The sixth lens 126 may be spherical. For example, the eleventh surface and the twelfth surface S12 may be spherical. The eleventh surface of the sixth lens 126 may be provided without a critical point from the optical axis OA to the end of the effective region. The twelfth surface S12 may be provided without a critical point from the optical axis OA to the end of the effective region.

The fifth lens 125 and the sixth lens 126 may be bonded or joined, and may be defined as a cemented lens CL3. The fifth and sixth lenses 125 and 126 may have opposite refractive powers. The composite refractive power of the fifth and sixth lenses 125 and 126 may have positive (+) refractive power. The product of the refractive power of the object-side fifth lens 125 of the cemented lens CL3 and the refractive power or focal length of the sensor-side sixth lens 126 may be less than 0. The composite refractive power of the cemented lens CL3 may have a positive refractive power, and the fourth lens 124 arranged on the object side based on the cemented lens CL3 may have a positive refractive power, and the seventh lens 127 arranged on the sensor side may have a negative refractive power. Accordingly, the fourth lens 124, the cemented lens CL3, and the seventh lens 127 may refract some of the incident light in the direction of the optical axis.

The effective diameter of the cemented lens CL3 may be larger than the diagonal length of the image sensor 300. The effective diameter of the fifth lens 125 may be an average of the effective diameters of the ninth surface S9 and the tenth surface S10, and the effective diameters of each of the ninth surface S9 and the tenth surface S10 may be larger than the diagonal length of the image sensor 300. The effective diameter of the sixth lens 126 may be smaller than the effective diameter of the fifth lens 125 and larger than the diagonal length of the image sensor 300. The effective diameter of the seventh surface S7 of the fourth lens 124 may be larger than the diagonal length of the image sensor 300, and the effective diameter of the twelfth surface S12 of the sixth lens 126 may be smaller than the diagonal length of the image sensor 300. The difference in effective diameters between the object-side eleventh surface and the sensor-side twelfth surface S12 of the sixth lens 126 may be the largest within the lens portion 100B. For example, the effective diameters of the ninth and tenth surfaces of the sixth lens 126 satisfy the following condition: CA61>CA62, and the difference between CA61 and CA62 may be the largest among the differences in effective diameters between the object-side surfaces and the sensor-side surfaces of each lens. Accordingly, by maximizing the difference in effective diameter between the object-side surface and the sensor-side surface of the sixth lens 126, light may be guided to the effective region of the aspherical lens having a relatively small effective diameter. Accordingly, a slimmer optical system may be provided. The effective diameter of the sixth lens 126 may satisfy the following condition: 1.10<CA61/CA62<1.50.

The seventh lens 127 may have negative (−) refractive power on the optical axis OA. The seventh lens 127 may be made of glass or glass mold material. The object-side thirteenth surface S13 of the seventh lens 127 in the optical axis may be convex, and the sensor-side fourteenth surface S14 may be concave. The seventh lens 127 may be made of glass and have aspherical surfaces on both sides. The thirteenth surface S13 and the fourteenth surface S14 above have aspherical surfaces, and the aspherical coefficients may be provided as L7S1 and L7S2 of FIG. 28.

FIG. 27 is an example of lens data of the optical system of the embodiment of FIG. 26. As shown in FIG. 27, when the curvature radius of each lens on the optical axis is expressed as an absolute value, the curvature radius of the seventh surface S7 of the fourth lens 124 on the optical axis OA may be the largest among the lenses, and the curvature radius of the ninth surface S9 of the fifth lens 125 or the twelfth surface S12 of the sixth lens 126 may be the smallest among the lenses. Preferably, the curvature radius of the ninth surface S9 of the fifth lens 125 may be the smallest. The difference between the maximum curvature radius and the minimum curvature radius may be 10 times or more, for example, 10 times to 50 times. The radius of curvature of the third lens 123, which is an aspherical lens, may be smaller than the radii of curvature of the first, second, and fourth lenses 121, 122, and 124 made of glass. Here, the radius of curvature is an average of the absolute values of the radii of curvature of the object-side surface and the sensor-side surface of each lens. When expressed as an absolute value, the radius of curvature of the first lens 121 disposed on the object-side of the aperture stop ST in the optical axis may be larger than the radius of curvature of the second lens 122 disposed on the sensor-side of the aperture stop ST. When expressed as an absolute value, the radius of curvature of the seventh lens 127 on the optical axis may be larger than the radius of curvature of the sixth lens 126. The radius of curvature of the seventh lens 127 may be larger than the radii of curvature of the fifth and sixth lenses 125 and 126. When expressed as an absolute value, the difference in the radius of curvature between the object-side surface and the sensor-side surface of the seventh lens 127 may be greater than the difference in the radius of curvature between the object-side surface and the sensor-side surface of the sixth lens 126, and may be greater than the difference in the radius of curvature between the object-side surface and the sensor-side surface of the fifth lens 125.

The radius of curvature of the third lens 123 having an aspherical surface is less than 35 mm and the effective diameter is designed to be large, so that assembly may be facilitated. Also, when the radius of curvature is large on the optical axis, the shape of the lens is formed gently, so that even if it is assembled with a slight tilt from the optical axis, the influence on the lenses on the sensor side may be minimal. Among the first to fourth lenses 121-124, the first lens 121 having a spherical surface is disposed on the object side of the aperture stop ST and is the lens most sensitive to optical characteristics. Therefore, the radius of curvature of the first lens 121 is made larger than the radii of curvature of the second and third lenses 122 and 123, and the thickness of the first lens 122 is provided as thickest.

Since the third lens 123 is provided as an aspherical surface, the curvature radius on the optical axis may not be increased, the difference in the curvature radius between the object-side surface and the sensor-side surface may not be greatly increased, heat compensation may be possible by the glass material, the assemblability may be improved by the effective diameter, and the influence on the optical characteristics may be reduced. The curvature radius of the seventh lens 127 may be larger than the curvature radius of the sixth lens 126 made of glass.

The curvature radii of the first lens 121 to the seventh lens 127 may satisfy the following conditions.

$$Condition 1 : 0 < \vert L 1 R 1 / L 1 R 2 \vert < 1 ,$$

$$Condition 2 : 0 < \vert L 2 R 1 / L 2 R 2 \vert < 1$$

$$Condition 3 : 0.5 < L 3 R 1 / L 3 R 2 < 1.2 ,$$

$$Condition 4 : 5 < \vert L 4 R 1 / L 4 R 2 \vert < 20$$

$$Condition 5 : 0.2 < \vert L 5 R 1 / L 5 R 2 \vert < 1.2 ,$$

$$Condition 6 : 0.7 < \vert L 6 R 1 / L 6 R 2 \vert < 1.5$$

$$Condition 7 : 2 < \vert L 7 R 1 / L 7 R 2 \vert < 7 ,$$

$$Condition 8 : 1 mm \leq \vert L 3 R 2 - L 3 R 1 \vert \leq 10 mm$$

$$Condition 9 : 30 mm < \vert L 7 R 1 \vert - L 7 R 2$$

If the difference between the object-side curvature radius and the sensor-side curvature radius of the third lens 123 is provided within the above range, the assembling performance of the third lens 123 having an aspherical surface may be improved and the optical influence caused by the third lens 123 may be reduced.

The center thickness CT1 of the first lens 121 may be greater than 100% of the center thickness CT56 of the cemented lens CL3, and may be in the range of, for example, 101% to 150%. The thicknesses of the first to seventh lenses 121-127 may satisfy the following conditions.

$$Condition 1 : 0.6 < CT 1 / ET 1 < 1.3 ,$$

$$Condition 2 : 1 < CT 2 / ET 2 < 2.7$$

$$Condition 3 : 0.8 < CT 3 / ET 3 < 2 ,$$

$$Condition 4 : 0.8 < CT 4 / ET 4 < 2.5$$

$$Condition 5 : 1.5 < CT 5 / ET 5 < 3.5 ,$$

$$Condition 6 : 0 < CT 6 / ET 6 < 1$$

$$Condition 7 : 0.3 < CT 7 / ET 7 < 1.2 ,$$

$$Condition 8 : 0.8 < \sum C T / \sum ΕΤ < 1.2$$

$$Condition 9 : 0.24 < CT 1 / \sum C T < 0.44$$

Also, the maximum center thickness may be greater than the sum of the center thicknesses of two adjacent lenses.

The center distance CG3 between the third lens 123 and the fourth lens 124 is the center distance between the aspherical lens and the spherical lens, is the maximum within the lens portion 100B, and is larger than the center distance between the spherical lenses. It may be less than the center thickness of the cemented lens CL3, for example, 61% or less of the center thickness of the cemented lens CL3, for example, in the range of 41% to 61%. The following Condition may satisfy: CG6<CT7<CG3<CT1.

The distances between the first to seventh lenses 121-127 may satisfy the following conditions (Here, the distance within the cemented lens is excluded).

$$Condition 1 : 15 < CT 1 / CG 1 < 40 ,$$

$$Condition 2 : 0.4 < CG 6 / CT 7 < 1.5$$

$$Condition 3 : 0.5 < CG 3 / CT 3 < 2 ,$$

$$Condition 4 : ( CG 6 / CT 7 ) < ( CG 3 / CT 3 )$$

$$Condition 5 : 0.2 < CG 3 / \sum CG < 0.7 ,$$

$$Condition 6 : 2 < CT 1 / CG 3 < 3.2$$

By providing the maximum center thickness between the lenses to be 2.1 times or more of the maximum center distance, for example, in the range of 2.1 to 3 times, a camera module applying an aspherical lens within the optical system may be provided without increasing the center distance compared to the center thickness of each lens. In Condition 3, since the aspherical third lens 123 is provided in a meniscus shape convex toward the object side, the distance between the third and fourth lenses 124 and 125 may be provided greatly.

Here, if the i-th center distance between adjacent two lenses is defined as CGi, and the center thickness of the i-th lens positioned closer to the object than CGi is defined as CTi, the following conditions may be satisfied (here, the distance between the cemented lenses and the cemented lenses is excluded). The ratio of CTi/CGi may be maximum when i is 1, and minimum when i is 3. The reason why the value of CTi/CGi is minimum when i is 3 may be implemented by the third lens 123 made of an aspherical glass material.

In terms of the effective diameter, the lens having the maximum effective diameter may be the third lens 123. The fifth surface S5 of the third lens 123 may be the lens surface having the maximum effective diameter. The lens having the minimum effective diameter may be the lens closest to the image sensor 300, for example, the seventh lens 127. The lens surface having the minimum effective diameter may be the thirteenth surface S13 of the seventh lens 127. The relationship between CT1 to CT7 and TTL, and the effective diameters of the first lens 121 to the seventh lens 127, the refractive indexes, and the Abbe numbers of the first to seventh lenses 121-127 will be referred to in the description of the second embodiment.

The focal lengths F1, F6, and F7 of the first, sixth, and seventh lenses 121, 126, and 127 have negative refractive power, and the focal lengths F2, F3, F4, and F5 of the second, third, fourth, and fifth lenses 122, 123, 124, and 125 may have positive refractive power. By satisfying the refractive index difference of the fifth and sixth lenses 125 and 126 arranged sequentially to be 0.01 or more and 0.15 or less and the Abbe number difference to be 20 or more and 60 or less, the chromatic aberration occurring in the spherical lens may be compensated for by the cemented lens.

The third lens 123 and the seventh lens 127 may be applied as aspherical lenses to correct the chromatic aberration occurring in the spherical lens, and the sixth lens 126 and the seventh lens 127 may be used to mutually correct the chromatic aberration between the spherical lens and the aspherical lens. By arranging glass lenses having relatively high Abbe numbers of the fifth lens 125 of the cemented lens CL3 arranged on the object side of the aspherical seventh lens 127, color dispersion may be reduced by the glass lenses and color dispersion may be increased by the aspherical lenses.

When the focal length is expressed as an absolute value, the focal length of the third lens 123 is the largest among the lenses and may be 70 or more. The focal length of the sixth lens 126 is the smallest among the lenses. The difference between the maximum focal length and the minimum focal length may be 45 or more. By making the focal length of the aspherical third lens 123 on the object side the largest and providing the focal length of the sixth lens 126 adjacent to the last aspherical lens the smallest, the optical system may have improved MTF characteristics, aberration control characteristics, resolution characteristics, etc. in the set FOV range, and may have good optical performance in the periphery portion of the FOV.

The object-side surface of the seventh lens 127 has a critical point. The critical point is a point where the trend of the Sag value changes. That is, the point where the Sag value increases and then decreases, or the point where the Sag value decreases and then increases. It may be seen that the object-side surface of the seventh lens 127 has a critical point between a point of 1.6 mm and a point of 2.4 mm in a direction perpendicular to the optical axis based on the optical axis. For example, the Sag value of the object-side surface of the seventh lens 127 increases in a direction perpendicular to the optical axis up to the critical point, and then decreases toward the edge after the critical point. If the critical point exists on the object surface of the seventh lens 127, the TTL may be reduced, which facilitates miniaturization and weight reduction of the optical system. As another example, the sensor-side surface of the seventh lens 127 may have a critical point. In contrast, the object-side surface and the sensor-side surface of the seventh lens 127 may be provided without a critical point. When expressed as an absolute value for the Sag value, the maximum value of Sag51 may be greater than the maximum values of Sag52, Sag62, Sag71, and Sag72.

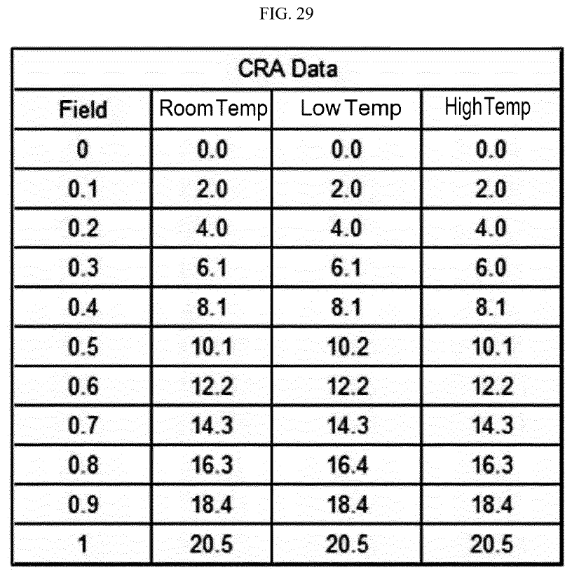

As shown in FIG. 28, the lens surfaces of the third and seventh lenses 123 and 127 among the lenses of the lens portion 100B may include an aspherical surface having a 30th aspherical coefficient. For example, the third and seventh lenses 123 and 127 may include a lens surface having a 30th aspherical coefficient. As shown in FIG. 29, the thickness T1-T7 of each lens in the Y-axis direction may be expressed at intervals of 0.1 mm or 0.2 mm or more, and the distances G1-G6 between each lens may be expressed at intervals of 0.1 mm or 0.2 mm or more. The relationship between the thickness of each lens, the distances between adjacent lenses, and the center thickness CT56 and edge thickness ET56 of the cemented lens CL3 shall be described with reference to the description of the second embodiment.

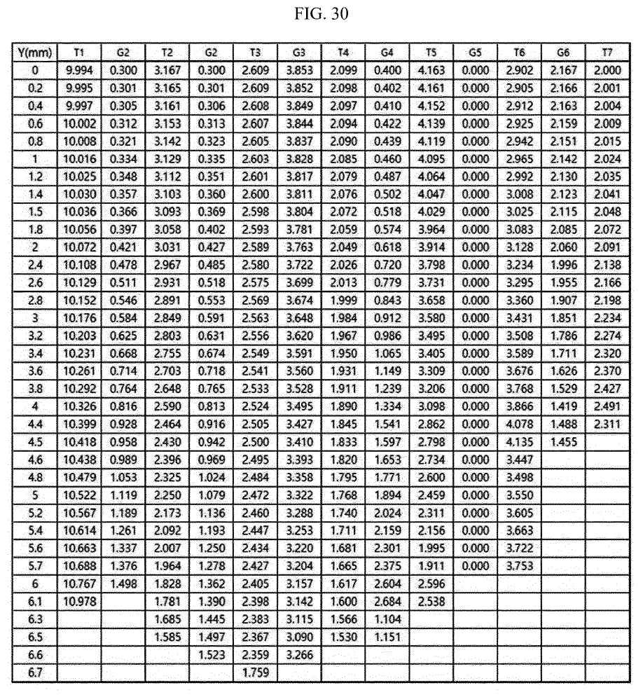

As shown in FIG. 30, the CRA of the optical system and camera module of FIG. 26 may be 10 degrees or more, for example, in a range of 10 to 35 degrees or 10 to 25 degrees. As shown in FIG. 33, in the optical system according to the third embodiment, a table showing the relative illumination or the ambient light ratio from the center of the image sensor to the image height, that is, from 0 to 4.630 mm, may be seen that the relative illumination is 70% or more, for example, 75% or more, from the center of the image sensor to the diagonal end. That is, it may be seen that the difference in the ambient illumination according to the low temperature, room temperature, and high temperature is almost the same up to 4.399 mm from the optical axis.

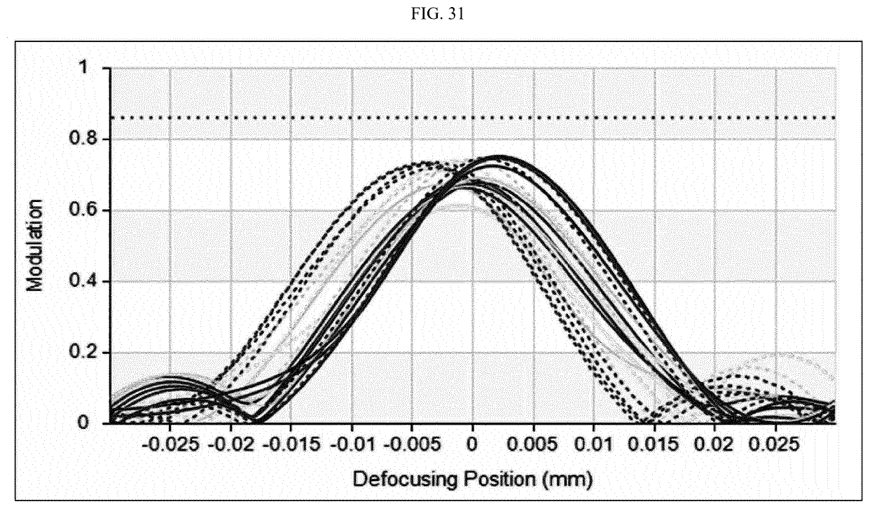

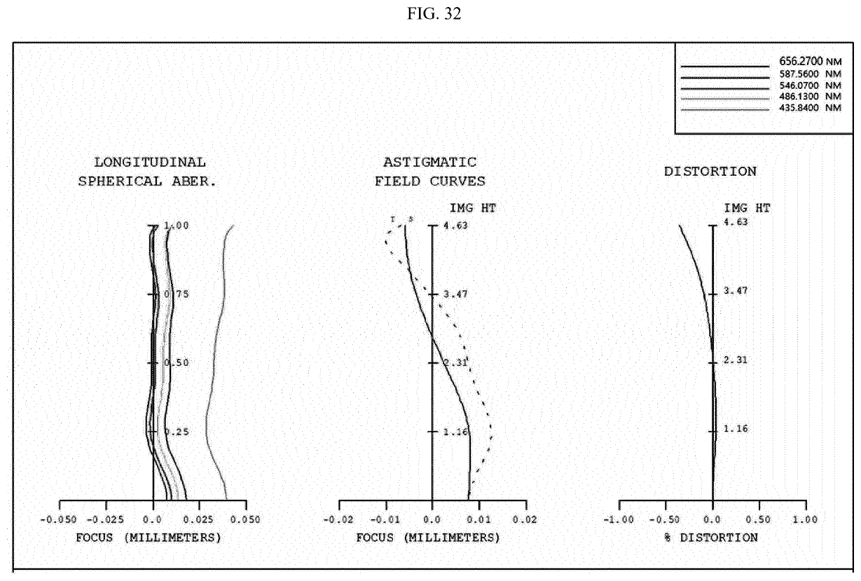

FIG. 31 is a graph showing the diffraction MTF at room temperature in the optical system of FIG. 26, and is a graph showing the modulation according to the spatial frequency. FIG. 32 is a graph showing the aberration characteristics at room temperature in the optical system of FIG. 26. It is a graph measuring spherical aberration (Longitudinal spherical aberration), astigmatic field curves, and distortion from the left to the right in the aberration graph of FIG. 32. The optical system 1000 according to the embodiment has improved resolution and may have good optical performance not only in the center portion but also in the periphery portion of the FOV. Here, the low temperature is −20 degrees or lower, for example, in the range of −20 to −40 degrees, the room temperature is in the range of 22 degrees±5 degrees or in the range of 18 degrees to 27 degrees, and the high temperature is 85 degrees or higher, for example, in the range of 85 degrees to 105 degrees. Accordingly, it may be seen that the reduction in the modulation from the low temperature to the high temperature of FIGS. 23 to 25 is less than 10%, for example, 5% or less, or is almost unchanged. The optical system of the third embodiment disclosed above can effectively control aberration characteristics such as chromatic aberration and distortion aberration, and may have good optical performance not only at the center portion of the FOV but also at the periphery portion.

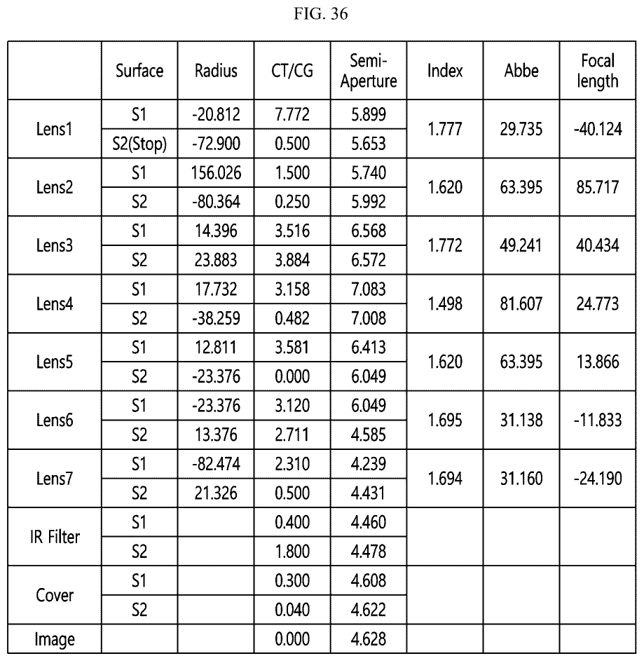

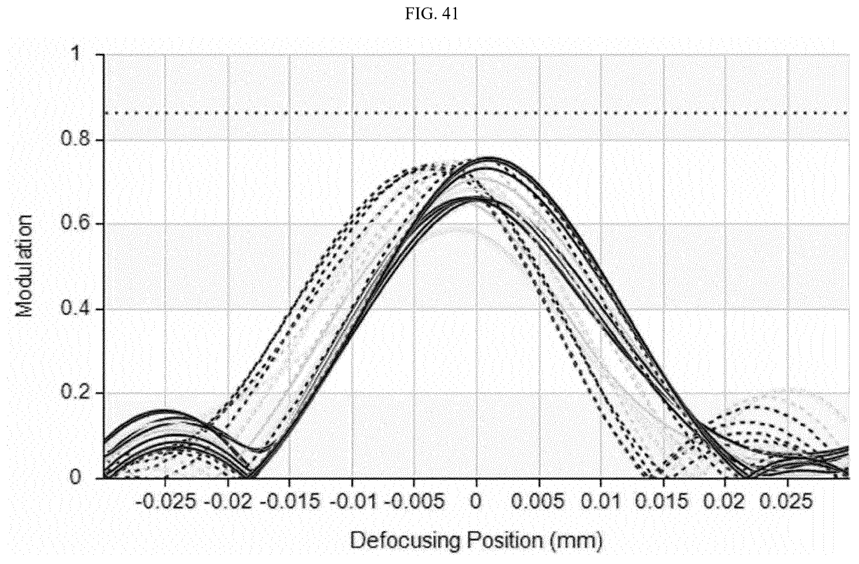

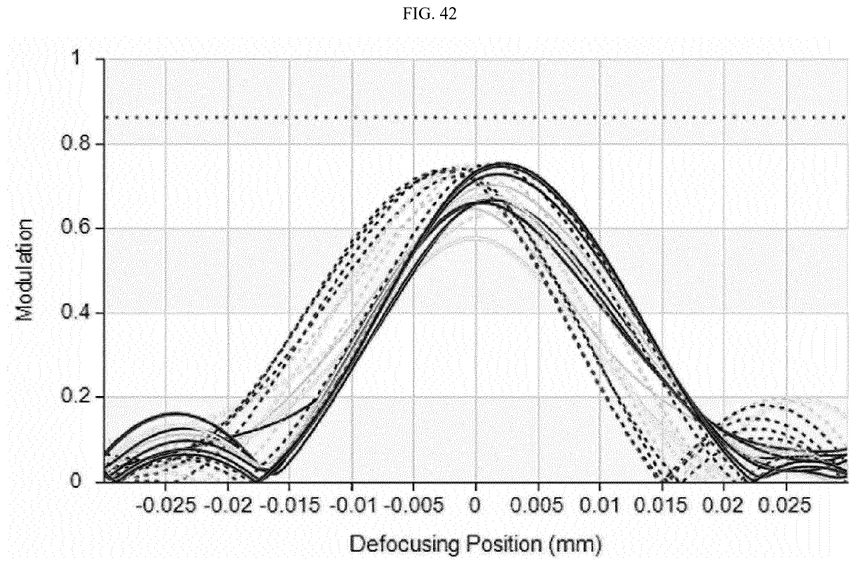

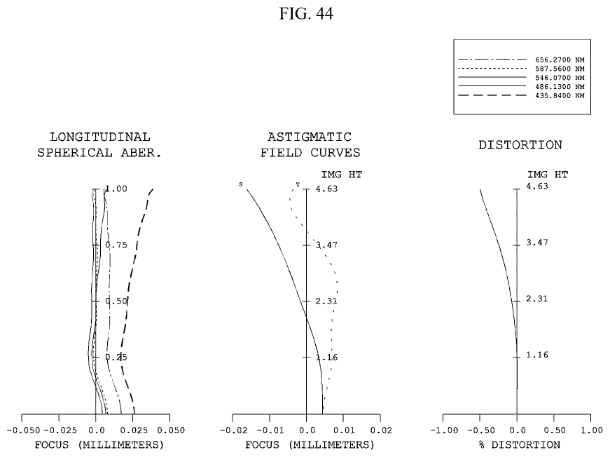

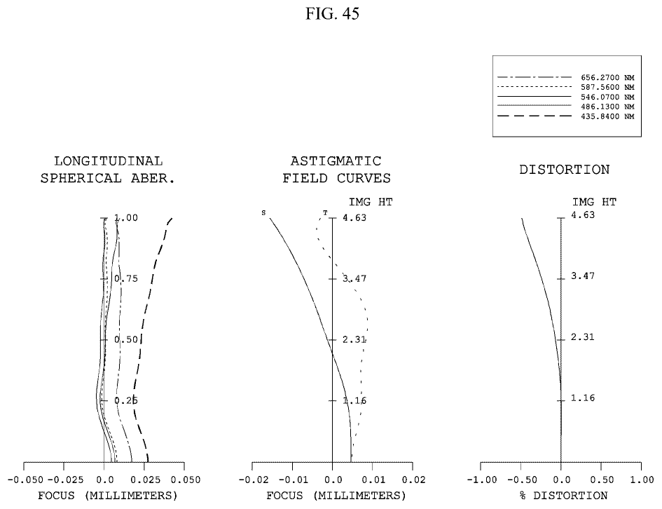

The fourth embodiment of the invention will be described with reference to FIGS. 34 to 45. In describing the fourth embodiment, the same or overlapping contents as those of the first to third embodiments will be referred to in the description of the first to third embodiments, and may be included, substituted, or applied to the fourth embodiment. Referring to FIGS. 34 to 36, the lens portion 100C of the optical system 1000 according to the fourth embodiment may include the first lens 131 to the seventh lens 137. The first lens 131 may be the first lens group LG1, and the second to seventh lenses 132, 133, 134, 135, 136, and 137 may be the second lens group LG2.

The first lens 131 may have a negative (−) refractive power on the optical axis OA. The first lens 131 may be made of glass or a glass non-mold material. The object-side first surface S1 of the first lens 131 on the optical axis may be concave, and the sensor-side second surface S2 may be convex. The thickness of the first lens 131 may be the thickest in the lens portion 100C. The thickness of the first lens 131 may be thicker than the thickness of the cemented lens CL4. The center thickness of the first lens 131 may be thicker than the center thickness of the cemented lens CL4. The edge thickness of the first lens 131 may be thicker than the edge thickness of the cemented lens CL4. The first surface S1 of the first lens 131 may be provided without a critical point from the optical axis OA to the end of the effective region, that is, the edge. The second surface S2 of the first lens 131 may be provided without a critical point.

The aperture stop ST may be arranged on the periphery of the sensor-side surface of the first lens 131. Since the aperture stop ST is arranged on the periphery between the first and second lenses 131 and 132, the center distance between the first and second lenses 131 and 132 may not be increased, and the effective diameter difference between the first and second lenses 131 and 132 may be reduced.

The second lens 132 may have positive (+) refractive power on the optical axis OA. The second lens 132 may be provided with a glass material. The object-side third surface S3 of the second lens 132 on the optical axis OA may be convex, and the sensor-side fourth surface S4 may be convex. The second lens 132 may be provided with a spherical lens made of glass. The third surface S3 and the fourth surface S4 may be spherical. At least one or both of the third surface S3 and the fourth surface S4 may be provided without a critical point from the optical axis OA to the end of the effective region.

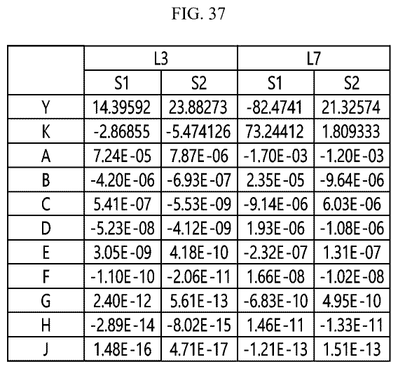

The third lens 133 may have positive (+) refractive power on the optical axis OA. The third lens 133 may be provided with a glass material or a glass mold material. The object-side fifth surface S5 of the third lens 133 on the optical axis may be convex, and the sensor-side sixth surface S6 may be concave. The third lens 133 may be provided as a first aspherical lens made of glass. The fifth surface S5 and the sixth surface S6 may be aspherical, and the aspherical coefficients may be provided as L3S1 and L3S2 of FIG. 37.

The optical system 1000 may include at least one, for example, 1 to 3, glass lenses having aspherical surfaces. The effective radius of the fifth surface S5 or the sixth surface S6 of the third lens 133 may be larger than the effective radii of the object-side surface or the sensor-side surface of the first lens 131 or the seventh lens 137. The effective diameter of the third lens 133 may have the second largest effective diameter in the lens portion 100C. The effective diameter of the third lens 133 may have the second largest effective diameter among the spherical lens and the aspherical lens. The difference between the effective diameter of the third lens 133 and the maximum effective diameter may be 2 mm or less, for example, 1.5 mm or less.

The fourth lens 134 may have positive (+) refractive power on the optical axis OA. The fourth lens 134 may be provided with a glass material. The object-side seventh surface S7 of the fourth lens 134 on the optical axis may be convex, and the sensor-side eighth surface S8 may be convex. The fourth lens 134 may be provided as a spherical lens made of glass. The seventh surface S7 and the eighth surface S8 may be spherical.

The fifth lens 135 may have positive (+) refractive power on the optical axis OA. The fifth lens 135 may be provided as a glass material. The object-side ninth surface S9 of the fifth lens 135 on the optical axis OA may be convex, and the sensor-side tenth surface S10 may be convex. The fifth lens 135 may have a shape in which both sides are convex on the optical axis OA. The fifth lens 135 may be a spherical lens. The ninth surface S9 and the tenth surface S10 of the fifth lens 135 may be spherical.

The sixth lens 136 may have a refractive power of negative (−) on the optical axis OA. The sixth lens 136 may be provided with a glass material. With respect to the optical axis OA, the eleventh surface of the sixth lens 136 on the object side may be concave, and the twelfth surface S12 on the sensor side may be concave. The sixth lens 136 may be spherical. For example, the eleventh surface and the twelfth surface S12 may be spherical. The eleventh surface of the sixth lens 136 may be provided without a critical point from the optical axis OA to the end of the effective region.

The fifth lens 135 and the sixth lens 136 may be bonded or joined, and may be defined as a cemented lens CL4. The bonding surface between the fifth lens 135 and the sixth lens 136 may be defined as a tenth surface S10. When the distance between the fifth and sixth lenses 135 and 136 is G5, G5 may be less than 0.01 mm. The distance G5 between the fifth and sixth lenses 135 and 136 may be less than 0.01 mm from the optical axis OA to the end of the effective region. The fifth and sixth lenses 135 and 136 may have opposite refractive powers. The composite refractive power of the fifth and sixth lenses 135 and 136 may have positive (+) refractive power. The product of the refractive power of the object-side fifth lens 135 of the cemented lens CL4 and the refractive power or focal length of the sensor-side sixth lens 136 may be less than 0. Accordingly, the aberration characteristics of the optical system may be improved. The composite refractive power of the cemented lens CL4 may have a positive refractive power, and the fourth lens 134 arranged on the object side with respect to the cemented lens CL4 may have a positive refractive power, and the seventh lens 137 arranged on the sensor side may have a negative refractive power. Accordingly, the fourth lens 134, the cemented lens CL4, and the seventh lens 137 may refract some of the incident light in the direction of the optical axis.

The difference in effective diameter between the object-side eleventh surface and the sensor-side twelfth surface S12 of the sixth lens 136 may be the largest among the lenses. For example, when the effective diameter of the ninth surface and the effective diameter of the sensor-side twelfth surface S12 of the sixth lens 136 are CA61 and CA62, the following condition satisfies: CA61>CA62, and the difference between CA61 and CA62 may be the largest among the differences in effective diameters between the object-side surface and the sensor-side surface of each lens. Accordingly, by maximizing the effective diameter difference between the object-side surface and the sensor-side surface of the sixth lens 136, light may be guided to the effective region of the aspherical lens having a relatively small effective diameter. Accordingly, a slimmer optical system may be provided. The effective diameter of the sixth lens 136 may satisfy the following condition: 1.10<CA61/CA62<1.50.

The effective diameter difference between the object-side surface and the sensor-side surface of the cemented lens CL4 may be greater than the effective diameter difference between the object-side surface and the sensor-side surface of each of the first to fourth lenses 131-134. The effective diameter difference between the object-side surface and the sensor-side surface of the cemented lens CL4 may be greater than the effective diameter difference between the object-side surface and the sensor-side surface of the sixth lens 136. By applying a bonding lens CL4 between the fourth lens 134 and the seventh lens 137, the effective diameter of the seventh lens 137 may be reduced, thereby improving the assembling efficiency and reducing the TTL.

The seventh lens 137 may have a negative (−) refractive power on the optical axis OA. The seventh lens 137 may be made of glass or glass mold material. The object-side thirteenth surface S13 of the seventh lens 137 on the optical axis may be concave, and the sensor-side fourteenth surface S14 may be concave. The seventh lens 137 may be made of glass and have aspherical surfaces on both sides, and may be a second aspherical lens. The thirteenth surface S13 and the fourteenth surface S14 have aspherical surfaces, and aspherical coefficients may be provided as L7S1 and L7S2 of FIG. 37.

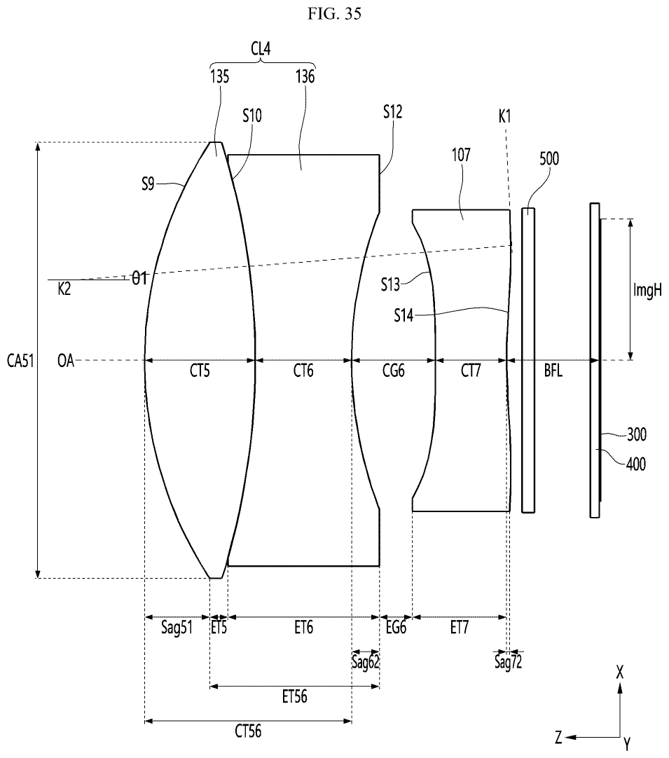

Referring to FIG. 35, at least one of the thirteenth surface S13 and the fourteenth surface S14 of the seventh lens 137 may have a critical point. The distance between the center of the sensor-side fourteenth surface S14 of the seventh lens 137 and the straight line perpendicular to the center of the sensor-side surface of the seventh lens 137 from the center of the fourteenth surface S14 to the edge of the sensor-side fourteenth surface S14 may gradually increase and then decrease. The sensor-side surface of the seventh lens 147 has a critical point. The critical point of the sensor-side surface of the seventh lens 147 may be arranged between a point of 3.2 mm and a point of 4 mm in a direction perpendicular to the optical axis based on the optical axis. When expressed as an absolute value for the Sag value, the maximum value of Sag51 may be greater than the maximum values of Sag52, Sag62, Sag71, and Sag72.

The maximum tangent angle θ1 on the fourteenth surface S14 in the first direction X may be 40 degrees or less, for example, in the range of 5 degrees to 40 degrees or in the range of 5 degrees to 20 degrees, based on an axis parallel to the optical axis. The maximum tangent angle on the thirteenth surface S13 in the first direction X may be 5 degrees or more, for example, in the range of 5 degrees to 40 degrees or in the range of 5 degrees to 30 degrees, based on an axis parallel to the optical axis. The seventh lens 137 may have a small inclination angle between the thirteenth surface S13 and the fourteenth surface S14 and an effective diameter of 90% or more, for example, in the range of 90% to 99% of the diagonal length of the image sensor 300. Therefore, light refracted from the seventh lens 137 may be refracted to the entire region of the image sensor 300.

As shown in FIGS. 34 to 36, when the radius of curvature of each lens is expressed as an absolute value on the optical axis, the radius of curvature of the third surface S3 of the second lens 132 on the optical axis OA may be the largest among the lenses, and the radius of curvature of the fifth surface S5 of the third lens 133, the ninth surface S9 of the fifth lens 135, or the twelfth surface S12 of the sixth lens 136 may be the smallest among the lenses. Preferably, the radius of curvature of the ninth surface S9 of the fifth lens 135 may be the smallest. The difference between the maximum radius of curvature and the minimum radius of curvature may be 5 times or more, for example, 5 to 30 times. The radius of curvature of the third lens 133, which is an aspherical lens, may be smaller than the radii of curvature of the first, second, and fourth lenses 131, 132, and 134 made of glass. Here, the radius of curvature is the average of the absolute values of the radius of curvature of the object-side surface and the sensor-side surface of each lens. When expressed as an absolute value, the radius of curvature of the first lens 131 disposed on the object-side of the aperture stop ST in the optical axis may be smaller than the radius of curvature of the second lens 132 disposed on the sensor-side of the aperture stop ST. When expressed as an absolute value, the radius of curvature of the seventh lens 137 in the optical axis may be larger than the radius of curvature of the sixth lens 136. The radius of curvature of the seventh lens 137 may be larger than the radius of curvature of the fifth and sixth lenses 135 and 136.

When expressed as an absolute value, the difference in the radius of curvature between the object-side surface and the sensor-side surface of the seventh lens 137 may be greater than the difference in the radius of curvature between the object-side surface and the sensor-side surface of the sixth lens 136, and may be greater than the difference in the radius of curvature between the object-side surface and the sensor-side surface of the fifth lens 135.

If the third lens 133 is designed as an aspherical surface, it may satisfy thermal compensation and improve optical performance, but may not be as easy to assemble as a spherical lens, and the optical characteristics of lenses arranged on the sensor side may be affected more than the third lens 133 due to the assemblability of the aspherical third lens 133. If the third lens is a spherical lens, even if the optical characteristics of the third lens are affected, the radius of curvature of the third lens on the optical axis may not be significantly changed due to the spherical characteristics. The invention is designed so that the radius of curvature of the third lens 133 having an aspherical surface is less than 35 mm and the effective diameter is large, so that assembly may be facilitated, and also, when the radius of curvature is large on the optical axis, the shape of the lens is formed gently, so that even if it is assembled with a slight tilt from the optical axis, the influence on the lenses on the sensor side may be minimal.

In addition, among the first to fourth lenses 131-134, the first lens 131 having a spherical surface is arranged on the object side of the aperture stop ST and is the lens most sensitive to optical characteristics, so the radius of curvature of the first lens 131 is made larger than that of the third lens, and the thickness of the first lens 132 is provided as thick as possible. The radius of curvature of each lens may satisfy at least one of the following conditions.

$$Condition 1 : 0 < \vert L 1 R 1 / L 1 R 2 \vert < 1 ,$$

$$Condition 2 : 1 < \vert L 2 R 1 / L 2 R 2 \vert < 5$$

$$Condition 3 : 0.1 < L 3 R 1 / L 3 R 2 < 1.2 ,$$

$$Condition 4 : 0 < \vert L 4 R 1 / L 4 R 2 \vert < 1$$

$$Condition 5 : 0.1 < \vert L 5 R 1 / L 5 R 2 \vert < 1.2 ,$$

$$Condition 6 : 1 < \vert L 6 R 1 / L 6 R 2 \vert < 3$$

$$Condition 7 : 2 < \vert L 7 R 1 / L 7 R 2 \vert < 7 ,$$

$$Condition 8 : 3 mm \leq \vert L 3 R 2 - L 3 R 1 \vert \leq 15 mm$$

$$Condition 9 : 30 mm < \vert L 7 R 1 \vert - L 7 R 2$$

When the difference between the object-side curvature radius and the sensor-side curvature radius of the third lens 133 is provided within the above range, the assembling performance of the third lens 133 having an aspherical surface may be improved and the optical influence caused by the third lens 133 may be reduced. Also, if the absolute value of the curvature radius of the object-side surface of the i-th lens is LiR1 and the absolute value of the curvature radius of the sensor-side surface is LiR2, the value of LiR1/LiR2 (i=1˜7) may be minimum when i is 1 and maximum when i is 7.

Also, the difference in curvature radius between the adjacent spherical lens surface and the aspherical lens surface may satisfy the following conditions.

$$Condition 10 : 4 < \vert L 2 R 2 \vert / L 3 R 1 < 7 ,$$

$$Condition 11 : 4 < \vert L 7 R 1 \vert / L 6 R 2 < 7$$

The difference in curvature radius between the spherical lens surface and the aspherical lens surface is set to 80 mm or less, for example, in the range of 10 mm to 80 mm, so that chromatic aberration due to the aspherical lens surface may be corrected.

When explaining the thickness of the lenses, the center thickness CT1 of the first lens 131 may be greater than the center thicknesses CT2-CT7 of the second to seventh lenses 132-137, and may have the maximum thickness within the lens portion 100C. The center thickness CT2 of the second lens 132 may be less than the center thicknesses CT3-CT7 of the third to seventh lenses 133-137, and may preferably have the minimum thickness within the lens portion 100C. The aspherical lens may include the third lens 133 and the seventh lens 137. The center thickness CT1 of the first lens 131 may be greater than 100% of the center thickness CT56 of the cemented lens CL4, and may be, for example, in the range of 101% to 150%. The thickness of each lens may satisfy at least one of the following conditions.

$$Condition 1 : 0.6 < CT 1 / ET 1 < 1.3 ,$$

$$Condition 2 : 1 < CT 2 / ET 2 < 2.7$$

$$Condition 3 : 0.8 < CT 3 / ET 3 < 2 ,$$

$$Condition 4 : 1 < CT 4 / ET 4 < 5$$

$$Condition 5 : 2 < CT 5 / ET 5 < 6 ,$$

$$Condition 6 : 0 < CT 6 / ET 6 < 1$$

$$Condition 7 : 0.3 < CT 7 / ET 7 < 1.2 ,$$

$$Condition 8 : 0.8 < \sum CT / \sum ET < 1.2 or 1 < \sum CT / \sum ΕΤ < 1.2$$

$$Condition 9 : 0.24 < CT 1 / \sum CT < 0.44$$

In the conditions, when CTi/ETi (i=1˜7) is present, it may be maximum when i is 5 and minimum when i is 6. This makes it possible to design a slim optical system by increasing the center thickness and edge thickness of the cemented lens CL4. The difference between the center thickness and the edge thickness of each lens may be set to more than 0.6 mm and less than 4 mm. This makes it possible to effectively guide light without increasing the difference between the center thickness and the edge thickness of each lens by arranging the aspherical lens on the third and seventh lenses 133 and 137. In addition, by setting the center thickness and the edge thickness difference of the third lens 133 to the range of Condition 3, the difference in the radius of curvature between the object-side surface and the sensor-side surface may be designed not to be large, and the assembling property of the aspherical third lens 133 may be improved and the influence on the optical characteristics may be reduced.

In addition, the difference between the maximum center thickness and the minimum center thickness in the lenses may be 3 mm or more, for example, in the range of 3 mm to 8 mm or 3 mm to 7.5 mm. That is, even if the center thickness of the last aspherical lens is provided thinly, the optical performance may not be degraded, and the thickness of the camera module may be provided slimly. In addition, since the difference between the center thickness and the edge thickness of each lens is not large, even if at least one lens is tilted, the influence on the optical characteristics may be reduced. In addition, the influence on the thermal characteristics between the center and edge parts of the lenses may be reduced. The maximum center thickness may be greater than the sum of the center thicknesses of the two adjacent lenses.

The center distance CG3 between the third lens 133 and the fourth lens 134 is the center distance between the aspherical lens and the spherical lens, is the maximum within the lens portion 100C, and is greater than the center distance between the spherical lenses. That is, the distance CG3 between the adjacent object-side aspherical lens and the sensor-side spherical lens may be the maximum within the lens portion 100C, and may be less than the center thickness of the cemented lens CL4, for example, 68% or less of the center thickness of the cemented lens CL4, for example, in the range of 48% to 68%. The center distance CG6 between the sixth lens 136 and the seventh lens 137 may be smaller than the center distance CG3 and the second largest within the lens portion 100C. That is, the distance CG6 between the adjacent object-side spherical lens and the sensor-side aspherical lens may satisfy the following condition: CT7<CG6<CG3<CT1. The distance between the center thickness of each lens and the center distance between the adjacent lenses may satisfy the following conditions (Here, the distance within the cemented lens is excluded).

$$Condition 1 : 10 < CT 1 / CG 1 < 30 ,$$

$$Condition 2 : 0.4 < CG 6 / CT 7 < 1.5$$

$$Condition 3 : 0.5 < CG 3 / CT 3 < 2 ,$$

$$Condition 4 : ( CG 6 / CT 6 ) < ( CG 3 / CT 3 )$$

$$Condition 5 : 0.2 < CG 3 / \sum CG < 0.7 ,$$

$$Condition 6 : 1.5 < CT 1 / CG 3 < 3.2$$

By providing the maximum center thickness between the lenses to be more than 1.5 times the maximum center distance, for example, in the range of 1.8 to 3 times, it is possible to provide a camera module that applies an aspherical lens within the optical system without increasing the center distance compared to the center thickness of each lens. In condition 3, since the aspherical third lens 133 is provided in a convex meniscus shape toward the object side, the distance between the third and fourth lenses 134 and 135 may be provided greatly.

Here, if the i-th center distance between the adjacent two lenses is defined as CGi, and the center thickness of the i-th lens positioned closer to the object side than CGi is defined as CTi, the following condition may be satisfied (here, the distance between the cemented lens and the cemented lens is excluded). The ratio of CTi/CGi may be maximum when i is 1, and minimum when i is 3. The reason why the value of CTi/CGi is minimum when i is 3 may be implemented by the third lens 133 made of aspherical glass material.

If the optical axis distance from the center of the object-side surface of the first lens 131 to the surface of the image sensor 300 is TTL, the following condition may be satisfied.

$$Condition 1 : 0.1 < CT 1 / TTL < 0.5$$

Preferably, Condition 1 may satisfy: 0.15≤CT1/TTL≤0.3. Since the first lens 131 is made of a glass material of a spherical lens, an optical system may be designed that may satisfy thermal compensation according to temperature change by the thickness of the first lens 131 that satisfies Condition 1. That is, Condition 1 may be a feature that appears by designing the first lens 131 as a spherical glass.

$$Condition 2 : 0 < CT 2 / TTL < 0.2 ,$$

$$Condition 3 : 0 < CT 3 / TTL < 0.2$$

$$Condition 4 : 0 < CT 4 / TTL < 0.2 ,$$

$$Condition 5 : 0 < CT 5 / TTL < 0.4$$

$$Condition 6 : 0 < CT 6 / TTL < 0.2 ,$$

$$Condition 7 : 0 < CT 7 / TTL < 0.2$$

The ratio of CT1/TTL of Condition 1 may be greater than the values of Conditions 2 to 7, and may be minimum when i is 2 in the ratio of CTi/TTL (i=1 to 7).

Regarding the effective diameter, the lens having the maximum effective diameter may be the fourth lens 134. The seventh surface S7 of the fourth lens 134 may be a lens surface having the maximum effective diameter. The lens having the minimum effective diameter may be the lens closest to the image sensor 300, and may be, for example, the seventh lens 137. The fourth lens 134 having the maximum effective diameter may be disposed between the third lens 133 and the fifth lens 135, and may be arranged on the sensor side of the third gap CG3 having the maximum distance. The lens surface having the minimum effective diameter may be the thirteenth surface S13 of the seventh lens 137. That is, the object-side lens or the sensor-side lens forming the maximum center distance may have the maximum effective diameter.

The effective diameter of each lens may satisfy at least one of the following conditions.

$$Condition 1 : CA 21 < CA 11 < CA 22 ,$$

$$Condition 2 : CA 71 < CA 72 < CA 62$$

$$Condition 3 : CA 32 < CA 42 < CA 41 ,$$

$$Condition 4 : ( CA 11 - CA 12 ) < ( CA 61 - CA 62 )$$

$$Condition 5 : ( 2 * ImgH ) < CA 1 < CA 2 < CA 3 < CA 4 ,$$

$$Condition 6 : CA 4 > CA 5 > CA 6 > ( 2 * ImgH ) > CA 7$$

As in Condition 1, even if the effective diameter of the first lens 131 is provided smaller than that of the second lens 132, the heat compensation may be more effective and the assemblability may be improved due to the spherical glass material and thick thickness.

In terms of the refractive index, at least one of the first and third lenses 131 and 133 has the maximum refractive index among the lenses, and preferably, the refractive index of the first lens 131 may be the maximum and may be 1.72 or more. The difference in refractive index of the first and third lenses 131 and 133 is 0.10 or less. The refractive index of the fourth lens 134 is the minimum among the lenses. The difference between the maximum refractive index and the minimum refractive index may be 0.15 or more. By adjusting the refractive indices of the spherical lens and the aspherical lens, the incident efficiency may be increased, and the incident light may be guided to the image sensor 300.

In terms of the Abbe number, the Abbe number of the fourth lens 134 is the maximum among the lenses, and may be 65 or more. The Abbe number of the first lens 131 is the minimum among the lenses. The difference between the maximum refractive index and the minimum Abbe number may be 30 or more. By making the Abbe number of the object-side lens based on the aperture stop ST small, the Abbe number of the sensor-side lens based on the aperture stop ST large, and providing the Abbe number of the aspherical seventh lens 137 closest to the image sensor 300 small, the color dispersion of light traveling between the lenses made of glass may be controlled, and the color dispersion between the spherical lens and the aspherical lens may be increased and guided to the image sensor 300.

If the average effective diameter of the spherical lens is GL_CA_Aver and the average effective diameter of the aspherical lens is GM_CA_Aver, the following condition may satisfy: GM_CA_Aver<GL_CA_Aver. If the average of the center thickness of the spherical lens is GL_CT_Aver and the average of the center thickness of the aspherical lens is GM_CT_Aver, the following condition may satisfy: GM_CT_Aver<GL_CT_Aver. If the average refractive index of a spherical lens is GL_nd_Aver and the average refractive index of an aspherical lens is GM_nd_Aver, the following condition may satisfy: GL_nd_Aver<GM_nd_Aver. If the average Abbe number of a spherical lens is GL_Ad_Aver and the average Abbe number of an aspherical lens is GM_Ad_Aver, the following condition may satisfy: GM_Ad_Aver<GL_Ad_Aver.

The focal lengths F1, F6, and F7 of the first, sixth, and seventh lenses 131, 136, and 137 may have negative refractive power, and the focal lengths F2, F3, F4, and F5 of the second, third, fourth, and fifth lenses 132, 133, 134, and 135 may have positive refractive power. In addition, the fifth and sixth lenses 135 and 136, which are adjacently arranged lenses, may satisfy the following conditions.
Condition 1: Refractive index of lens with positive refractive power<Refractive index of lens with negative refractive power
Condition 2: Dispersion of lens with positive refractive power>Dispersion of lens with negative refractive power

Here, the fifth lens 135 has positive refractive power and the sixth lens 136 has negative refractive power, and like conditions 1 and 2, the refractive index of the fifth lens 135 is smaller than the refractive index of the sixth lens 136, and the dispersion value of the fifth lens 135 is larger than the dispersion value of the sixth lens 136. Accordingly, the chromatic aberration occurring in the spherical lens may be corrected by the aspherical lens. In addition, the refractive index difference between the fifth and sixth lenses 135 and 136 arranged sequentially may be satisfied to be 0.01 or more and 0.15 or less and the Abbe number difference to be 20 or more and 60 or less. The optical system 1000 generates chromatic aberration and corrects the chromatic aberration by using a cemented lens CL4 or two lenses arranged in series. The lens contracts and expands repeatedly as the temperature changes from low to high. Since the lens characteristics of the same material change the same amount according to the temperature change, it is effective to correct the chromatic aberration between the lenses of the same material even when the temperature changes.

In addition, the chromatic aberration occurring in the spherical lens may be corrected by using the third lens 133 and the seventh lens 137, and the chromatic aberration between the spherical lens and the aspherical lens may be mutually corrected by using the sixth lens 136 and the seventh lens 137. In addition, by arranging the glass lenses having a relatively high Abbe number of the fifth lens 135 of the cemented lens CL4 disposed on the object side of the aspherical seventh lens 137, the chromatic dispersion by the glass lenses may be reduced and the chromatic dispersion by the aspherical lenses may be increased.

When the focal length is expressed as an absolute value, the focal length of the second lens 132 is the largest among the lenses and may be 60 or more. The focal length of the sixth lens 136 is the smallest among the lenses. The difference between the maximum focal length and the minimum focal length may be 35 or more. By providing the focal length of the second lens 133 adjacent to the aspherical lens as the largest and the focal length of the sixth lens 136 adjacent to the last aspherical lens as the smallest, the optical system may have improved MTF characteristics, aberration control characteristics, resolution characteristics, etc. in the set FOV range, and may have good optical performance in the periphery portion of the FOV.

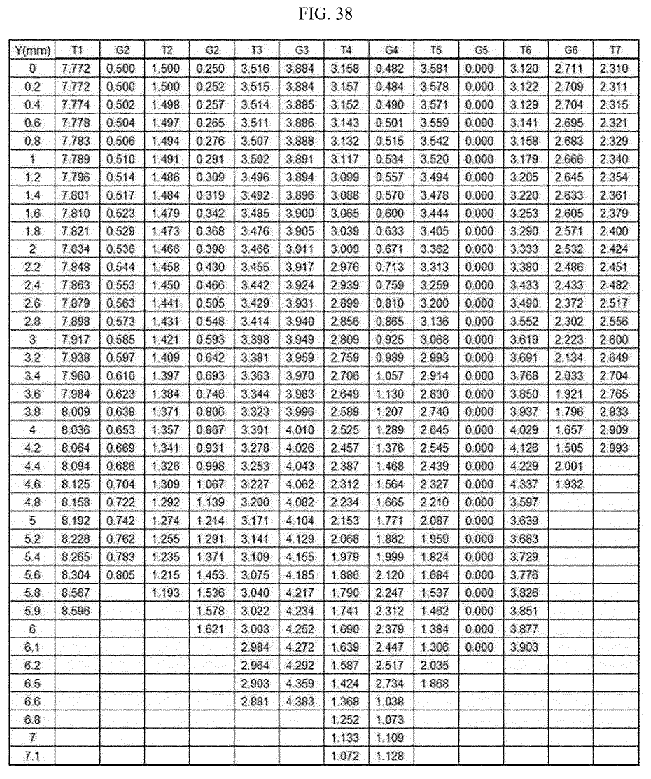

As shown in FIG. 37, among the lenses of the lens portion 100C in the embodiment, the lens surfaces of the third and seventh lenses 133 and 137 may include aspherical surfaces having a 30th aspherical coefficient. For example, the third and seventh lenses 133 and 137 may include lens surfaces having a 30th aspherical coefficient. As shown in FIG. 38, the thickness of each lens T1-T7 in the Y-axis direction may be expressed at intervals of 0.1 mm or 0.2 mm or more, and the interval between each lens G1-G6 may be expressed at intervals of 0.1 mm or 0.2 mm or more.

The center thickness CT56 of the cemented lens CL4 may be greater than the edge thickness ET56. The center thickness CT56 of the cemented lens CL4 is the distance from the center of the object-side ninth surface S9 of the fifth lens 135 to the center of the twelfth surface S12 of the sixth lens 136, and the edge thickness ET56 is the distance from the end of the effective region of the ninth surface S9 to the twelfth surface S12 in the optical axis direction. The maximum thickness of the cemented lens CL4 is at the center, the minimum thickness is at the edge, and the maximum thickness may be 1 time or more of the minimum thickness, for example, 1 to 1.5 times. The cemented lens CL4 may satisfy the following condition: 0 mm<CT56-ET56<2 mm.

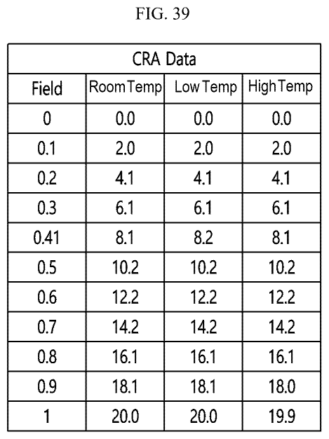

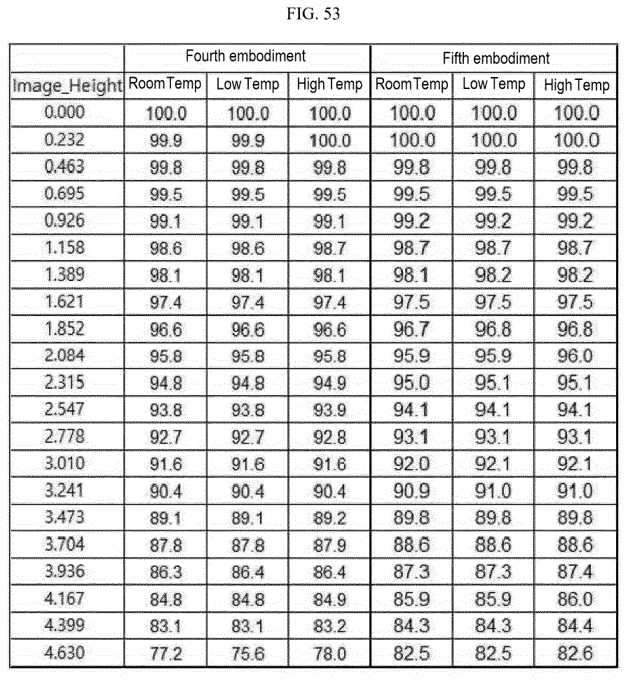

As shown in FIG. 39, in the optical system and camera module of FIG. 34, the angle of the CRA may be 10 degrees or more, for example, 10 to 35 degrees, or 10 to 25 degrees. As shown in FIG. 53, in the optical system according to the fourth embodiment, a table showing the relative illumination or the ambient light ratio from the center of the image sensor to the image height, that is, from 0 to 4.630 mm, may be seen that the ambient light ratio from the center of the image sensor to the diagonal end is 70% or more, for example, 75% or more. That is, it may be seen that the difference in the ambient illuminance according to the low temperature, room temperature, and high temperature is almost the same up to 4.399 mm from the optical axis.

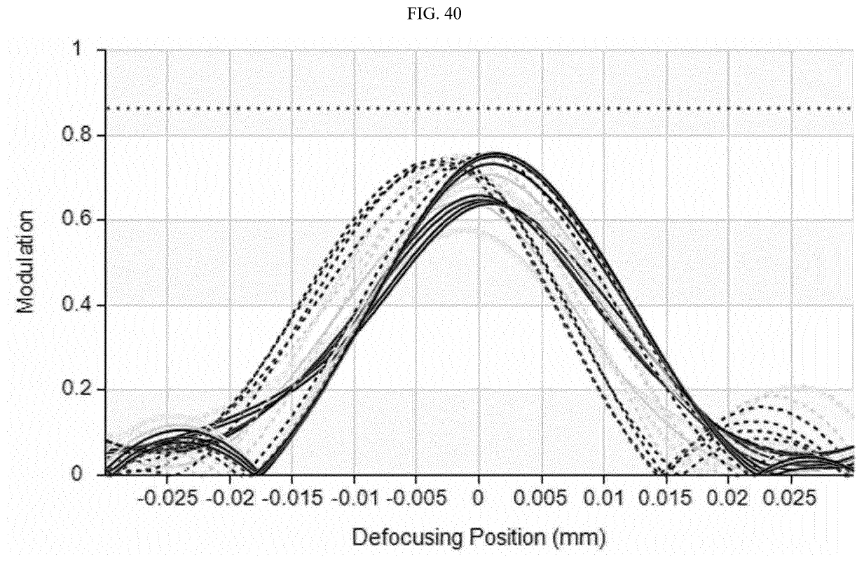

FIGS. 40 to 42 are graphs showing the diffraction MTF at room temperature, low temperature, and high temperature in the optical system of FIG. 34, and are graphs showing the modulation according to the spatial frequency. As shown in FIGS. 40 to 42, in the embodiment of the invention, the deviation of the MTF with respect to the low temperature or high temperature based on the room temperature may be less than 10%, that is, 7% or less.

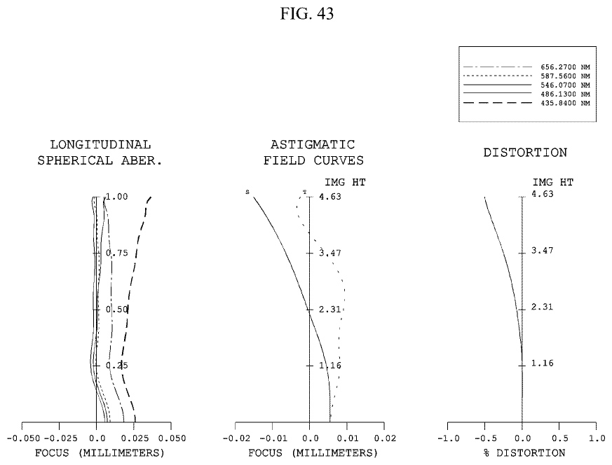

FIGS. 43 to 45 are graphs showing the aberration characteristics at room temperature, low temperature, and high temperature in the optical system of FIG. 34. The graphs of the aberration graphs of FIGS. 43 to 45 are graphs measuring spherical aberration (Longitudinal Spherical Aberration), astigmatic field curves, and distortion from the left to the right. In FIGS. 43 to 45, the X-axis may represent a focal length (mm) and a distortion degree (%), and the Y-axis may represent the height of the image. In addition, the graph for spherical aberration is a graph for light having a wavelength band of about 435 nm, about 486 nm, about 546 nm, about 587 nm, and about 656 nm, and the graph for astigmatism and distortion aberration is a graph for light having a wavelength band of about 546 nm. In the aberration diagrams of FIGS. 43 to 45, it may be interpreted that the closer the respective curves at room temperature, low temperature, and high temperature are to the Y-axis, the better the aberration correction function is. It may be seen that in the optical system 1000 according to the embodiment, the measured values are close to the Y-axis in almost all areas. That is, the optical system 1000 according to the embodiment has improved resolution and may have good optical performance not only in the center portion of the FOV but also in the periphery portion. Here, the low temperature is −20 degrees or less, for example, −20 to −40 degrees, the room temperature is 22 degrees±5 degrees or 18 to 27 degrees, and the high temperature may be 85 degrees or more, for example, 85 to 105 degrees. Accordingly, it may be seen that the reduction in the modulation from the low temperature to the high temperature in FIGS. 43 to 45 is less than 10%, for example, 5% or less, or is almost unchanged.

Table 1 compares the changes in optical characteristics such as EFL, BFL, F number, TTL, and FOV at room temperature, low temperature, and high temperature in the optical system according to the embodiment, and it may be seen that the change rate of the optical characteristics at low temperature is 5% or less, for example, 3% or less, based on room temperature, and it may be seen that the change rate of the optical characteristics at low temperature is 5% or less, for example, 3% or less, based on room temperature.

TABLE 3

| | | | | Low | High |
|---|---|---|---|---|---|
| | Room | Low | High | temperature/Room | temperature/Room |
| | temperature | temperature | temperature | temperature | temperature |
| EFL(F) | 15.1 | 15.1 | 15.1 | 99.90% | 100.14% |
| BFL | 3.04 | 3.04 | 3.04 | 99.88% | 100.14% |
| F# | 1.6 | 1.6 | 1.6 | 99.89% | 100.14% |
| TTL | 35.8 | 35.8 | 35.9 | 99.92% | 100.10% |
| FOV | 34.2 | 34.3 | 34.2 | 100.11% | 99.86% |

Therefore, as shown in Table 3, the change in optical characteristics according to the temperature change from low temperature to high temperature, for example, the change rate of EFL, TTL, BFL, F number, and diagonal FOV is 10% or less, that is, 5% or less, for example, 0 to 5%. This design enables temperature compensation for aspherical lenses even when at least one or two or more aspherical lenses are used, thereby preventing a decrease in reliability of optical characteristics. The optical system of the embodiment disclosed above can effectively control aberration characteristics such as chromatic aberration and distortion aberration, and may have good optical performance not only at the center portion but also at the periphery portion of the FOV.

The optical system according to the fifth embodiment of the invention will be described with reference to FIGS. 46 to 62. In describing the fifth embodiment, a different configuration from the fourth embodiment will be described, and the same configuration will be referred to the first to fourth embodiments.

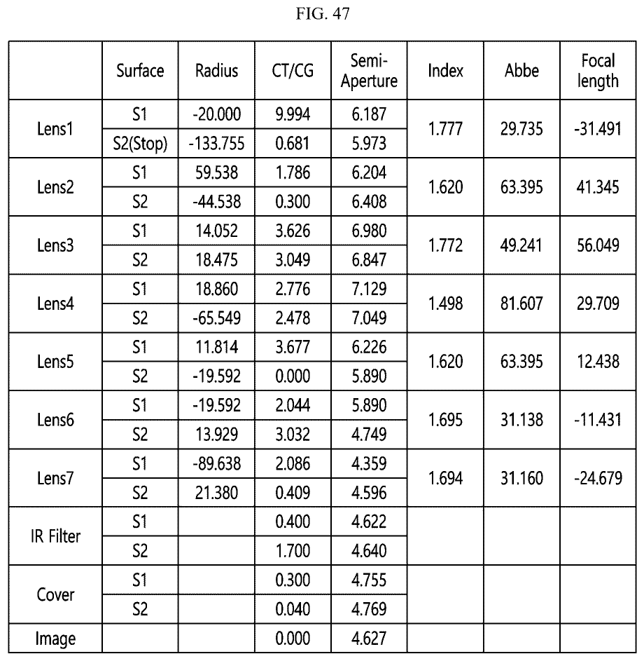

Referring to FIGS. 46 and 47, the lens portion 100D of the optical system 1000 according to the fifth embodiment may include the first lens 141 to the seventh lens 147. The first lens 141 may be a first lens group LG1, and the second to seventh lenses 142, 143, 144, 145, 146, and 147 may be a second lens group LG2.

The first lens 141 may have a negative (−) refractive power on the optical axis OA. The first lens 141 may be made of glass or a glass non-mold material. The object-side first surface S1 of the first lens 141 on the optical axis may be concave, and the sensor-side second surface S2 may be convex. The first lens 141 may be provided with a glass material having the thickest thickness, so that the rigidity may be prevented from being reduced due to external impact, and the optical performance may be maintained constant when the temperature changes to low or high temperature due to the glass material. In addition, since the spherical surface is applied to the glass material, even if the lens is designed to be thick, the refractive index of light does not change significantly.

The thickness of the first lens 141 may be thicker than the thickness of the cemented lens CL5. The center thickness of the first lens 141 may be thicker than the center thickness of the cemented lens CL5. The edge thickness of the first lens 141 may be thicker than the edge thickness of the cemented lens CL5. The aperture stop ST may be arranged on the periphery of the sensor-side surface of the first lens 141. In contrast, the aperture stop ST may be arranged around the object-side or sensor-side surface of the second lens 142, or around the object-side surface of the third lens 143.

The second lens 142 may have positive (+) refractive power on the optical axis OA. The second lens 142 may be provided with a glass material. The object-side third surface S3 of the second lens 142 on the optical axis OA may be convex, and the sensor-side fourth surface S4 may be convex. The second lens 142 may have a shape in which both sides are convex in the optical axis. The second lens 142 may be provided with a spherical lens made of glass. The third surface S3 and the fourth surface S4 may be spherical.

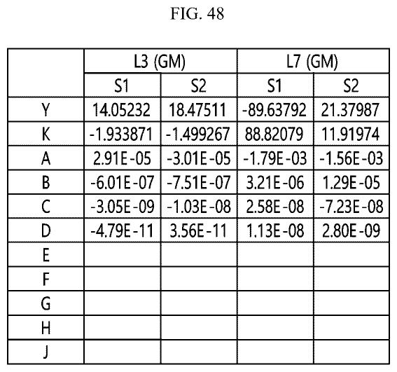

The third lens 143 may have a positive (+) refractive power on the optical axis OA. The third lens 143 may be provided with a glass material or a glass mold material. The object-side fifth surface S5 of the third lens 143 on the optical axis may be convex, and the sensor-side sixth surface S6 may be concave. The third lens 143 may be provided with an aspherical lens made of glass. The fifth surface S5 and the sixth surface S6 may be aspherical, and the aspherical coefficients may be provided as L3S1 and L3S2 of FIG. 48.

The fourth lens 144 may have a positive (+) refractive power on the optical axis OA. The fourth lens 144 may be provided with a glass material. The object-side seventh surface S7 of the fourth lens 144 on the optical axis may be convex, and the sensor-side eighth surface S8 may be convex. The fourth lens 144 may be provided as a spherical lens made of glass. The effective diameter of the fourth lens 144 may have the largest effective diameter within the lens portion 100D. The effective diameter of the fourth lens 144 may have the largest effective diameter among the spherical lens and the aspherical lens.

The fifth lens 145 may have positive (+) refractive power on the optical axis OA. The fifth lens 145 may be provided as a glass material. The object-side ninth surface S9 of the fifth lens 145 on the optical axis OA may be convex, and the sensor-side tenth surface S10 may be convex. The fifth lens 145 may have a shape in which both sides are convex on the optical axis OA. The fifth lens 145 may be a spherical lens. The ninth surface S9 and the tenth surface S10 of the fifth lens 145 may be spherical. The sixth lens 146 may have negative (−) refractive power on the optical axis OA. The sixth lens 146 may be provided with a glass material. The eleventh surface of the sixth lens 146 on the object side may be concave on the optical axis OA, and the twelfth surface S12 on the sensor side may be concave.

The fifth lens 145 and the sixth lens 146 may be bonded or joined, and may be defined as a cemented lens CL5. The fifth and sixth lenses 145 and 146 may have opposite refractive powers. The composite refractive power of the fifth and sixth lenses 145 and 146 may have positive refractive power. The product of the refractive power of the fifth lens 145 on the object side of the cemented lens CL5 and the refractive power or focal length of the sixth lens 146 on the sensor side may be less than 0. Accordingly, the aberration characteristics of the optical system may be improved. If the signs of the refractive powers of the two lenses of the cemented lens CL5 are the same, there is a limit to the improvement of aberration.

The composite refractive power of the cemented lens CL5 may have positive refractive power, and the fourth lens 144 disposed on the object side based on the cemented lens CL5 may have positive refractive power, and the seventh lens 147 disposed on the sensor side may have negative refractive power. Accordingly, the fourth lens 144, the cemented lens CL5, and the seventh lens 147 may refract some of the incident light in the direction of the optical axis. The effective diameter of the above-described joining lens CL5 may be larger than the diagonal length of the image sensor 300. The effective diameter of the fifth lens 145 is an average of the effective diameters of the ninth surface S9 and the tenth surface S10, and each of the effective diameters of the ninth surface S9 and the tenth surface S10 may be larger than the diagonal length of the image sensor 300. The effective diameter of the sixth lens 146 may be smaller than the effective diameter of the fifth lens 145 and larger than the diagonal length of the image sensor 300. The effective diameter of the seventh surface S7 of the fourth lens 144 may be larger than the diagonal length of the image sensor 300, and the effective diameter of the twelfth surface S12 of the sixth lens 146 may be smaller than the diagonal length of the image sensor 300. The difference in effective diameter between the object-side eleventh surface and the sensor-side twelfth surface S12 of the sixth lens 146 may be the largest within the lens portion 100D. Accordingly, the difference in effective diameter between the object-side surface and the sensor-side surface of the sixth lens 146 may be maximized, thereby guiding light to the effective region of an aspherical lens having a relatively small effective diameter. Accordingly, a slimmer optical system may be provided. The effective diameter of the sixth lens 146 may satisfy the following condition: 1.10<CA61/CA62<1.50.

The seventh lens 147 may have a negative (−) refractive power on the optical axis OA. The seventh lens 147 may be made of glass or a glass mold material. The thirteenth surface S13 on the object side of the seventh lens 147 in the optical axis may be concave, and the fourteenth surface S14 on the sensor side may be concave. The seventh lens 147 may have a shape in which both sides are concave on the optical axis. The seventh lens 147 may be made of glass and may have aspherical surfaces on both sides. The thirteenth surface S13 and the fourteenth surface S14 may have aspherical surfaces, and aspherical coefficients may be provided as L7S1 and L7S2 of FIG. 48.

FIG. 47 is an example of lens data of the optical system of the embodiment of FIG. 46. As shown in FIG. 47, when the radius of curvature of each lens is expressed as an absolute value on the optical axis, the radius of curvature of the second surface S2 of the first lens 141 on the optical axis OA may be the largest among the lenses, and the radius of curvature of the ninth surface S9 of the fifth lens 145 or the twelfth surface S12 of the sixth lens 146 may be the smallest among the lenses. Preferably, the radius of curvature of the ninth surface S9 of the fifth lens 145 may be the smallest. The difference between the maximum radius of curvature and the minimum radius of curvature may be 5 times or more, for example, 5 to 30 times. The radius of curvature of the third lens 143, which is an aspherical lens, may be smaller than the radii of curvature of the first, second, and fourth lenses 141, 142, and 144 made of glass. Here, the radius of curvature is an average of the absolute values of the radii of curvature of the object-side surface and the sensor-side surface of each lens. When expressed as an absolute value, the curvature radius of the first lens 141 arranged on the object side of the aperture stop ST in the optical axis may be greater than the curvature radius of the second lens 142 arranged on the sensor side of the aperture stop ST.

When expressed as an absolute value, the curvature radius of the seventh lens 147 on the optical axis may be greater than the curvature radius of the sixth lens 146. The curvature radius of the seventh lens 147 may be greater than the curvature radii of the fifth and sixth lenses 145 and 146. When expressed as an absolute value, the difference in curvature radii between the object-side surface and the sensor-side surface of the seventh lens 147 may be greater than the difference in curvature radii between the object-side surface and the sensor-side surface of the sixth lens 146, and may be greater than the difference in curvature radii between the object-side surface and the sensor-side surface of the fifth lens 145.

The invention is designed so that the radius of curvature of the third lens 143 having an aspherical surface is less than 35 mm and the effective diameter is large, so that assembly may be facilitated, and also, when the radius of curvature is large on the optical axis, the shape of the lens is formed gently, so that even if it is assembled with a slight tilt from the optical axis, the influence on the lenses on the sensor side may be minimal. In addition, among the first to fourth lenses 141-144, the first lens 141 having a spherical surface is arranged on the object side of the aperture stop ST and is the lens most sensitive to optical characteristics, so the radius of curvature of the first lens 141 is made larger than the radii of curvature of the second and third lenses 142 and 143, and the thickness of the first lens 142 is provided as thickest.

Since the third lens 143 is provided as an aspherical surface, the curvature radius on the optical axis may not be increased, the difference in the curvature radius between the object-side surface and the sensor-side surface may not be greatly reduced, heat compensation may be possible by the glass material, the assemblability may be improved by the effective diameter, and the influence on the optical characteristics may be reduced. The curvature radius of the object-side surface of the seventh lens 147 may be larger than the curvature radius of the sensor-side surface of the sixth lens 146 made of glass. Accordingly, the seventh lens 147 may guide the light incident through the first to sixth lenses 141-146 to the entire region of the image sensor 300. When the curvature radius of the seventh lens 147 is made larger than the curvature radius of the sixth lens 146, the assemblability of the last aspherical lens may be improved and the change in the optical characteristics may be minimized.

The radius of curvature of the first lens 141 to the seventh lens 147 may satisfy at least one of the following conditions.

$$Condition 1 : 0 < \vert L 1 R 1 / L 1 R 2 \vert < 1 ,$$

$$Condition 2 : 0.5 < \vert L 2 R 1 / L 2 R 2 \vert < 3$$

$$Condition 3 : 0.2 < L 3 R 1 / L 3 R 2 < 1.5 ,$$

$$Condition 4 : 0 < \vert L 4 R 1 / L 4 R 2 \vert < 1$$

$$Condition 5 : 0.2 < \vert L 5 R 1 / L 5 R 2 \vert < 1.5 ,$$

$$Condition 6 : 0.8 < \vert L 6 R 1 / L 6 R 2 \vert < 2$$

$$Condition 7 : 2 < \vert L 7 R 1 / L 7 R 2 \vert < 7 ,$$

$$Condition 8 : 1 mm \leq \vert L 3 R 2 - L 3 R 1 \vert \leq 10 mm$$

$$Condition 9 : 30 mm < \vert L 7 R 1 \vert - L 7 R 2$$

If the difference between the object-side curvature radius and the sensor-side curvature radius of the third lens 143 is provided within the above range, the assembling performance of the third lens 143 having an aspherical surface may be improved and the optical influence caused by the third lens 143 may be reduced. In addition, if the absolute value of the object-side curvature radius of the i-th lens is LiR1 and the absolute value of the sensor-side curvature radius is LiR2, the value of LiR1/LiR2 (i=1˜7) may be minimum when i is 1 and maximum when i is 7. The center thickness CT1 of the first lens 141 may be more than 100% of the center thickness CT56 of the cemented lens CL5, for example, may be in the range of 101% to 150%. The center thickness CT1-CT7 and edge thickness ET1-ET7 of the first to seventh lenses 141-147, and the sum ΣCT of the center thicknesses and the sum ΣET of the edge thicknesses may satisfy at least one of the following conditions.

$$Condition 1 : 0.6 < CT 1 / ET 1 < 1.3 ,$$

$$Condition 2 : 1 < CT 2 / ET 2 < 2.7$$

$$Condition 3 : 0.8 < CT 3 / ET 3 < 2 ,$$

$$Condition 4 : 1 < CT 4 / ET 4 < 5$$

$$Condition 5 : 2 < CT 5 / ET 5 < 6 ,$$

$$Condition 6 : 0 < CT 6 / ET 6 < 1$$

$$Condition 7 : 0.3 < CT 7 / ET 7 < 1.2 ,$$

$$Condition 8 : 0.8 < \sum CT / \sum ET < 1.2 or 1 < \sum CT / \sum ΕΤ < 1.2$$

$$Condition 9 : 0.24 < CT 1 / \sum CT < 0.44$$

In the conditions, when CTi/ETi (i=1˜7) is present, it may be maximum when i is 5 and minimum when i is 6. This can design a slim optical system by increasing the center thickness and edge thickness of the cemented lens CL4. The maximum center thickness may be greater than the sum of the center thicknesses of two adjacent lenses. For example, the conditions may satisfy:

$$( CT 2 + CT 3 ) < CT 1 ,$$

$$( CT 3 + CT 4 ) < CT 1 ,$$

$$( CT 4 + CT 5 ) < CT 1 ,$$

$$( CT 5 + CT 6 ) < CT 1 , and$$

$$( CT 6 + CT 7 ) < CT 1.$$

The center distance CG3 between the third lens 143 and the fourth lens 144 is the center distance between the aspherical lens and the spherical lens, is the maximum within the lens portion 100D, and is larger than the center distance between the spherical lenses. It may be less than the center thickness of the cemented lens CL5, for example, 63% or less of the center thickness of the cemented lens CL5, for example, in the range of 43% to 63%. The center distance CG1-CG6 between the first to seventh lenses 141-147 and the sum ΣCG of the center distances may satisfy the following conditions (Here, the distance within the cemented lens is excluded).

$$Condition 1 : 10 < CT 1 / CG 1 < 30 ,$$

$$Condition 2 : 1 < CG 6 / CT 7 < 2$$

$$Condition 3 : 0.5 < CG 3 / CT 3 < 2 ,$$

$$Condition 4 : ( CG 6 / CT 6 ) < ( CG 3 / CT 3 )$$

$$Condition 5 : 0.2 < CG 3 / \sum CG < 0.7 ,$$

$$Condition 6 : 1.5 < CT 1 / CG 3 < 5$$

The maximum center thickness between the lenses is provided to be more than 1.5 times the maximum center distance, for example, in the range of 2 to 4 times, so that a camera module applying an aspherical lens within the optical system may be provided without increasing the center distance compared to the center thickness of each lens. In Condition 3, since the aspherical third lens 143 is provided in a meniscus shape convex toward the object side, the distance between the third and fourth lenses 144 and 145 may be provided greatly.

Here, if the i-th center distance between the two adjacent lenses is defined as CGi, and the center thickness of the i-th lens positioned closer to the object side than CGi is defined as CTi, the following conditions may be satisfied (here, the distance between the cemented lens and the cemented lens is excluded). The ratio of CTi/CGi is maximum when i is 1, and minimum when i is 6. The reason why the value of CTi/CGi is minimum when i is 6 may be implemented by the seventh lens 147 made of aspherical glass material.

If the optical axis distance from the center of the object-side surface of the first lens 141 to the surface of the image sensor 300 is TTL, the relationship between CT1 to CT7 and TTL will be referred to the description of the fourth embodiment. In the ratio of CTi/TTL (i=1˜7), it is maximum when i is 1, and minimum when i is 2.

Regarding the effective diameter, the lens having the maximum effective diameter may be the fourth lens 144. The seventh surface S7 of the fourth lens 144 may be the lens surface having the maximum effective diameter. The lens having the minimum effective diameter may be the lens closest to the image sensor 300, for example, the seventh lens 147. The lens surface having the minimum effective diameter may be the thirteenth surface S13 of the seventh lens 147. The effective diameters of the first lens 141 to the seventh lens 147 will be described with reference to the description of the fourth embodiment. The effective diameter of the sensor-side surface of the sixth lens 146 may be larger than the diagonal length of the image sensor 300.

$$Condition 1 : CA 71 < ( 2 * ImgH ) < CA 62 ,$$

$$Condition 2 : ( 2 * ImgH ) < CA 1 < CA 2 < CA 3 < CA 4$$

$$Condition 3 : CA 4 > CA 5 > CA 6 > ( 2 * ImgH ) > CA 7$$

The focal lengths F1, F6, and F7 of the first, sixth, and seventh lenses 141, 146, and 147 have negative refractive power, and the focal lengths F2, F3, F4, and F5 of the second, third, fourth, and fifth lenses 142, 143, 144, and 145 may have positive refractive power. By satisfying the refractive index difference of the fifth and sixth lenses 145 and 146 arranged sequentially to be 0.01 or more and 0.15 or less and the Abbe number difference to be 20 or more and 60 or less, the chromatic aberration occurring in the spherical lens may be compensated for by the cemented lens. By applying the third lens 143 and the seventh lens 147 as aspherical lenses, the chromatic aberration occurring in the spherical lens may be corrected, and the sixth lens 146 and the seventh lens 147 may be used to mutually correct the chromatic aberration between the spherical lens and the aspherical lens. By arranging glass lenses having a relatively high Abbe number of the fifth lens 145 of the cemented lens CL5 disposed on the object side of the aspherical seventh lens 147, the chromatic dispersion may be reduced by the glass lenses, and the chromatic dispersion may be increased by the aspherical lenses.

When the focal length is expressed as an absolute value, the focal length of the third lens 143 is the maximum among the lenses, and may be 42 or more. The focal length of the sixth lens 146 is the minimum among the lenses. The difference between the maximum focal length and the minimum focal length may be 20 or more. By making the focal length of the object-side aspherical third lens 143 the largest and providing the focal length of the sixth lens 146 adjacent to the last aspherical lens the smallest, the optical system may have improved MTF characteristics, aberration control characteristics, resolution characteristics, etc. in the set FOV range, and may have good optical performance in the periphery portion of the FOV.

The sensor-side surface of the seventh lens 147 has a critical point. It may be seen that the critical point exists between the point of 2.9 mm and the point of 3.7 mm in the direction perpendicular to the optical axis based on the center of the sensor-side surface of the seventh lens 147. If the critical point exists on the object surface of the seventh lens 147, the TTL may be reduced, making it easy to miniaturize and lighten the optical system. As another example, the sensor-side surface of the seventh lens 147 may have a critical point. Alternatively, the object-side surface and the sensor-side surface of the seventh lens 147 may be provided without a critical point. In terms of the absolute value of the Sag value, the maximum value of Sag51 may be greater than the maximum values of Sag52, Sag62, Sag71, and Sag72.

As shown in FIG. 48, among the lenses of the lens portion 100D in the embodiment, the lens surfaces of the third and seventh lenses 143 and 147 may include aspherical surfaces having a 30th aspherical coefficient. For example, the third and seventh lenses 143 and 147 may include lens surfaces having a 30th aspherical coefficient. As described above, since the aspherical surface having a 30th aspherical coefficient (a value other than “0”) can significantly change the aspherical shape of the peripheral portion, the optical performance of the peripheral portion of the FOV may be well compensated.

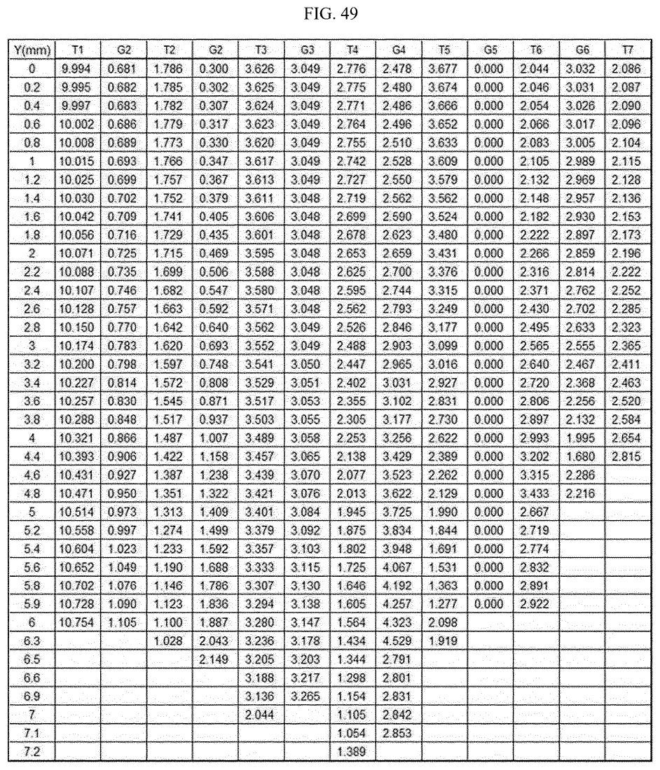

As shown in FIG. 49, the thicknesses T1-T7 of the first to seventh lenses 141, 142, 143, 144, 145, 146, and 147 and the distances G1-G6 between adjacent two lenses may be set. As shown in FIG. 38, the thickness T1-T7 of each lens in the Y-axis direction may be expressed at intervals of 0.1 mm or 0.2 mm or more, and the distances G1-G6 between each lens may be expressed at intervals of 0.1 mm or 0.2 mm or more. The thickness of each lens and the distance between adjacent lenses shall refer to the description of the fourth embodiment. In addition, the relationship between the center thickness CT56 and the edge thickness ET56 of the cemented lens CL5 shall refer to the description of the fourth embodiment.

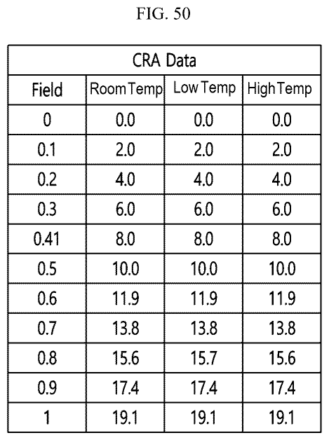

As shown in FIG. 50, the CRA of the optical system and camera module of FIG. 46 may be 10 degrees or more, for example, in a range of 10 to 35 degrees or 10 to 25 degrees. As shown in FIG. 53, in a table showing the relative illumination or the ambient light ratio from the center of the image sensor to the image height, that is, from 0 to 4.630 mm in the optical system according to the fifth embodiment, it may be seen that the ambient light ratio from the center of the image sensor to the diagonal end is 70% or more, for example, 75% or more. That is, it may be seen that the difference in the ambient illumination according to the low temperature, room temperature, and high temperature is almost the same up to 4.399 mm from the optical axis.

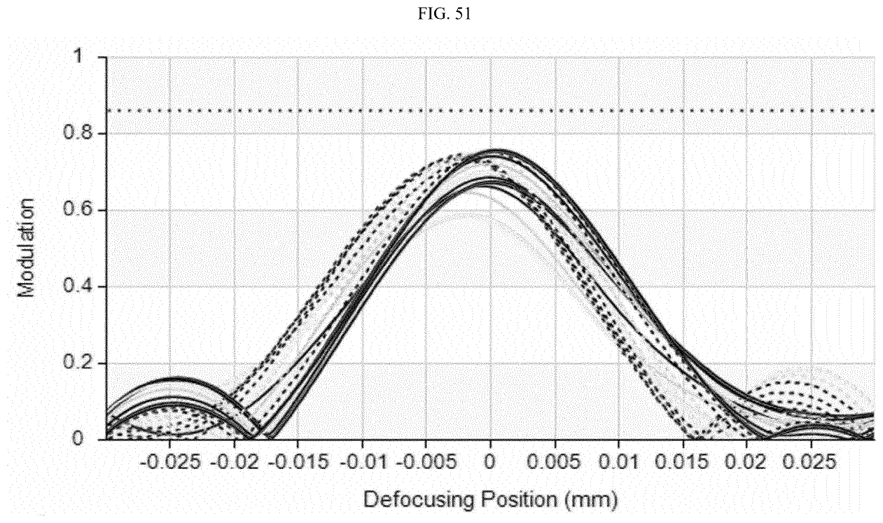

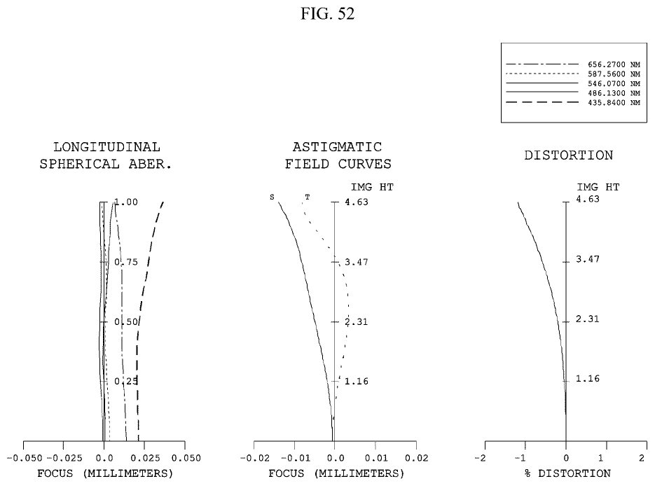

FIG. 51 is a graph showing a diffraction MTF at room temperature in the optical system of FIG. 46, and is a graph showing modulation according to spatial frequency. FIG. 52 is a graph showing aberration characteristics at room temperature in the optical system of FIG. 46. It is a graph measuring longitudinal spherical aberration (Longitudinal spherical aberration), astigmatic field curves, and distortion from left to right in the aberration graph of FIG. 52. The optical system 1000 according to the embodiment has improved resolution and may have good optical performance not only in the center portion but also in the periphery portion of the FOV. Here, the low temperature is −20 degrees or lower, for example, in the range of −20 to −40 degrees, the room temperature is in the range of 22 degrees±5 degrees or in the range of 18 degrees to 27 degrees, and the high temperature is 85 degrees or higher, for example, in the range of 85 degrees to 105 degrees. Accordingly, it may be seen that the reduction in the modulation from the low temperature to the high temperature of FIG. 43 to FIG. 45 is less than 10%, for example, less than 5%, or is almost unchanged.

The optical system of the first to fifth embodiments disclosed above can effectively control aberration characteristics such as chromatic aberration and distortion aberration, and may have good optical performance not only in the center portion of the FOV but also in the periphery portion.

The optical system 1000 according to the first to fifth embodiments disclosed above may satisfy at least one or two or more of the Equations described below. Accordingly, the optical system 1000 according to the embodiment may have improved optical characteristics. For example, when the optical system 1000 satisfies at least one Equation, the optical system 1000 can effectively control aberration characteristics such as chromatic aberration and distortion aberration, and may have good optical performance not only in the center portion of the FOV but also in the periphery portion. In addition, the optical system 1000 may have improved resolution. In addition, the thickness of the lens on the optical axis OA and the spacing of the adjacent lenses on the optical axis OA described in the Equations can refer to the above-described embodiments.

$$1 < CT 1 / CT 2 < 7 \qquad [ Equation l ]$$

In Equation 1, CT1 means the center thickness of the first lens 101-141, and CT2 means the thickness (mm) of the second lens 102-142 in the optical axis OA. Equation 1 sets the difference in the center thickness of the first and second lenses, thereby improving the chromatic aberration of the optical system. In Equation 1 In Equation 1, the first embodiment may satisfy: 3<CT1/CT2<4, the second and third embodiments may satisfy: 1<CT1/CT2<5 or 2<CT1/CT2<4, and the fourth embodiment may satisfy: 2<CT1/CT2<7 or 4<CT1/CT2<6. The center thickness of the first and second spherical lenses 101 and 102 may be set, so that the optical performance of the center and peripheral portions of the FOV may be improved.

$$( CT 7 * CA 7 ) < ( CT 1 * CA 1 ) \qquad [ Equation 2 ]$$

CT7 is the center thickness of the seventh lens 107-147, CA1 is the effective diameter of the first lens 101-141, and CA7 is the effective diameter of the seventh lens. The effective diameter is the average of the effective diameters of the object-side surface and the sensor-side surface of the first and seventh lenses. Preferably, the following conditions may satisfy: CT7<CT1 and CA7<CA1. Preferably, the following condition may satisfy: 2<(CT1*CA1)/(CT7*CA7)<7. By setting the thickness and effective diameter of the first and seventh lenses, the optical system can improve spherical aberration. In addition, heat compensation is possible by the center thickness and effective diameter of the first lens 101 made of glass by Equation 2, and the influence on optical characteristics may be reduced.

$$Po 1 < 0 \qquad [ Equation 3 ]$$

In Equation 3, Pol means the refractive power of the first lens 101-141, and may be set to have a short effective focal length F compared to TTL in the optical system for the performance of the optical system. Accordingly, TTL>F may be satisfied, and for example, TTL may be in the range of 1.5 times or more, for example, 1.5 to 3 times the effective focal length F.

$$1.7 < n 3 < 2.2 \qquad [ Equation 4 ]$$

The n3 is the refractive index of the d-line of the third lens 103-143. Equation 4 sets the refractive index of the third lens high, so that it can control the factor affecting the reduction of the third aberration (Seidel aberration) of the optical system, and can reduce the aberration that may occur as the TTL becomes somewhat longer. Equation 4 can preferably satisfy 1.72<n3<1.90. If it is designed to be lower than the lower limit of Equation 4, the aberration may be reduced to obtain performance, and the refractive power of the third lens 103 becomes weak, so that light cannot be collected efficiently, and the performance of the optical system may deteriorate. If it is designed to be higher than the upper limit of the Equation 4, there is a disadvantage that it becomes difficult to obtain materials. In addition, if the refractive index of the third lens 103 is designed to be lower than the lower limit of the Equation 4, in order to increase the refractive power of the fifth and sixth lenses, the radius of curvature of the fifth and sixth lenses must be increased, and in this case, lens manufacturing becomes more difficult, the lens defect rate increases, and the yield may decrease.

$$1.6 \leq A v e r ( n 1 : n 7 ) \leq 1.7 \qquad [ Equation 4 - 1 ]$$

In Equation 4-1, Aver(n1:n7) is the average of the refractive index values of the d-line of the first to seventh lenses. If the optical system 1000 according to the embodiment satisfies Equation 4-1, the optical system 1000 can set the resolution and suppress the influence on the TTL.

$$0.5 < GL\_nd \_Aver / G M\_nd \_Aver < 1.5 \qquad [ Equation 4 - 2 ]$$

GL_nd_Aver is the average refractive index of the spherical lenses in the lens portion 100, and GM_nd_Aver is the average refractive index of the aspherical lenses. The fifth to seventh lenses having high refractive indices are positioned on the sensor side to increase color dispersion. Preferably, Equation 4-2 may satisfy: 0.7<GL_nd_Aver/GM_nd_Aver<1.

$$20 degrees < FOV\_H < 40 degrees \qquad [ Equation 5 ]$$

In Equation 5, FOV_H represents the horizontal field of view and can set the range of the vehicle optical system. Equation 5 preferably satisfies: 25 degrees≤FOV_H≤35 degrees, or a range of 30 degrees±3 degrees, and at this time, the sensor length in the horizontal direction may be based on 8.064 mm+0.5 mm. In addition, if Equation 5 is satisfied, when the temperature changes from room temperature to high temperature, the change rate of the effective focal length and the change rate of the field of view may be set to 5% or less, for example, 0 to 5%. In addition, even if one or more aspherical lenses, for example, two or more aspherical lenses, are used in combination with a spherical lens in the optical system 1000, the deterioration of the optical characteristics may be prevented through temperature compensation of the glass lens.

$$L 1 R 1 < 0 \qquad [ Equation 6 ]$$

L1R1 means the radius of curvature of the first surface S1 of the first lens 101-141, and may be set to be smaller than 0. If Equation 6 is satisfied, the shape of the optical system may be limited. The object-side surface of the first lens 101-141 is formed concavely, so that when it comes into contact with an external structure, surface damage may be prevented. In addition, since the following condition satisfies: L1R1*L1R2>0, the incident light may be refracted in a direction away from the optical axis. Accordingly, the embodiment can reduce the center distance between the first and second lenses, and the effective diameter of the second lens 102 may be provided to be larger than the effective diameter of the first lens.

$$L 3 R 1 > 0 , L 2 R 2 < 0 \qquad [ Equation 6 - 1 ]$$

L3R1 is the radius of curvature of the object-side surface of the third lens 103-143, and L2R2 is the radius of curvature of the sensor-side surface of the second lens. Since the first lens 101-141 has a meniscus shape convex toward the sensor, light may be refracted to the edges of the second and third lenses, which have large effective diameters. Since the first lens has a convex meniscus shape toward the sensor side, it can refract even the edges of the second and third lenses having large effective diameters, and can reduce the number of lenses. In addition, since the following conditions satisfy: L3R2>L3R1 and |L4R1<L4R2|, light may be adjusted so that the effective diameters of the fifth to seventh lenses do not become large, and TTL may be reduced. If the following condition: L3R1>L3R2, there is a problem that aberration occurs between the object-side surfaces of the first lens and the second lens, or the effective diameters of the sensor-side lenses increase, or the TTL increases. By setting the radii of curvature of the first, second, and fourth lenses large, the influence of optical characteristics on incident light may be reduced.

$$0.8 < B F L / L 7 S 2 \_ max \_sag to Sensor < 3 \qquad [ Equation 7 ]$$

BFL is the optical axis distance from the center of the sensor-side surface of the last lens, i.e., the seventh lens, to the surface of the image sensor. L7S2_max_sag to Sensor may be the distance in the optical axis direction from the maximum Sag value of the seventh lens 107-147 to the image sensor 300. If the optical system satisfies Equation 7, TTL may be reduced and conditions for manufacturing a camera module may be set. In addition, L7S2_max_sag to Sensor can set a space where an optical filter 500 and a cover glass 400 located between the image sensor 300 and the seventh lens may be placed. If the range of Equation 7 is smaller than the lower limit, the space for placing circuit structures such as optical filters and image sensors becomes more restricted, and the process of assembling circuit structures such as filters and image sensors to the optical system may become difficult. When the range of Equation 7 is larger than the upper limit, the process of assembling circuit structures such as filters and image sensors into the optical system is easy, but the TTL becomes long, making it difficult to miniaturize the optical system. That is, Equation 7 can set the minimum distance between the image sensor 300 and the last lens, and preferably, it may satisfy the following condition: L7S2_max_sag to Sensor<BFL. In addition, when the last lens does not have a point that protrudes further in the direction of the image sensor than the center of the sensor-side surface, the value of Equation 7 may be equal to the BFL (Back focal length). The BFL is the optical axis distance from the image sensor 300 to the center of the sensor-side surface of the last lens. In detail, if the following condition satisfies: 0.8<BFL/L7S2_max_sag to Sensor<1.2, the manufacturing convenience and TTL reduction are easier.

$$3 < CT 1 / CT 7 < 7 \qquad [ Equation 8 ]$$

If Equation 8 is satisfied, the aberration characteristics may be improved and the influence on the reduction of the optical system may be set. Preferably, in Equation 8, the first embodiment may satisfy: 4<CT1/CT7<5.5, the second embodiment may satisfy: 3<CT1/CT7<5.5, and the third embodiment may satisfy: 2.5<CT1/CT7<5.5. Equation 8 can set the center thickness of the first lens on the object side of the optical system and the seventh lens having an aspherical surface, and can limit the difference in their center thicknesses. Accordingly, the chromatic aberration of the optical system may be improved, good optical performance may be achieved at the set field of view, and TTL may be controlled.

$$0.4 < CT 1 / CA 11 < 1 \qquad [ Equation 8$$

In Equation 8-1, the center thickness CT1 of the first lens 101-141 and the effective diameter CA11 of the object-side surface S1 of the first lens may be set, and if these are satisfied, the strength and optical characteristics of the glass lens may be prevented from being deteriorated. If it is lower than the range of Equation 8-1, the lens may be damaged or injection molding may be difficult, and if it is larger than the above range, the TTL may increase and the weight of the optical system may become heavy. Preferably, 0.5<CT1/CA11<0.90 may be satisfied.

$$0.4 < CT 1 / CA 41 < 1 \qquad [ Equation 8 - 2 ]$$

In Equation 8-2, the center thickness CT1 of the first lens 101-141 and the effective diameter CA41 of the object-side surface S7 of the fourth lens 104-144 may be set, and if this is satisfied, a lens having the maximum center thickness and a lens having the maximum effective diameter may be set. Preferably, 0.45<CT1/CA41<0.8 may be satisfied.

$$0 < CT 3 / CT 7 < 3 \qquad [ Equation 9 ]$$

CT3 is the center thickness of the third lens 103-143, and CT7 is the center thickness of the seventh lens 107-147. If the optical system satisfies Equation 9, the ratio of the center thickness of the aspherical lens may be set, the aberration characteristics may be improved, and the influence on the reduction of the optical system may be set. Equation 9 preferably satisfies 1.2<CT3/CT7<1.9.

$$1 < CT 56 / CT 7 < 5 \qquad [ Equation 10 ]$$

In Equation 10, CT56 is the sum of the center thicknesses of the fifth and sixth lenses, for example, the center thickness of the cemented lens CL1-CT5. That is, CT56 is the optical axis distance from the center of the object-side surface of the fifth lens 105-145 to the center of the sensor-side surface of the sixth lens 106-146. When the optical system satisfies Equation 10, the center thicknesses of the cemented lens and the seventh lens 107-147 adjacent thereto may be set to improve the aberration characteristics. In Equation 10, the first embodiment may satisfy: 3<CT56/CT7<4, and the second to fifth embodiments may satisfy: 1.5<CT56/CT7<4. Here, the following condition may satisfy: CT56>ET56, and ET56 is the edge thickness of the cemented lens.

$$0 < \vert L 2 R 1 / L 4 R 2 \vert < 5 \qquad [ Equation 11 ]$$

In Equation 11, L2R1 means the radius of curvature of the first surface S1 of the second lens 102-142, and L4R2 means the radius of curvature of the eighth surface S8 of the fourth lens 104-144. When the optical system 1000 according to the embodiment satisfies Equation 11, the optical system 1000 may have improved aberration characteristics. Preferably, in Equation 11, the first embodiment may satisfy: 0<L2R1/L4R21<1 or 0<L2R1/L4R21<0.5, and the second and third embodiments may satisfy: 0<L2R1/L4R21<1 or 0<L2R1/L4R2|<0.8, the fourth embodiment may satisfy: 0<|L2R1/L4R21<5 or 2<|L2R1/L4R21<4.5, and the fifth embodiment may satisfy: 0<L2R1/L4R21<5 or 0.5<|L2R1/L4R21<1.

$$0 < CT 56 - ET 56 < 2 mm \qquad [ Equation 12 ]$$

In Equation 12, ET56 is the optical axis distance from the end of the effective region of the object-side surface of the fifth lens 105 to the end of the effective region of the sensor-side surface of the sixth lens 106. When the optical system satisfies Equation 12, the center thickness and edge thickness of the cemented lens may be set to improve the aberration characteristics, and preferably, the following condition may satisfy: CT56<CT1. Also, the following condition may satisfy: ET56<ET1.

$$0 < CA 11 / CA 31 < 2 \qquad [ Equation 13 ]$$

In Equation 13, CA11 means the effective diameter of the first surface S1 of the first lens 101, and CA31 means the effective diameter of the fifth surface S5 of the third lens 103. When Equation 13 is satisfied, the optical system 1000 can control the incident light and set the factor affecting the aberration, and preferably, 0.5<CA11/CA31<1 may be satisfied. Since the first and third lenses satisfy Equation 13, the difference in effective diameters of the first and third lenses is not large, so that the influence of assembly may be reduced, and the optical influence of temperature change may be reduced.

$$0 < CA 72 / CA 42 < 2 \qquad [ Equation 14 ]$$

In Equation 14, CA42 means the effective diameter of the eighth surface S8 of the fourth lens 104, and CA72 means the effective diameter of the fourteenth surface S14 of the seventh lens 107. When Equation 14 is satisfied, the optical system 1000 can control the incident light path, and can set factors for performance changes according to CRA and temperature. Preferably, Equation 14 may satisfy: 0.5<CA72/CA42<1.0.

$$0 < CA 12 / CA 21 < 2 \qquad [ Equation 15 ]$$

In Equation 15, CA12 means the effective diameter of the second surface S2 of the first lens 101, and CA21 means the effective diameter of the third surface S3 of the second lens 102. When the optical system 1000 according to the embodiment satisfies Equation 15, the optical system 1000 can control the light that proceeds to the first lens group LG1 and the second lens group LG2, and can set a factor that affects the decrease in lens sensitivity. Equation 15 can preferably satisfy 0.5<CA12/CA21<1. Since the first and second lenses satisfy Equation 15, the influence on the optical characteristics due to the assembly and tilt may be suppressed by the curvature radius and effective diameter of the first and second lenses, and heat compensation may be possible.

$$0 < CA 31 / CA 42 < 2 \qquad [ Equation 16 ]$$

CA31 means the effective diameter of the fifth surface S5 of the third lens 103, and CA42 means the effective diameter of the eighth surface S8 of the fourth lens 104. When the optical system 1000 according to the embodiment satisfies Equation 16, the sizes of the aspherical lens and the spherical lens may be set. Preferably, the first, fourth, and fifth embodiments may satisfy: 0.5<CA31/CA42<1.0, and the second and third embodiments may satisfy: 1<CA31/CA42<1.2.

$$0 < CA 51 / CA 62 < 2 \qquad [ Equation 17 ]$$

CA51 means the effective diameter of the ninth surface S9 of the fifth lens 105-145, and CA62 means the effective diameter of the twelfth surface S12 of the sixth lens 106-146. When the optical system 1000 according to the embodiment satisfies Equation 17, the optical system 1000 can improve chromatic aberration and set the size between the object-side surface and the sensor-side surface within the cemented lenses CL1-CL5. Accordingly, by setting the effective diameter size of the cemented lens positioned closer to the object side than the last aspherical lens, the light incident through the cemented lens may be effectively guided to the aspherical lens. Equation 17 can preferably satisfy 1<CA51/CA62<1.6. Since the cemented lens satisfies Equation 17, it is possible to reduce TTL within an optical system, reduce the effective diameter of lenses arranged on the sensor side of the cemented lens, and provide a camera module having a slimmer thickness.

$$0 < CA 62 / CA 71 < 2 \qquad [ Equation 18 ]$$

CA71 means the effective diameter of the thirteenth surface S13 of the seventh lens 107-147. When the optical system 1000 according to the embodiment satisfies Equation 18, the relationship between the effective diameter of the sensor-side surface of the cemented lens CL1-CL5 and the effective diameter of the object-side surface of the adjacent lens may be set. Accordingly, the optical system 1000 can improve chromatic aberration and can set the size and curvature radius between the sensor-side surfaces of the sensor-side sixth lens within the cemented lens. Accordingly, the effective diameter sizes of the fifth and sixth lenses arranged on the object side more than the last lens may be set. Equation 18 preferably satisfies: 1<CA62/CA71<1.2.

$$1 mm < ( CA 61 - CA 62 ) < 3 mm \qquad [ Equation 18 - 1 ]$$

In Equation 18-1, the effective diameter difference between the object-side surface and the sensor-side surface S12 of the sixth lens 106-146 may exceed 1 mm, may be greater than the effective diameter differences between the object-side surfaces and the sensor-side surfaces of other lenses, and may be the maximum among the effective diameter differences between the object-side surfaces and the sensor-side surfaces of each lens within the optical system. Accordingly, by maximizing the effective diameter difference between the object-side surface and the sensor-side surface of the sixth lens, which is a spherical lens adjacent to the aspherical lens, the light refracted through the sixth lens may proceed within the effective region of the aspherical lens.

$$CA 4 > CA 5 > CA 6 \qquad [ Equation 18 - 1 ]$$

$$CA 41 > ( ImgH * 2 ) \qquad [ Equation 18 - 2 ]$$

$$CA 51 > ( ImgH * 2 ) \qquad [ Equation 18 - 3 ]$$

In Equations 18-2 to 18-4, CA5 is the effective diameter of the fifth lens 105, CA6 is the effective diameter of the sixth lens 106, ImgH is ½ of the diagonal length of the image sensor 300, and CA62 is the effective diameter of the sensor-side surface of the sixth lens. Accordingly, the light path may be set to the area of the image sensor 300 by the effective diameter of the fifth lens 105, the effective diameter of the object-side surface of the fourth lens 104, and the effective diameter of the object-side surface of the fifth lens 105. In the embodiment, since the n-th lens is provided as an aspherical lens, the effective diameter ratio of the adjacent spherical lens and the cemented lens may satisfy Equations 18 to 18-4.

The first embodiment satisfies: CA62>(ImgH*2), the second and third embodiments satisfy: CA62<(ImgH*2), and the fourth and fifth embodiments satisfy: CA71<(ImgH*2). CA71 is the effective diameter of the object-side surface of the seventh lens.

$$0.2 < GL\_CA \_Aver / GM\_CA \_Aver < 2 \qquad [ Equation 19 ]$$

In Equation 19, GL_CA_Aver represents the average effective diameter of glass lenses having a spherical surface, and GM_CA_Aver represents the average effective diameter of glass mold lenses having an aspherical surface. In Equation 19, the effective diameters of the spherical lens and the aspherical lens are set, so that the path of the incident light may be effectively guided. Equation 19 preferably satisfies: 1<GL_CA_Aver/GM_CA_Aver<1.2. That is, the difference in the effective diameters of the spherical lens and the aspherical lens may be set not to be large. Here, nGL>nGM may be satisfied. The nGL is the number of spherical glass lenses, and nGM is the number of aspherical glass lenses. In an embodiment, by adding an aspherical lens, the number of lenses may be reduced, and the deterioration of optical characteristics may be prevented.

$$0 < GL\_nd \_Aver / GM\_nd \_Aver < 1.6 \qquad [ Equation 20 ]$$

In Equation 19, GL_nd_Aver is the average of the refractive indices of the lenses made of glass, for example, the average of the refractive indices of the first, second, fourth, fifth, and sixth lenses. GM_nd_Aver is the average of the refractive indices of the third and seventh lenses. Preferably, the refractive indices of the spherical lens and the refractive indices of the aspherical lens may be set to satisfy the following condition: 0.7<GL_nd_Aver/GM_nd_Aver<1.

$$0 < Σ {GM}_{-} n d / Σ {GL}_{-} n d < 1 \qquad [ Equation 20 - 1 ]$$

ΣGM_nd is the sum of the refractive indices of the glass mold lens, and EGL_nd is the sum of the refractive indices of the spherical glass lens. Preferably, the expression: 0.2<ΣGM_nd/EGL_nd<0.6, and the fourth and fifth embodiments may satisfy the expression: 0<ΣGM_nd/EGL_nd<0.4. The optical system can adjust the resolution and color dispersion by setting the difference in the refractive indices of the spherical lens and the aspherical lens.

$$CA 7 < CA 5 \qquad [ Equation 21 ]$$

In addition, the first embodiment satisfies the equation: CA6<CA5, and the second to fifth embodiments may satisfy the equation: (2*ImgH)<CA6<CA5<CA4<CA3. In Equation 21, CA6 is the effective diameter of the sixth lens 106, CA7 is the effective diameter of the seventh lens 107-147, CA5 represents the effective diameter of the fifth lens, CA3 and CA4 represent the effective diameters of the third and fourth lenses, and ImgH is ½ of the diagonal length of the image sensor. If this Equation 21 is satisfied, the optical system can guide light to the center and periphery portions of the image sensor 300 and improve chromatic aberration by setting the effective diameter size of the 6th and seventh lenses arranged between the fifth lens 105-145 and the image sensor 300 to be smaller than the effective diameter of the fifth lens 105-145.

$$CG 2 < CG 6 < CG 3 \qquad [ Equation 22 ]$$

In Equation 22, CG2 is the center distance between the second and third lenses, CG3 is the center distance between the third and fourth lenses, and CG6 is the center distance between the sixth and seventh lenses. If Equation 22 is satisfied, the center distance from the second lens to the seventh lens may be set, so that the center distance may be reduced and the optical performance of the periphery portion of the FOV may be improved.

$$G 5 < 0.01 < 0.01 mm or CG 5 < 0.01 mm \qquad [ Equation 22 - 1 ]$$

In Equation 22-1, G5 and CG5 are the distance and center distance between the fifth lens 105-145 and the sixth lens 106-146. If Equation 22-1 is satisfied, the fifth and sixth lenses may be set as cemented lenses. Here, CT56=CT5+CT6+CG5 may be preferably satisfied, and may be obtained by the sum of the center thicknesses CT5 and CT6 of the fifth and sixth lenses and the center distance CG5 of the fifth and sixth lenses.

$$0 < CT 7 / CG 6 < 2 \qquad [ Equation 23 ]$$

In Equation 23, CG6 is the center distance between the sensor-side surface of the sixth lens 106-146 and the object-side surface of the seventh lens 107-147. In Equation 23, by setting the center thickness CT7 of the seventh lens and the center distance between the sixth and seventh lenses, the optical performance at the periphery portion of the field of view may be improved. In Equation 23, the first embodiment preferably satisfies: 0.2<CT7/CG6<0.8, the second and third embodiments satisfy: 0.5<CT7/CG6<1.5, and the fourth and fifth embodiments satisfy: 0.5<CT7/CG6<1.

In the first to third embodiments, the following equation may satisfy: LD34<LD12. LD12 is the optical axis distance from the object-side surface of the first lens to the sensor-side surface of the second lens, and LD34 is the optical axis distance from the object-side surface of the third lens to the sensor-side surface of the fourth lens. If the equation 24 is satisfied, the incident light may be guided to the effective region of the aspherical lens, and the TTL may be reduced.

In the fourth and fifth embodiments, the following equation may satisfy: L6R2<CA41. L6R2 is the radius of curvature of the optical axis of the sensor-side surface of the sixth lens 106 and 146, and CA41 is the effective diameter of the object-side surface of the fourth lens. If the equation is satisfied, the radius of curvature of the sensor-side surface of the last spherical lens may be set to be smaller than the maximum effective diameter, so that the effective diameter of the seventh lens and the size of the image sensor may be adjusted.

In the first to third embodiments, the following equation may satisfy: CG57<CG14, where CG14 is the sum of the center distances between the first to fourth lenses, and CG46 represents the sum of the center distances between the fifth to seventh lenses. When the equation above is satisfied, the center distance between the lenses located on the object side relative to the cemented lens and the center distance from the cemented lens to the last lens may be adjusted to guide the incident light to the aspherical lens, improve chromatic aberration, and reduce TTL.

In the fourth and fifth embodiments, the following equation may satisfy: 1.2<CT1/ImgH<2.5. In the Equation, by setting CT1 to be greater than ½ of the diagonal length of the image sensor, the surface of the optical system may be protected, changes in optical characteristics due to temperature changes may be reduced, and deterioration of assembly may be prevented.

$$FOV < 45 \qquad [ Equation 24 ]$$

In Equation 24, FOV means the field of view (Degree) in the diagonal direction of the optical system 1000, and can provide a vehicle optical system of less than 45 degrees. The FOV can preferably satisfy: 20<FOV<40.

$$1 < TTL / CA \_Max < 5 \qquad [ Equation 25 ]$$

CA_Max means the largest effective diameter (mm) among the object-side and sensor-side surfaces of the plurality of lenses, and TTL (Total track length) means the distance (mm) from the vertex of the seventh surface S7 of the fourth lens to the upper surface of the image sensor 300 in the optical axis OA. Equation 71 sets the relationship between the total optical axis length of the optical system and the maximum effective diameter, and can provide an improved vehicle optical system. Equation 71 can preferably satisfy: 2<TTL/CA_Max<4.

$$0 < CT 6 / CT 7 < 3 \qquad [ Equation 26 ]$$

In Equation 26, by setting the center thickness CT6 of the sixth lens to be thicker than the center thickness CT7 of the seventh lens, factors affecting aberration may be controlled. Preferably, in Equation 26, the first embodiment may satisfy: 1<CT6/CT7<3 or 1<CT6/CT7<1.5, and the second to fifth embodiments may satisfy: 0<CT6/CT7<1.7 or 0.5<CT6/CT7<1.5. The second embodiment satisfies: CT6<CT7, the third embodiment may satisfy: CT7<CT6, the fourth embodiment may satisfy: CT6>CT7, and the fifth embodiment may satisfy CT7>CT6.

$$10 < \vert L 7 R 1 / CT 7 \vert < 60 \qquad [ Equation 27 ]$$

In Equation 27, L7R1 means the radius of curvature of the thirteenth surface of the seventh lens. In Equation 27, by setting the radius of curvature of the object-side surface of the seventh lens and the center thickness of the seventh lens, the refractive power of the seventh lens may be controlled. Accordingly, good optical performance may be achieved at the center and periphery of the field of view. Preferably, in the Equation 27, the first embodiment may satisfy: 10<L7R1/CT7<40 or 18<L7R1/CT7<30, and the second to fifth embodiments may satisfy: 15<|L7R1/CT7|<55. By controlling the radius of curvature and the center thickness of the seventh lens having an aspherical surface by the Equation 27, the TTL of the optical system may be reduced and the deterioration of the optical performance may be prevented.

$$0 < \vert L 5 R 2 / L 7 R 1 \vert < 10 \qquad [ Equation 28 ]$$

In the Equation 28, L5R2 means the radius of curvature of the tenth surface of the fifth lens. In the Equation 28, by setting the radius of curvature of the sensor-side surface of the fifth lens and the radius of curvature of the object-side surface of the seventh lens, the refractive powers of the fifth and seventh lenses may be controlled. Accordingly, it may have good optical performance in the center and periphery of the field of view. Preferably, in Equation 28, the first embodiment may satisfy: 0<L5R2/L7R1|<1, the second and third embedment may satisfy: 0<L5R2/L7R1|<2 or 0<L5R2/L7R1|<2, and the fourth and fifth embodiments may satisfy: 0<L5R2/L7R1|<2 or 0<L5R2/L7R1|<1.

In the first embodiment, the following equation satisfies: L1R1*L1R2>0, where L1R1 is the radius of curvature of the object-side surface of the first lens, and L1R2 means the radius of curvature of the sensor-side surface of the first lens. When the equation is satisfied, the refractive power of the first lens may be controlled to control the incident light as a spherical lens. Preferably, L1R1+L1R2<0 may be satisfied. By setting the curvature radius of the first lens by the Equation, the assembly performance of the spherical lens may be prevented from being deteriorated, and the distance between the first and second lenses may be set.

In the second to fifth embodiments, the following equation may satisfy: L1R1*L5R2>0. L1R1 represents the curvature radius of the object-side surface of the first lens, and L5R2 means the curvature radius of the sensor-side surface of the fifth lens. When the equation is satisfied, the refractive power of the first and fifth lenses may be controlled to control the incident light to the spherical lens. Preferably, L1R1<0, L5R2<0, and L1R2*L5R2>0 may be satisfied. By setting the radius of curvature of the first lens using the Equation, the assemblability of the spherical lens may be prevented from deteriorating, and the distance between the first and second lenses may be set.

$$2 < TTL / ImgH < 15 \qquad [ Equation 29 ]$$

Equation 29 can set the total optical axis length (TTL) of the optical system and the diagonal length (ImgH) from the optical axis of the image sensor 300. When the optical system 1000 according to the embodiment satisfies Equation 72, the optical system 1000 may have TTL for application to the vehicle image sensor 300, thereby providing improved image quality. Equation 29 can preferably satisfy: 4<TTL/ImgH<10.

$$0 < \vert L 5 R 1 / L 6 R 2 \vert < 2 \qquad [ Equation 30 ]$$

L5R1 means the radius of curvature of the object-side surface of the fifth lens, and L6R2 means the radius of curvature of the sensor-side surface of the sixth lens. If Equation 30 is satisfied, the fourth and fifth lenses may be expressed as a cemented lens. Preferably, 0<L5R1/L6R2|<1 may be satisfied. The radius of curvature of the interface between the fifth lens and the sixth lens is the same, for example, L6R1/L5R2=1 may be satisfied.

$$0 < \vert L 6 R 2 / L 6 R 1 \vert < 2 \qquad [ Equation 31 ]$$

L6R1 means the radius of curvature of the object-side surface of the sixth lens, and L6R2 means the radius of curvature of the sensor-side surface of the sixth lens. In Equation 31, by setting the radius of curvature of the object-side surface and the sensor-side surface of the sixth lens, light may be effectively refracted from the cemented lens toward the aspherical lens. Preferably, in Equation 31, the first embodiment may satisfy: 0<|L6R2/L6R1|<1, and the second to fifth embodiments may satisfy: 0.5<L6R2/L6R1|<1.

$$0 < L 7 R 1 / L 7 R 2 < 7 \qquad [ Equation 31 - 1 ]$$

In Equation 31-1, L7R1 and L7R2 mean the radii of curvature of the object-side surface and the sensor-side surface of the seventh lens. In Equation 31-1, by setting the radii of curvature of the object-side surface and the sensor-side surface of the seventh lens, light may be refracted to the image sensor through the aspherical lens. In Equation 31-1, the first embodiment may preferably satisfy: 0<L7R1/L7R2<1 or 0<L7R1/L7R2<0.5, and the second to fifth embodiments may satisfy: 2<L7R1/L7R21<7 or 3<L7R1/L7R21<5.

In the first embodiment, the Equation: 0<CT_Max/CG_Max<5 is satisfied, and the maximum center thickness CT_Max among the lenses and the maximum center distance CT_Max between adjacent lenses may be set. If this equation is satisfied, the optical system may have good optical performance at the focal length at the set field of view and can reduce TTL. Preferably, the embodiment may satisfy: 1<CT_Max/CG_Max<2.

In the second to fifth embodiments, the Equation satisfies: 0<CT_Max/CG_Max<5, and this equation can set the maximum center thickness CT_Max among the lenses and the maximum center distance CG_Max between adjacent lenses. If this equation is satisfied, the optical system may have good optical performance at the focal length at the set field of view and can reduce TTL. Preferably, the second and third embodiments may satisfy: 2<CT_Max/CG_Max<3, and the fourth and fifth embodiments may satisfy: 1.5<CT_Max/CG_Max<4.

$$0.1 < BFL / ImgH < 2 \qquad [ Equation 32 ]$$

Equation 32 can set the optical axis distance between the image sensor 300 and the last lens and the diagonal length from the optical axis of the image sensor 300. When the optical system 1000 according to the embodiment satisfies Equation 73, the optical system 1000 can secure a BFL (Back focal length) for applying the size of the vehicle image sensor 300, set the interval between the last lens and the image sensor 300, and have good optical characteristics at the center and periphery portions of the FOV. Equation 32 preferably satisfies the following condition: 0.3<BFL/ImgH<1, and BFL<ImgH.

$$1 < \sum CT / \sum CG < 5 \qquad [ Equation 33 ]$$

In Equation 33, ΣCT is the sum of the center thicknesses of the lenses, and ΣCG is the sum of the center distances between adjacent lenses. When Equation 33 is satisfied, the optical system may have good optical performance at the focal length at the set field of view, and can reduce the TTL. Preferably, the first embodiment may satisfy: 2<ΣCT/ΣCG<3, the second and third embodiments may satisfy: 3<ΣCT/ΣCG<4.5, and the fourth and fifth embodiments may satisfy: 2<ΣCT/ΣCG<4.5.

$$8 < \sum nd < 20 \qquad [ Equation 34 ]$$

Σnd means the sum of the refractive indices of each of the plurality of lenses at the d-line. If Equation 34 is satisfied, the optical system 1000 in which the aspherical lens and the spherical lens are mixed can control the TTL and have improved resolution. In addition, if the number of spherical lenses is greater than the number of aspherical lenses, and if the number of spherical lenses having relatively thick thickness is greater, the sum of the TTL and the refractive indices may be set. Equation 34 can preferably satisfy: 10<Σnd<13.

$$10 < Σ Abbe / Σ nd < 50 \qquad [ Equation 35 ]$$

ΣAbbe means the sum of the Abbe numbers of each of the plurality of lenses. If Equation 35 is satisfied, the optical system 1000 may have improved aberration characteristics and resolution. Equation 35 sets the Abbes sum and the sum of the refractive indices of the lenses to control the optical characteristics, and preferably satisfies: 20<ΣAbbe/Σnd<40.

$$Distortion < 2 \qquad [ Equation 36 ]$$

Distortion means the maximum value of distortion or the absolute value of the maximum from the center (0.0F) of the image sensor to the diagonal end (1.0F) based on the optical characteristics detected by the image sensor 300. When the optical system 1000 satisfies Equation 36, the optical system 1000 can improve the distortion characteristics and set conditions for image processing. Preferably, Distortion<1 may be satisfied.

$$0 < \sum CT / \sum ET < 2 \qquad [ Equation 37 ]$$

ΣCT is the sum of the center thicknesses of the lenses, and ΣET is the sum of the edge thicknesses of the effective region of the lenses. If Equation 37 is satisfied, the optical system may have good optical performance at the focal length at the set field of view and can reduce the TTL. Equation 37 can preferably satisfy: 1<ΣCT/ΣET<1.5.

$$0.5 < CA 11 / CA\_Min < 2.5 \qquad [ Equation 38 ]$$

CA11 is the effective diameter of the object-side surface of the first lens, and CA_Min represents the minimum effective diameter among the object-side surfaces and the sensor-side surfaces of the lenses. If Equation 38 is satisfied, the optical system can control the incident light, maintain the optical performance, and provide a slimmer module. Equation 38 can preferably satisfy: 1<CA11/CA_Min<2.

$$1 < CA\_Max / CA\_Min < 5 \qquad [ Equation 39 ]$$

CA_Max means the maximum effective diameter among the object-side surfaces and the sensor-side surfaces of the lenses. If Equation 39 is satisfied, the optical system can set a size for a slim and compact structure while maintaining optical performance. Equation 39 can preferably satisfy: 1<CA_Max/CA_Min<2.

$$1 < CA\_Max / CA\_Aver < 3 \qquad [ Equation 40 ]$$

CA_Aver means an average of the effective diameters of the object-side surfaces and the sensor-side surfaces of the lenses. If Equation 40 is satisfied, the optical system can set a size for a slim and compact structure while maintaining optical performance. Equation 40 can preferably satisfy: 1<CA_Max/CA_Aver<1.5.

$$0.5 < CA\_Min / CA\_Aver < 2 \qquad [ Equation 41 ]$$

If Equation 41 is satisfied, the optical system can set a size for a slim and compact structure while maintaining optical performance. Equation 41 can preferably satisfy: 0.5<CA_Min/CA_Aver<1.

$$1 < CA\_Max / ( 2 * ImgH ) < 3 \qquad [ Equation 42 ]$$

Equation 42 may be set to the maximum effective diameter CA_Max of lens surfaces and the diagonal length of the image sensor, and if it satisfies this, the optical system can maintain good optical performance and set the size for a slim and compact structure. Equation 42 can preferably satisfy: 1<CA_Max/(2*ImgH)<2.

$$1 < TD / CA\_Max < 4 \qquad [ Equation 43 ]$$

TD is the optical axis distance from the center of the object-side surface of the first lens to the center of the sensor-side surface of the last lens. If Equation 43 is satisfied, the total optical axis distance and the maximum effective diameter of the lenses may be set, and the size for good optical performance may be set. Equation 43 preferably satisfies: 2<TD/CA_Max<3.

$$TD > SD \qquad [ Equation 43 - 1 ]$$

The SD is the distance from the position of the aperture stop to the center of the sensor side of the last lens.

$$1 < F / C A 61 < 10 \qquad [ Equation 44 ]$$

In Equation 44, F means the EFL of the optical system, and may be 10 mm or more, for example, in the range of 10 mm to 20 mm. In Equation 44, by setting the relationship between the effective focal length and the effective diameter of the object-side surface of the last spherical lens, the influence on the optical system reduction, for example, TTL, may be controlled. Equation 44 can preferably satisfy: 1<F/CA61<2.

$$0 < F / \vert L 1 R 1 \vert < 1 \qquad [ Equation 45 ]$$

In Equation 45, by setting the effective focal length of the optical system and the radius of curvature of the object-side surface of the first lens, the influence on the incident light and TTL may be controlled. Equation 45 can preferably satisfy: 0.5<F/L1R1|<1.

$$Max ( C T / E T ) < 4 \qquad [ Equation 46 ]$$

Max (CT/ET) means the maximum value of the ratio of the center thickness and the edge thickness of each lens. When Equation 46 is satisfied, the optical system can control the influence on the effective focal length. In Equation 46, the first to third embodiments may preferably satisfy: 2<Max (CT/ET)<3, and the fourth and fifth embodiments may satisfy: 2.5<Max (CT/ET)<3.5.

The ratio of the center thickness and the edge thickness of the aspherical lens within the lens section may satisfy the following condition: 0.50<GM(CT/ET)<1.3. The ratio of the center thickness and the edge thickness of the spherical lens within the lens section may satisfy the following condition: 0.50<GL(CT/ET)<3 or 0.50<GL(CT/ET)<3.5. If the condition of the aspherical lens is smaller than the lower limit of the above range, it is difficult to manufacture a glass mold lens. That is, when manufacturing by injecting high-temperature resin and hardening at a low temperature, if the thickness difference is large, the lens may not shrink uniformly as it cools at a low temperature, which may result in a high surface defect rate. In addition, as the temperature changes from −40 degrees to 105 degrees, the aspherical lens shrinks and expands, and during this process, the change rate of the lens shape appears significantly, which may deteriorate the optical system performance.

$$0 < EPD / \vert L 1 R 1 \vert < 1 \qquad [ Equation 47 ]$$

EPD means the size (mm) of the entrance pupil diameter of the optical system 1000, and LiR1 means the radius (mm) of curvature of the first surface S1 of the first lens. When the optical system 1000 according to the embodiment satisfies Equation 47, the optical system 1000 can control the incident light. Equation 47 preferably satisfies: 0.3<EPD/L1R1|<0.7.

$$- 10 < F 1 / F 3 < 0 \qquad [ Equation 48 ]$$

F1 is the focal length of the first lens, and F3 is the focal length of the third lens. If Equation 48 is satisfied, the refractive power of the first and third lenses may be controlled to improve the resolution, and can affect the TTL and EFL. The fourth and fifth embodiments may satisfy: −1<F1/F3<0.

$$\vert F 6 \vert < F 4 \qquad [ Equation 48 - 1 ]$$

$$\vert F 6 \vert < F5 \qquad [ Equation 48 - 2 ]$$

$$\vert F 6 \vert < \vert F 7 \vert \qquad [ Equation 48 - 3 ]$$

In Equations 48-1 to 48-3, F5 is the focal length of the fifth lens, F4 is the focal length of the fourth lens, F6 is the focal length of the sixth lens, and F7 is the focal length of the seventh lens. Accordingly, the absolute value of the focal length of the sixth lens adjacent to the last aspherical lens may be smaller than the focal lengths of the fourth and fifth lenses and smaller than the focal length of the seventh lens. Accordingly, the refractive power of the last spherical lens may be controlled to effectively guide light to the aspherical lens.

The aperture stop ST is arranged on the sensor-side surface of the first lens 101-141. The focal length of the lens arranged on the sensor side more than the aperture stop ST and arranged closest to the aperture stop ST is greater than 0. In the embodiment of the present invention, the focal length F2 of the second lens 102-142 should be designed to be greater than 0. In this case, the second lens 102-142 collects light, so that the effective diameter of the fourth to seventh lenses, which are arranged closer to the sensor than the second lens 102-142, may be prevented from increasing. In addition, since the TTL may be prevented from becoming longer, the optical system may be miniaturized. The composite focal length of the fourth to seventh lenses may have positive refractive power.

The composite focal length of the lenses arranged closer to the sensor than the aperture stop ST, that is, the lenses arranged closer to the sensor than the aperture, is designed to be greater than 0. In the embodiment of the invention, the composite focal length of the second to seventh lenses is designed to be greater than 0. In this case, the optical system may be miniaturized by reducing the TTL at a horizontal field of view (FOV_H) of 25 to 35 degrees.

$$Po 5 * Po 6 < 0 \qquad [ Equation 49 ]$$

Po5 is the refractive power value of the fifth lens, and Po6 is the refractive power value of the sixth lens. That is, the refractive powers of the fifth and sixth lenses have opposite refractive powers, so they can improve aberrations and effectively guide light with an aspherical lens. If a value of Po4*Po5 is greater than 0, the effect of improving chromatic aberration as a cemented lens does not appear significantly.

$$Po 1 ( Po 5 * Po 6 ) > 0 \qquad [ Equation 49 - 1 ]$$

$$F 56 > 0 \qquad [ Equation 49 - 2 ]$$

$$F 5 * F 6 < 0 \qquad [ Equation 49 - 3 ]$$

Pol is the refractive power value of the first lens, F56 is the composite focal length of the fifth and sixth lenses, F5 is the focal length of the fifth lens, and F6 is the focal length of the sixth lens. If Equations 49-1 to 49-3 are satisfied, it is easy to improve the aberration of the optical system with the fifth lens and the sixth lens, which are cemented lenses, and the incident light may be effectively guided to the aspherical lens.

$$15 < v 5 - v 6 < 60 \qquad [ Equation 50 ]$$

In Equation 50, v5 is the Abbe number of the fifth lens, and v6 is the Abbe number of the sixth lens. If Equation 50 is satisfied, the Abbe number difference of at least two lenses forming the cemented lens may be maintained at a certain value or more, and chromatic aberration may be improved. Equation 50 can preferably satisfy: 20<v5−v6<40. If the Abbe number difference of the cemented lenses is less than the lower limit of Equation 50, it may be insignificant in improving the aberration characteristics of the optical system. Accordingly, if the difference in Abbe numbers between the object-side lens and the sensor-side lens in the cemented lens is greater than 20 and less than 40, the aberration characteristics may be improved.

$$( v 1 * n 1 ) < ( v 2 * n 2 ) < ( v 4 * n 4 ) \qquad [ Equation 50 - 1 ]$$

v1, v2, and v4 are Abbe numbers of the first, second, and fourth lenses, and n1, n2, and n4 are refractive indices at the d-line of the first, second, and fourth lenses.

$$0 \text{<\textbar} F 1 / F \vert < 20 \qquad [ Equation 51 ]$$

Equation 51 sets the relationship between the focal length F1 and the effective focal length F of the first lens, so that the TTL of the optical system may be set. Equation 51 preferably satisfies:

$$0 < \vert F 5 / F 6 \vert < 2 \qquad [ Equation 52 ]$$

In Equation 52, by setting the relationship between the focal lengths F5 and F6 of the fifth and sixth lenses, the refractive power and optical path of the last spherical lenses may be adjusted, and the resolution may be improved. Equation 52 preferably satisfies: 1<F5/F6<1.5.

$$0 \text{<\textbar} F 5 / F 7 \vert < 1 \qquad [ Equation 53 ]$$

In Equation 53, by setting the relationship between the focal lengths F5 and F7 of the fifth and seventh lenses, the refractive power and optical path of the spherical lens and the last aspherical lens may be adjusted, and the resolution may be improved. In Equation 53, the first to third embodiments preferably satisfies: 0.2<F5/F7|<0.6, and the fourth and fifth embodiments may satisfy: 0.2<| F5/F7<0.7.

$$0 < \vert F 6 / F 1 \vert < 1.2 \qquad [ Equation 54 ]$$

In Equation 54, by setting the relationship between the focal lengths F1 and F6 of the first and sixth lenses, the refractive power and optical path of the first and last spherical lenses may be adjusted, and the influence of TTL may be adjusted to improve the resolution. Equation 54 preferably satisfies: 0.1<F6/F1<0.6.

$$0 < \vert F 27 / F \vert < 2 \qquad [ Equation 55 ]$$

In Equation 55, by setting the relationship between the composite focal length F27 and the effective focal length F of the second to seventh lenses, the refractive power of the second to seventh lenses may be controlled to improve the resolution, and the optical system may be provided in a slim and compact size. Equation 55 preferably satisfies: 0<F27/F<0.5.

$$1 < \vert F 47 / F 6 \vert < 25 \qquad [ Equation 56 ]$$

In Equation 56, the relationship between the composite focal length F47 of the fourth to seventh lenses and the focal length F6 of the sixth lens is set, so that the composite refractive power of the fourth to seventh lenses and the refractive power of the last spherical lens may be adjusted to improve the resolution, and the optical system may be provided in a slim and compact size. Preferably, in Equation 56, the first embodiment may satisfy: 1<F47/F6<5 or 2.5<F47/F6<4.5, the second and third embodiments may satisfy: 10<F47/F6<20, and the fourth and fifth embodiments may satisfy: 1<F47/F6<10 or 1<F47/F6<5.

$$0 < \vert F 47 / F 7 \vert < 10 \qquad [ Equation 57 ]$$

In Equation 57, the relationship between the composite focal length F47 of the fourth to seventh lenses and the focal length F7 of the seventh lens is set, so that the composite refractive power of the fourth to seventh lenses and the refractive power of the last aspherical lens may be adjusted to improve the resolution, and the optical system may be provided in a slim and compact size. In Equation 57, the first embodiment may preferably satisfy: 1<F47/F7<3 or 1<F47/F7<2, and the second to fifth embodiments may satisfy: 2<F47/F7<8.

$$0 < \vert F6 / F \vert < 5 \qquad [ Equation 58 ]$$

In Equation 58, the relationship between the focal length F6 of the sixth lens and the effective focal length F is set, so that the resolution may be improved by adjusting the refractive power of the last spherical lens and the entire focal length, and the optical system may be provided in a slim and compact size. Equation 58 preferably satisfies: 0<F6/F1<1.

$$F\_LG1 / F\_LG2 < 0 \qquad [ Equation 59 ]$$

In Equation 59, the relationship between the focal length F_LG1 of the first lens group LG1 and the focal length of the second lens group F_LG2 may be set. The focal length of the first lens group may have a negative value, and the focal length of the second lens group may have a positive value. When Equation 59 is satisfied, the optical system 1000 can improve aberration characteristics such as chromatic aberration and distortion aberration. Equation 59 can preferably satisfy: 2<| F_LG1/F_LG2|<7.

$$1 < nGL / nGM < 4 \qquad [ Equation 60 ]$$

In Equation 60, nGL means the number of spherical lenses, and nGM means the number of aspherical lenses. By arranging the number of aspherical lenses in Equation 60 to be 1 time more than the number of spherical lenses, the thickness of the optical system may be reduced and more refractive power may be provided through the aspherical surface. Equation 60 can preferably satisfy: 2<nGL/nGM<3.

$$1 < nSS / nAS < 4 \qquad [ Equation 61 ]$$

nSS is the number of spherical lens surfaces within the lens section, and nAS is the number of aspherical lens surfaces within the lens section. In Equation 61, by arranging the number of aspherical lens surfaces to be 1 time more than the number of spherical lens surfaces, the thickness of the optical system may be reduced and a wider range of refractive powers may be provided through the aspherical surfaces. Equation 61 preferably satisfies: 2<nSS/nAS<3.

$$( CAS\_Max / CAS\_Min ) < ( CT\_Max / CT\_Min ) \qquad [ Equation 62 ]$$

CAS_Max is the maximum effective diameter of the object-side surface and the sensor-side surface of the lenses, and CAS_Min is the minimum effective diameter of the object-side surface and the sensor-side surface of the lenses. CT_Max is the maximum center thickness of the lenses, and CT_Min is the minimum center thickness of the lenses. Equation 62 can improve the assembly of lenses by setting the effective diameter difference of lenses to be smaller than the difference in the center thickness of the lenses. Preferably, 1.5<(CAS_Max/CAS_Min)<(CT_Max/CT_Min)<4 may be satisfied.

$$0 < \sum GM\_CT / \sum GL\_CT < 1 \qquad [ Equation 63 ]$$

ΣGM_CT is the sum of the center thicknesses of the aspherical lens(es), and ΣGL_CT is the sum of the center thicknesses of the spherical lenses. If Equation 62 is satisfied, the entire TTL may be controlled by setting the relationship between the thickness of the aspherical lens and the thickness of the spherical lens compared to the TTL. In Equation 63, the first to third embodiments preferably satisfies: 0<ΣGM_CT/ΣGL_CT<0.5, and the fourth and fifth embodiments may satisfy: 0.2<ΣGM_CT/ΣGL_CT<0.9.

$$10 mm < TTL < 50 mm \qquad [ Equation 64 ]$$

TTL (Total track length) means the distance (mm) from the center of the first surface S1 of the first lens 101-141 to the surface of the image sensor 300 in the optical axis OA. In Equation 64, the TTL may be set to exceed 10 mm or 20 mm to provide a vehicle optical system. Equation 64 preferably satisfies: 22 mm<TTL<40 mm or satisfies the following condition: TD<TTL.

$$2 mm < ImgH \qquad [ Equation 65 ]$$

Equation 65 can set the diagonal length (2*ImgH) of the image sensor 300 and can provide an optical system having a vehicle sensor size. Equation 65 can preferably satisfy: 4 mm<ImgH.

$$2 mm < B F L < 7 mm \qquad [ Equation 66 ]$$

In Equation 66, the BFL (Back focal length) is set to be more than 2 mm and less than 7 mm, thereby securing the installation space of the optical filter 500 and the cover glass 400, and improving the assemblability of the components through the distance between the image sensor 300 and the last lens, and improving the joint reliability. Equation 66 can preferably satisfy: 2.5 mm≤BFL≤3.5 mm. If the BFL is less than the range of the Equation 68, some of the light that is transmitted to the image sensor may not be transmitted to the image sensor, which may cause a decrease in resolution. If the BFL exceeds the range of the Equation 68, stray light may be introduced, which may deteriorate the aberration characteristics of the optical system.

$$0 < BFL / CG 3 < 1 \qquad [ Equation 67 ]$$

In the Equation 67, the BFL (Back focal length) sets the distance between the lenses, for example, the center distance CG3 between the third and fourth lenses, thereby securing the installation space of the optical filter 500 and the cover glass 400, and improving the assemblability of the components and improving the joint reliability through the distance between the image sensor 300 and the last lens. In the Equation 67, the first embodiment may satisfy: 0.3<BFL/CG3<0.8, and the second to fifth embodiments may satisfy: 0.3<BFL/CG3<1. The center distance CG3 between the third and fourth lenses may be the largest within the lens section.

$$1 < CT 1 / BFL < 3.5 \qquad [ Equation 68 ]$$

In Equation 68, the BFL (Back focal length) is set to be smaller than the distance between the lenses, for example, the center thickness of the first lens, so that the installation space for the optical filter 500 and the cover glass 400 may be secured, and the assemblability of the components may be improved and the bonding reliability may be improved through the distance between the image sensor 300 and the last lens. In addition, the seventh lens, which is the last lens, can disperse the incident light to the effective region of the image sensor, but if the BFL does not satisfy Equation 68, some of the emitted light may not be transmitted to the effective region of the image sensor, which may deteriorate the resolution. Preferably, the first embodiment may satisfy: 1<CT1/BFL<3 or 2<CT1/BFL<3, and the second to fifth embodiments may satisfy: 2<CT1/BFL<3.5.

$$3 < F < 40 \qquad [ Equation 69 ]$$

Equation 69 can set the total effective focal length F to suit the vehicle optical system. Equation 69 may satisfy 10<F<30.

$$5 < TTL / BFL < 20 \qquad [ Equation 70 ]$$

Equation 70 can set the total optical axis length (TTL) of the optical system, and the optical axis distance (BFL) between the image sensor 300 and the last lens. When the optical system 1000 according to the embodiment satisfies Equation 70, the optical system 1000 can secure BFL. Equation 70 can preferably satisfy: 8<TTL/BFL<16.

$$1 < TTL / F < 3 \qquad [ Equation 71 ]$$

Equation 71 can set the total focal length F and the total optical axis length (TTL) of the optical system 1000. Accordingly, an optical system for a driver assistance system may be provided. Equation 71 can preferably satisfy: 1.5≤TTL/F<2.8. When the optical system 1000 according to the embodiment satisfies Equation 75, the optical system 1000 may have an appropriate focal length in the set TTL range, and provides an optical system that can maintain an appropriate focal length and form an image even when the temperature changes from low temperature to high temperature. If it is less than the lower limit of Equation 71, it is necessary to increase the refractive power of the lenses, so that correction of spherical aberration or distortion aberration becomes difficult, and if it exceeds the upper limit of Equation 71, the effective diameter or TTL of the lenses becomes long, so that a problem of a large-sized photographing lens system may occur.

$$1 < F / BFL < 10 \qquad [ Equation 72 ]$$

Equation 72 can set the total effective focal length F of the optical system 1000 and the optical axis distance (BFL) between the image sensor 300 and the last lens. If the optical system 1000 according to the embodiment satisfies Equation 72, the optical system 1000 may have a set field of view and an appropriate focal length, and a vehicle optical system may be provided. In addition, the optical system 1000 can minimize the distance between the last lens and the image sensor 300, so that it may have good optical characteristics in the periphery portion of the FOV. Equation 72 can preferably satisfy: 3<F/BFL<8.

$$1 < F / ImgH < 5 \qquad [ Equation 73 ]$$

Equation 73 can set the total effective focal length F of the optical system 1000 and the diagonal length (ImgH) of the optical axis of the image sensor 300. This optical system 1000 may have improved aberration characteristics in the size of the vehicle image sensor 300. Equation 73 can preferably satisfy: 2<F/ImgH<4.1.

$$1 < F / EPD < 5 \qquad [ Equation 74 ]$$

Equation 74 can set the overall effective focal length F and the entrance pupil diameter of the optical system 1000. Accordingly, the overall brightness of the optical system may be controlled. Preferably, Equation 74 can set: 1<F/EPD<3.

$$0 < BFL / TD < 0.3 \qquad [ Equation 75 ]$$

Equation 75 can set the relationship between the optical axis distance (TD) and the BFL of the lenses of the optical system 1000. Accordingly, the resolution of the optical system may be maintained and the overall size may be controlled. Preferably, Equation 75 may satisfy: 0<BFL/TD<0.2. When the condition value of BFL/TD is 0.2 or more, since the BFL is designed to be large compared to the TD, the size of the entire optical system becomes large, which makes it difficult to miniaturize the optical system, and the distance between the seventh lens and the image sensor becomes long, which may increase unnecessary light quantity through the seventh lens and the image sensor, which may cause aberration characteristics to deteriorate, resulting in a problem of reduced resolution.

$$0 < EPD / ImgH / FOV < 0.2 \qquad [ Equation 76 ]$$

Equation 75 can set the relationship between the EPD, the length (ImgH) of ½ of the diagonal length of the image sensor, and the field of view in the diagonal direction. Accordingly, the overall size and brightness of the optical system may be controlled. Equation 80 preferably satisfies: 0<EPD/ImgH/FOV<0.1.

$$5 < FOV / F \# < 40 \qquad [ Equation 77 ]$$

Equation 77 can set the relationship between the diagonal field of view of the optical system and the F number. Preferably, Equation 77 may satisfy: 10<FOV/F #<30. Here, F # is provided as 1.8 or less, so as to provide a bright image.

$$1 < \sum GL\_CT / F \# < 20 \qquad [ Equation 78 ]$$

Equation 78 can set the relationship between the sum ΣGL_CT of the center thicknesses of the glass lenses of the optical system and the F number (F #). Preferably, in Equation 78, the first embodiment may satisfy: 1<ΣGL_CT/F #<5, and the second to fifth embodiments may satisfy: 5<ΣGL_CT/F #<15.

$$1 < \sum GM\_CT / F \# < 5 \qquad [ Equation 79 ]$$

Equation 79 can set the relationship between the sum ΣGM_CT of the center thicknesses of the aspherical lenses of the optical system and the F number F #. Preferably, Equation 79 may satisfy: 1<ΣGM_CT/F #<3.

$$1 < \sum GL\_nd / F \# < 10 \qquad [ Equation 80 ]$$

Equation 80 can set the relationship between the sum ΣGL_nd of the refractive indices of the spherical lenses of the optical system and the F number F #. Preferably, Equation 80 may satisfy: 3<ΣGL_nd/F #<10.

$$1 < \sum GM\_nd / F \# < 10 \qquad [ Equation 81 ]$$

Equation 81 can set the relationship between the sum ΣGM_nd of the refractive indices of the aspherical lenses of the optical system and the F number F #. Equation 81 preferably satisfies: 1<GM_nd/F #<5.

$$\vert Max\_Sag62 \vert < \vert Max\_Sag51 \vert \qquad [ Equation 82 ]$$

Max_Sag62 is the maximum distance in the optical axis direction from a straight line perpendicular to the optical axis on the sensor-side surface of the sixth lens to the sensor-side surface of the sixth lens, and Max_Sag51 is the maximum distance in the optical axis direction from a straight line perpendicular to the optical axis on the object-side surface of the fifth lens to the object-side surface of the fifth lens. When Equation 86 is satisfied, light may be guided from the last spherical lens to the last aspherical lens by the radius of curvature of the sensor-side surface of the sixth lens, and the effective diameters of the fifth and sixth lenses may be adjusted.

$$\vert Max\_Sag72 \vert < \vert Max\_Sag62 \vert \qquad [ Equation 83 ]$$

Max_Sag72 is the maximum distance in the direction of the optical axis from a straight line perpendicular to the optical axis on the sensor-side surface of the seventh lens to the sensor-side surface of the seventh lens. When Equation 83 is satisfied, light may be guided from the last spherical lens to the last aspherical lens by the radius of curvature of the sensor-side surface of the sixth lens, and the effective diameters of the sixth and seventh lenses may be adjusted.

The first to third embodiments may satisfy at least one of |Max_Sag41|<|Max_Sag52|, |Max_Sag52|<|Max_Sag51|, and |Max_Sag72|<|Max_Sag71|. In addition, the fourth and fifth embodiments may satisfy at least one of |Max_Sag52|<|Max_Sag41|, |Max_Sag52|<|Max_Sag51|, and |Max_Sag72<Max_Sag71|.

Max_Sag41 is the maximum distance in the optical axis direction from a straight line perpendicular to the optical axis on the object-side surface of the fourth lens to the object-side surface of the fourth lens. Max_Sag52 is the maximum distance in the optical axis direction from a straight line perpendicular to the optical axis on the sensor-side surface of the fifth lens to the sensor-side surface of the fifth lens. Max_Sag71 is the maximum distance in the optical axis direction from a straight line perpendicular to the optical axis on the object-side surface of the seventh lens to the object-side surface of the seventh lens.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + … \qquad [ Equation 84 ]$$

In Equation 84, Z may mean a distance in the optical axis direction from an arbitrary position on the aspherical surface to the vertex of the aspherical surface. The Y may mean a distance in the direction perpendicular to the optical axis from an arbitrary position on the aspherical surface to the optical axis. The c may mean the curvature of the lens, and K may mean the conic constant. In addition, A, B, C, D, E, and F may mean aspheric coefficients.

The optical system 1000 according to the embodiment may satisfy at least one or two or more Equations among Equations 1 to 83. In this case, the optical system 1000 may have improved optical characteristics, improved resolution, and improved aberration and distortion characteristics. In addition, the optical system 1000 can secure a BFL (Back focal length) for applying a vehicle image sensor 300, can compensate for optical characteristic degradation due to temperature change, and can minimize the distance between the last lens and the image sensor 300, so that it may have good optical performance at the center and periphery of the FOV.

Table 4 shows the items of the Equations described above in the optical system 1000 of the embodiment, including TTL (mm), back focal length (BFL), effective focal length F (mm), ImgH (mm), effective diameter (CA) (mm), thickness (mm), optical axis distance TD (mm) from the first surface S1 to the fourteenth surface S14, focal lengths F1, F2, F3, F4, F5, F6, and F7 (mm) of each of the first to seventh lenses, sum of refractive indices, sum of Abbe numbers, sum of thicknesses (mm), sum of distances between adjacent lenses, diagonal FOV (Degree), edge thickness (ET), focal lengths of the first and second lens groups, F number, etc.

TABLE 4

| Items | Embodiment 1 | Embodiment 2 | Embodiment 3 | Embodiment 4 | Embodiment 5 |
|---|---|---|---|---|---|
| F | 15.138 | 15.151 | 15.087 | 15.109 | 15.178 |
| F1 | −31.303 | −31.136 | −31.655 | −40.124 | −31.491 |
| F2 | 30.367 | 20.470 | 21.822 | 85.717 | 41.345 |
| F3 | 65.717 | 130.000 | 97.102 | 40.434 | 56.049 |
| F4 | 35.095 | 70.649 | 72.989 | 24.773 | 29.709 |
| F5 | 13.344 | 11.806 | 12.397 | 13.866 | 12.438 |
| F6 | −11.681 | −11.176 | −11.135 | −11.833 | −11.431 |
| F7 | −29.278 | −25.807 | −31.497 | −24.190 | −24.679 |
| F_LG1 | −31.303 | −31.136 | −31.655 | −40.124 | −31.491 |
| F_LG2 | 11.041 | 10.910 | 11.070 | 11.641 | 11.012 |
| F13 | 35.793 | 24.686 | 17.407 | 55.951 | 47.352 |
| F47 | 42.399 | 174.774 | 143.825 | 27.315 | 32.891 |
| F56 | 173.247 | 75.050 | 102.236 | 282.074 | 122.318 |
| Σnd | 11.676 | 11.676 | 11.676 | 11.676 | 11.676 |
| ΣAbbe | 349.671 | 349.671 | 349.671 | 349.671 | 349.671 |
| ΣCT | 24.118 | 26.782 | 26.934 | 24.956 | 25.988 |
| ΣCG | 9.339 | 6.414 | 7.021 | 7.827 | 9.541 |
| ΣET | 21.798 | 24.7047 | 24.956 | 22.315 | 23.523 |
| ET1 | 9.066 | 9.807 | 10.816 | 8.406 | 10.828 |
| ET2 | 1.424 | 1.533 | 1.536 | 1.171 | 1.002 |
| ET3 | 2.303 | 2.996 | 2.347 | 2.867 | 3.080 |
| ET4 | 1.477 | 1.515 | 1.520 | 1.036 | 1.030 |
| ET5 | 1.535 | 1.576 | 1.591 | 1.064 | 1.064 |
| ET6 | 3.631 | 4.067 | 4.517 | 4.726 | 3.735 |
| ET7 | 2.362 | 3.211 | 2.629 | 3.046 | 2.784 |
| CT56 | 6.101 | 6.663 | 7.066 | 6.701 | 5.721 |
| ET56 | 5.166 | 5.643 | 6.108 | 5.791 | 4.799 |
| F-number | 1.597 | 1.602 | 1.596 | 1.599 | 1.600 |
| FOV (diagonal | 34.263 | 34.263 | 34.228 | 34.218 | 34.287 |
| angle) | | | | | |
| EPD | 9.481 | 34.258 | 9.451 | 9.448 | 9.486 |
| BFL | 3.200 | 9.458 | 3.500 | 3.040 | 2.849 |
| TD | 33.458 | 3.300 | 33.954 | 32.783 | 35.529 |
| ImgH | 4.626 | 33.196 | 4.626 | 4.626 | 4.626 |
| SD | 24.979 | 4.626 | 23.810 | 24.762 | 25.153 |
| TTL | 36.658 | 36.496 | 37.454 | 35.823 | 38.378 |

| | |
|---|---|
| Sensor size | 3840*2160 |

Table 5 shows the result values or the Equations 1 to 30 described above in the optical system 1000 of the embodiment. Referring to Table 5, it may be seen that the optical system 1000 satisfies at least one, two or more, or three or more of the Equations 1 to 30. Accordingly, the optical system 1000 may have good optical performance and excellent optical characteristics in the center and periphery of the FOV.

TABLE 5

| Equations | | Embodiment 1 | Embodiment 2 | Embodiment 3 | Embodiment 4 | Embodiment 5 |
|---|---|---|---|---|---|---|
| 1 | 1 < CT1/CT2 < 7 | 3.377 | 2.716 | 3.156 | 5.181 | 5.597 |
| 2 | (CT7*CA7) < (CT1*CA1) | Satisfaction | Satisfaction | Satisfaction | Satisfaction | Satisfaction |
| 3 | Po1 < 0 | −0.032 | −0.032 | −0.032 | −0.025 | −0.032 |
| 4 | 1.7 < n3 < 2.2 | 1.694 | 1.694 | 1.694 | 1.694 | 1.694 |
| 5 | 20 < FOV_H < 40 | 30.00 | 0.00 | 0.00 | 30.00 | 30.00 |
| 6 | L1R1 < 0 | −18.523 | −17.274 | −18.791 | −20.812 | −20.000 |
| 7 | 0.8 < BFL/Max_Sag72 | 1.045 | 1.029 | 1.044 | 0.978 | 1.030 |
| | to Sensor < 3 | | | | | |
| 8 | 3 < CT1/CT7 < 7 | 4.864 | 3.598 | 4.997 | 3.364 | 4.792 |
| 9 | 0 < CT3/CT7 < 3 | 1.617 | 1.285 | 1.304 | 1.522 | 1.738 |
| 10 | 1 < CT56/CT7 < 5 | 3.392 | 2.553 | 2.158 | 2.160 | 3.157 |
| 11 | 0 < \|L2R1/L4R2\| < 5 | 0.326 | 0.552 | 0.636 | 4.078 | 0.908 |
| 12 | 0 < (CT45 − ET45) < 2 | 1.181 | 1.181 | 1.157 | 1.157 | 1.192 |
| 13 | 0 < CA11/CA31 < 2 | 0.908 | 0.893 | 0.918 | 0.898 | 0.886 |
| 14 | 0 < CA72/CA42 < 2 | 0.681 | 0.698 | 0.679 | 0.632 | 0.652 |
| 15 | 0 < CA12/CA21 < 2 | 0.965 | 0.913 | 0.922 | 0.985 | 0.963 |
| 16 | 0 < CA31/CA42 < 2 | 0.976 | 1.036 | 1.022 | 0.937 | 0.990 |
| 17 | 0 < CA51/CA62 < 2 | 1.339 | 1.349 | 1.364 | 1.399 | 1.311 |
| 18 | 0 < CA62/CA71 < 2 | 1.076 | 1.039 | 1.053 | 1.082 | 1.089 |
| 19 | 0.2 < GL_CA_Aver/ | 1.034 | 1.053 | 1.058 | 1.025 | 1.033 |
| | GM_CA_Aver < 2 | | | | | |
| 20 | 0 < GL_nd_Aver/ | 0.948 | 0.948 | 0.948 | 0.948 | 0.948 |
| | GM_nd_Aver < 1.60 | | | | | |
| 21 | CA7 < CA5 | Satisfaction | Satisfaction | Satisfaction | Satisfaction | Satisfaction |
| 22 | CG2 < CG6 < CG3 | Satisfaction | Satisfaction | Satisfaction | Satisfaction | Satisfaction |
| 23 | 0 < CT7/CG6 < 2 | 0.593 | 1.279 | 0.923 | 0.852 | 0.688 |
| 24 | FOV < 45 | 34.263 | 34.258 | 34.228 | 34.218 | 34.287 |
| 25 | 1 < TTL/CA_Max < 5 | 2.680 | 2.730 | 2.837 | 2.529 | 2.692 |
| 26 | 0 < CT6/CT7 < 3 | 1.195 | 0.987 | 1.451 | 1.351 | 0.980 |
| 27 | 10 < \|L7R1/CT7\| < 60 | 27.581 | 41.192 | 20.602 | 35.702 | 42.977 |
| 28 | 0 < \|L5R2/L7R1\| < 10 | 0.527 | 0.166 | 0.458 | 0.283 | 0.219 |
| 29 | 2 < TTL/ImgH < 15 | 7.924 | 7.889 | 8.096 | 7.744 | 8.296 |
| 30 | 0 < \|L5R1/L6R2\| < 2 | 0.934 | 0.771 | 0.852 | 0.958 | 0.848 |

Table 6 shows the result values for the Equations 31 to 60 described above in the optical system 1000 of the embodiment. Referring to Table 6, it may be seen that the optical system 1000 satisfies at least one, two or more, or three or more of the Equations 1 to 44. Accordingly, the optical system 1000 may have good optical performance and excellent optical characteristics in the center and periphery portions of the FOV.

TABLE 6

| Equations | | Embodiment 1 | Embodiment 2 | Embodiment 3 | Embodiment 4 | Embodiment 5 |
|---|---|---|---|---|---|---|
| 31 | 0 < \|L6R2/L6R1\| < 2 | 0.504 | 0.878 | 0.740 | 0.572 | 0.711 |
| 32 | 0.1 < BFL/ImgH < 2 | 0.692 | 0.713 | 0.757 | 0.657 | 0.616 |
| 33 | 1 < ΣCT/ΣCG < 5 | 2.582 | 4.176 | 3.836 | 3.189 | 2.724 |
| 34 | 8 < ΣIndex < 20 | 11.676 | 11.676 | 11.676 | 11.676 | 11.676 |
| 35 | 10 < ΣAbbe/Σnd < 50 | 29.947 | 29.947 | 29.947 | 29.947 | 29.947 |
| 36 | Distortion < 2 | Satisfaction | Satisfaction | Satisfaction | Satisfaction | Satisfaction |
| 37 | 0 < ΣCT/ΣET < 2 | 1.106 | 1.084 | 1.079 | 1.118 | 1.105 |
| 38 | 0.5 < CA11/CA_Min < 2.5 | 1.349 | 1.374 | 1.420 | 1.392 | 1.419 |
| 39 | 1 < CA_Max/CA_Min < 5 | 1.551 | 1.537 | 1.547 | 1.671 | 1.635 |
| 40 | 1 < CA_Max/CA_Aver < 3 | 1.162 | 1.141 | 1.131 | 1.205 | 1.181 |
| 41 | 0.5 < CA_Min/CA_Aver < 2 | 0.749 | 0.742 | 0.731 | 0.721 | 0.722 |
| 42 | 1 < CA_Max/(2*ImgH) < 3 | 1.478 | 1.445 | 1.427 | 1.531 | 1.541 |
| 43 | 1 < TD/CA_Max < 4 | 2.446 | 2.483 | 2.572 | 2.314 | 2.492 |
| 44 | 1 < F/CA61 < 10 | 1.292 | 1.346 | 1.331 | 1.249 | 1.289 |
| 45 | 0 < F/\|L1R1\| < 1 | 0.817 | 0.877 | 0.803 | 0.726 | 0.759 |
| 46 | Max (CT/ET) < 4 | 2.650 | 2.663 | 2.617 | 3.364 | 3.455 |
| 47 | 0 < EPD/\|L1R1\| < 1 | 0.512 | 0.548 | 0.503 | 0.454 | 0.474 |
| 48 | −10 < F1/F3 < 0 | −0.476 | −0.240 | −0.326 | −0.992 | −0.562 |
| 49 | Po5 * Po6 < 0 | Satisfaction | Satisfaction | Satisfaction | Satisfaction | Satisfaction |
| 50 | 15 < v4 − v5 < 60 | 18.212 | 18.212 | 18.212 | 18.212 | 18.212 |
| 51 | 0 < \|F1/F\| < 20 | 2.068 | 2.055 | 2.098 | 2.656 | 2.075 |
| 52 | 0 < \| F5/F6 \| < 2 | 1.142 | 1.056 | 1.113 | 1.172 | 1.088 |
| 53 | 0 < \| F5/F7 \| < 1 | 0.456 | 0.457 | 0.394 | 0.573 | 0.504 |
| 54 | 0 < \| F6/F1 \| < 1.2 | 0.373 | 0.359 | 0.352 | 0.295 | 0.363 |
| 55 | 0 < \| F27/F1\| < 2 | 0.353 | 0.350 | 0.350 | 0.290 | 0.350 |
| 56 | 1 < \| F47/F6 \| < 25 | 3.630 | 15.638 | 12.916 | 2.308 | 2.877 |
| 57 | 0 < \| F47/F7 \| < 10 | 1.448 | 6.772 | 4.566 | 1.129 | 1.333 |
| 58 | 0 < \|F6/F\| < 5 | 0.772 | 0.738 | 0.738 | 0.783 | 0.753 |
| 59 | F_LG1/F_LG2 < 0 | Satisfaction | Satisfaction | Satisfaction | Satisfaction | Satisfaction |
| 60 | 1 < nGL/nGM < 4 | 2.500 | 2.500 | 2.500 | 2.500 | 2.500 |

Table 7 shows the result values for the Equations 61 to 83 described above in the optical system 1000 of the embodiment. Referring to Table 7, it may be seen that the optical system 1000 satisfies at least one, two or more, or three or more of the Equations 61 to 83. In detail, it may be seen that the optical system 1000 according to the embodiment satisfies all of the Equations 1 to 83. Accordingly, the optical system 1000 may have good optical performance and excellent optical characteristics at the center and periphery portions of the FOV.

TABLE 7

| Equations | | Embodiment 1 | Embodiment 2 | Embodiment 3 | Embodiment 4 | Embodiment 5 |
|---|---|---|---|---|---|---|
| 61 | 1 < nSS/nAS < 4 | 2.500 | 2.500 | 2.500 | 2.500 | 2.500 |
| 62 | (CAS_Max/CAS_Min) < | Satisfaction | Satisfaction | Satisfaction | Satisfaction | Satisfaction |
| | (CT_Max/CT_Min) | | | | | |
| 63 | 0 < ΣGM_CT/ΣGL_CT < 1 | 0.113 | 0.136 | 0.103 | 0.152 | 0.141 |
| 64 | 10 < TTL < 50 | 36.658 | 36.496 | 37.454 | 35.823 | 38.378 |
| 65 | 2 < ImgH | 4.626 | 4.626 | 4.626 | 4.626 | 4.626 |
| 66 | 2 < BFL < 7 | 3.200 | 3.300 | 3.500 | 3.040 | 2.849 |
| 67 | 0.1 < BFL/CG3 < 1 | 0.575 | 0.954 | 0.908 | 0.783 | 0.934 |
| 68 | 1 < CT1/BFL < 3.5 | 2.587 | 2.726 | 2.855 | 2.556 | 3.508 |
| 69 | 3 < F < 40 | 15.138 | 15.151 | 15.087 | 15.109 | 15.178 |
| 70 | 5 < TTL/BFL < 20 | 11.455 | 11.059 | 10.701 | 11.784 | 13.469 |
| 71 | 1 < TTL/F < 3 | 2.422 | 2.409 | 2.483 | 2.371 | 2.529 |
| 72 | 1 < F/BFL < 10 | 4.731 | 4.591 | 4.311 | 4.970 | 5.327 |
| 73 | 1 < F/ImgH < 5 | 3.272 | 3.275 | 3.261 | 3.266 | 3.281 |
| 74 | 1 < F/EPD < 5 | 1.597 | 1.602 | 1.596 | 1.599 | 1.600 |
| 75 | 0 < BFL/TD < 0.3 | 0.0956 | 0.0994 | 0.1031 | 0.0927 | 0.0802 |
| 76 | 0 < EPD/ImgH/FOV < 0.2 | 0.0142 | 0.0143 | 0.0143 | 0.0143 | 0.0142 |
| 77 | 5 < FOV/F# < 40 | 21.459 | 21.386 | 21.442 | 21.398 | 21.429 |
| 78 | 1 < ΣGL_CT/F# < 20 | 12.316 | 13.152 | 13.985 | 11.963 | 12.673 |
| 79 | 1 < ΣGM_CT/F# < 5 | 1.395 | 1.783 | 1.444 | 1.822 | 1.785 |
| 80 | 1 < ΣGL_nd/F# < 10 | 5.142 | 5.125 | 5.144 | 5.134 | 5.132 |
| 81 | 1 < ΣGM_nd/F# < 10 | 2.171 | 2.164 | 2.171 | 2.167 | 2.166 |
| 82 | \|Max_Sag62 \| < \|Max_Sag51\| | Satisfaction | Satisfaction | Satisfaction | Satisfaction | Satisfaction |
| 83 | \|Max_Sag72\| < \|Max_Sag62\| | Satisfaction | Satisfaction | Satisfaction | Satisfaction | Satisfaction |

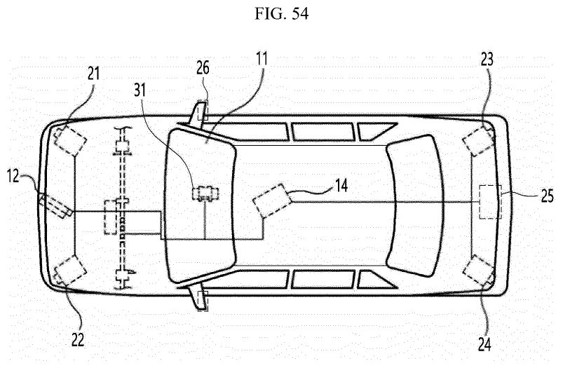

FIG. 54 is an example of a plan view of a vehicle to which a camera module or optical system according to an embodiment of the invention is applied. Referring to FIG. 54, a vehicle camera system according to an embodiment of the invention includes an image generating unit 11, a first information generating unit 12, a second information generating unit 21, 22, 23, 24, 25, and 26, and a control unit 14. The image generating unit 11 may include at least one camera module 31 disposed in the vehicle, and may capture images of the front of the vehicle and/or the driver to generate images of the front or interior of the vehicle. The image generating unit 11 may capture images of the front of the vehicle as well as the surroundings of the vehicle in one or more directions using the camera module 31, to generate images of the surroundings of the vehicle. Here, the front and surrounding images may be digital images, and may include color images, black and white images, and infrared images. In addition, the front and surrounding images may include still images and moving images. The image generating unit 11 provides the driver image, the front image, and the surrounding image to the control unit 14. Next, the first information generating unit 12 may include at least one radar and/or camera placed in the own vehicle, and detects the front of the own vehicle to generate the first detection information. Specifically, the first information generating unit 12 is placed in the own vehicle and detects the position and speed of vehicles located in front of the own vehicle, whether there is a pedestrian, and the position, etc. to generate the first detection information.

Using the first detection information generated by the first information generating unit 12, the distance between the own vehicle and the vehicle in front may be controlled to be maintained at a constant level, and the stability of vehicle operation may be increased in specific cases set in advance, such as when the driver wants to change the driving lane of the own vehicle or when parking in reverse. The first information generating unit 12 provides the first detection information to the control unit 14. The second information generating unit 21, 22, 23, 24, 25, and 26 detects each side of the own vehicle based on the front image generated by the image generating unit 11 and the first detection information generated by the first information generating unit 12 to generate the second detection information. Specifically, the second information generating unit 21, 22, 23, 24, 25, and 26 may include at least one radar and/or camera disposed on the own vehicle, and may detect the position and speed of vehicles located on the side of the own vehicle or capture images. Here, the second information generating unit 21, 22, 23, 24, 25, and 26 may be disposed on each of the front corners, side mirrors, and the rear center and rear corners of the own vehicle.

At least one information generating unit of these vehicle camera systems may be equipped with an optical system and a camera module having the same as described in the above-described embodiments, and may provide or process information acquired through the front, rear, each side, or corner area of the vehicle to a user to enable autonomous driving or to protect the vehicle and objects from surrounding safety.

The optical system of the camera module according to the embodiment of the invention may be installed in multiple units in a vehicle to enhance safety regulations, autonomous driving functions, and increase convenience by using an Advanced Driving Assistance System (ADAS). In addition, the optical system of the camera module is applied in a vehicle as a component for control such as a lane keeping assistance system (LKAS), a lane departure warning system (LDWS), and a driver monitoring system (DMS). This vehicle camera module can implement stable optical performance even under ambient temperature changes and can provide a module with price competitiveness, thereby ensuring the reliability of vehicle components.

Features, structures, effects, etc. described in the embodiments are included in at least one embodiment of the invention, and are not necessarily limited to only one embodiment. Furthermore, features, structures, effects, etc. illustrated in each embodiment may be combined or modified for other embodiments by those of ordinary skill in the art to which the embodiments belong. Accordingly, the contents related to such combinations and modifications should be interpreted as being included in the scope of the invention. In addition, although the embodiment has been described above, it is only an example and does not limit the invention, and those of ordinary skill in the art to which the invention pertains are exemplified above in a range that does not depart from the essential characteristics of the present embodiment. It may be seen that various modifications and applications that have not been made are possible. For example, each component specifically shown in the embodiment may be implemented by modification. And the differences related to these modifications and applications should be construed as being included in the scope of the invention defined in the appended claims.

1. An optical system comprising:
first to seventh lenses aligned along an optical axis from an object side toward a sensor side,
wherein a refractive power of the first lens is negative,
wherein a composite refractive power of the second to seventh lenses is positive,
wherein a refractive power of the seventh lens is negative,
wherein the first lens is a spherical lens having a maximum center thickness among center thicknesses of the first to seventh lenses, and
wherein the center thickness of the first lens is greater than an optical axis distance from a center of an object-side surface of the fifth lens to a center of a sensor-side surface of the sixth lens.

2. The optical system of claim 1, wherein an object-side surface of the fourth lens has a concave shape on the optical axis.

3. The optical system of claim 1, wherein the center thickness of the second lens is a minimum among the center thicknesses of the first to seventh lenses.

4. The optical system of claim 1, wherein a center distance between i-th lens and i+1 lens from the object side is CGi, a center thickness of the i-th lens is CTi, and a value of the following Equation: CTi/CGi is maximum when i is 1.

5. The optical system of claim 4, wherein the value of the following Equation: CTi/CGi is minimum when i is 3.

6. The optical system of claim 1, wherein an effective diameter of the first lens is CA1, an effective diameter of the second lens is CA2, and an effective diameter of the third lens is CA3, and satisfies the following Equation: CA1<CA2<CA3.

7. The optical system of claim 6, wherein a length from a center of an image sensor to a diagonal end is ImgH, an effective diameter of the fourth lens is CA4, an effective diameter of the fifth lens is CA5, an effective diameter of the sixth lens is CA6, an effective diameter of the seventh lens is CA7, and the optical system satisfying the following Equation: CA4>CA5>CA6>(2*ImgH)>CA7.

8. The optical system of claim 1, wherein a sensor-side surface of the fifth lens and an object-side surface of the sixth lens are bonded to each other.

9. The optical system of claim 8, comprising:
an aperture stop arranged on a periphery between the first lens and the second lens.

10. The optical system of claim 8,
wherein an object-side surface and a sensor-side surface of the third lens are aspherical on the optical axis, and
wherein an object-side surface and a sensor-side surface of the seventh lens are aspherical on the optical axis.

11. The optical system of claim 8,
wherein the first to seventh lenses are made of glass,
wherein a number of lenses whose object-side surface and sensor-side surface are spherical on the optical axis is at least twice a number of lenses whose object-side surface and sensor-side surface are aspherical.

12. The optical system of claim 1,
wherein the center thickness of the first lens is CT1,
wherein an optical axis distance from a center of an object-side surface of the first lens to a surface of an image sensor is TTL,
wherein the following Equation satisfies: 0.18≤CT1/TTL<0.3.

13. The optical system of claim 1,
wherein the fifth lens and the sixth lens are a cemented lens bonded to each other,
wherein the center thickness of the first lens is thicker than a center thickness of the cemented lens.

14. A camera module comprising:
an image sensor;
first to seventh lenses aligned along an optical axis from an object side toward a sensor side;
an aperture stop arranged between spherical lenses among the first to seventh lenses; and
an optical filter between the seventh lens and the image sensor,
wherein the first lens has a meniscus shape convex toward the sensor on the optical axis,
wherein the first and seventh lenses have negative refractive power,
wherein a composite refractive power of the second to seventh lenses is positive,
wherein one of the first to fourth lenses is an aspherical lens,
wherein the aspherical lens is arranged between lenses having a shape in which both sides are convex on the optical axis.

15. The camera module of claim 14, comprising a cemented lens in which two lenses having opposite refractive powers among the fifth to seventh lenses are cemented,
wherein the cemented lens includes an object-side lens that is convex on the optical axis and a sensor-side lens that is concave on the optical axis.

16. The camera module of claim 15, wherein the cemented lens includes the fifth lens and the sixth lens,
wherein a sensor-side surface of the fifth lens and an object-side surface of the sixth lens are bonded to each other.

17. The camera module of claim 16,
wherein a center thickness of the first lens is thicker than a center thickness of the cemented lens.

18. The camera module of claim 14,
wherein an object-side surface and a sensor-side surface of the third lens are aspherical on the optical axis, and
wherein an object-side surface and a sensor-side surface of the seventh lens are aspherical on the optical axis.

19. The camera module in claim 14,
wherein the first to seventh lenses are made of glass,
wherein a number of lenses among the first to seventh lenses whose object-side and sensor-side surfaces are spherical on the optical axis is at least twice a number of lenses whose object-side and sensor-side surfaces are aspherical on the optical axis.

20. The camera module in claim 14,
wherein a center thickness of the first lens is CT1,
wherein an optical axis distance from a center of an object-side surface of the first lens to a surface of the image sensor is TTL,
wherein the following Equation satisfies: 0.18<CT1/TTL<0.3.
